(19) United States
(12) Patent Application Publication
(10) Pub. No.: US 2006/0157574 A1
(43) Pub. Date: Jul. 20, 2006

(54) Printed data storage and retrieval

(75) Inventors: Stephen Farrar, Epping (AU); Stephen James Hardy, West Pymble (AU); Peter Alleine Fletcher, Rozelle (AU); Kieran Gerard Larkin, Putney (AU); Eric Lap Min Cheung, Epping (AU); Stephen Edward Ecob, Chatswood West (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/305,897

(22) Filed: Dec. 19, 2005

(30) Foreign Application Priority Data
Dec. 21, 2004 (AU) 2004242416
Dec. 21, 2004 (AU) 2004242417

(51) Int. Cl. G06K 19/06

(52) U.S. Cl. 235/494

(57) ABSTRACT

A method, apparatus and computer program for generating a barcode (200) representing one or more portions of data is disclosed. A block-based correlatable pattern of data is generated and the generated data patterns are arranged according to a predetermined arrangement. The one or more portions of data are interdispersed with the arranged data patterns to generate the barcode (200).

### FIELD OF THE INVENTION

The present invention relates generally to barcodes and, in particular, to barcodes resistant to global distortions, local distortions and noise. The present invention also relates to a method and apparatus for generating, printing and reading barcodes, and to a computer program product including a computer readable medium having recorded thereon a computer program for creating, printing and reading barcodes.

### BACKGROUND

While modern computers have significantly enhanced the manner is which data is processed and used, paper is still an important medium for recording and conveying information. Conventionally, paper has been primarily used to record and convey human readable information. This human readable information is typically printed on to the paper. However, computer readable information may also be printed on paper.

One conventional method of printing computer readable information on paper is by encoding the information into a one-dimensional barcode. There are a number of different formats of one-dimensional barcodes, including UPC/EAN, Code 39, Code 128, and Interleaved 2 of 5. However, one-dimensional barcodes are limited in the amount of data that they can store, since the data density of one-dimensional barcodes is low and one-dimensional barcodes are usually of a fixed size.

In order to increase the data density of a barcode, a two-dimensional barcode can be used. Various two-dimensional barcode formats are known. Most of these two-dimensional barcode formats comprise a collection of regions arranged in a grid formation. Each of these regions is typically colored (e.g., either black or white). The color of each region conveys one bit of information. However, even two-dimensional barcodes suffer from a number of problems.

The process of printing a one-dimensional or two-dimensional barcode can introduce distortions into the barcode. When a barcode is printed using an electro-photo-graphic engine (i.e., a laser printer) the types of distortions introduced into the barcode may include warping. Warping causes straight lines to be printed as wavy lines. These wavy lines may deviate from being straight by up to a few printer pixels. Noise can also be introduced into a printed barcode. Noise may be caused by splotches of ink in the printed barcode. Color channel mis-registration can also be introduced into a printed barcode. Color channel mis-registration may occur where cyan, magenta, yellow, and black channels, for example, of the printed barcode are not correctly aligned.

Warping of a printed barcode may also occur if the barcode is folded or crumpled in between printing and scanning the barcode. Additional noise may be introduced by marks made on a printed barcode.

One known method of reading a barcode image is by sampling the barcode at points on a grid formation. The samples may then be used to ascertain the colors of the regions of the barcode, and hence to encode the bits of information represented by the barcode. However, this method is problematic in the presence of warping distortions. If the amount of deviation in the barcode is larger than the size of the barcode regions, then the barcode image may be sampled at points inside a wrong region.

In one known method of generating a barcode, instead of coloring each region of the barcode, glyphs are printed in each region of the barcode. Typically, the glyphs that are printed in each region of a barcode are either forward or backward slashes. Upon reading the barcode generated in such a manner, the glyphs can be found by a tracking method. Typically, the tracking method scans along each row of the barcode, locating each successive glyph relative to the location of a previous glyph. Printing glyphs in each region of a barcode increases the resistance of the barcode to warping. However, printing glyphs in such a manner sacrifices data density, since the regions need to be larger. Additionally, the tracking method described above is not particularly resistant to noise. For example, if a glyph becomes corrupted due to noise and cannot be located, subsequent glyphs may not be able to be located either.

Another known method of generating a barcode colors the regions of the barcode either black or white. Tracking may then be performed on the barcode based on detecting edges where color changes from black to white, or vice versa. Coloring the regions of a barcode either black or white can increase the data density of the barcode. However, such barcodes may still be disadvantageously affected by noise. Further, the barcodes described often suffer from color channel mis-registration. In this instance, barcodes printed in color by combining more than one of cyan, magenta, yellow, or black inks, may be impossible to decode.

It is often desirable to ensure that a printed document has not been altered or tampered with in some unauthorised manner from the time the document was first printed. For example, a contract that has been agreed upon and signed on some date may subsequently be fraudulently altered. It is desirable to be able to detect such alterations in detail. Similarly, security documents of various sorts including cheques and monetary instruments record values, which are vulnerable to fraudulent alteration. Detection of any fraudulent alteration in such document is also desirable. Further, it is desirable that such detection be performed automatically, and that the detection reveals the exact nature of any alteration.

In addition to detection of fraudulent alteration or tampering with a document, it is desirable that printed documents offer a visible deterrent to fraudulent alteration. In the event of fraudulent alteration, it is desirable that an original of the altered printed document can be reliably reconstructed from the altered printed document.

Various methods of deterring and detecting fraudulent alteration to documents have been proposed and used.

One class of methods in use before high quality color scanners and printers became commonly available was to print important information such as monetary amounts in special fonts or with special shadows that were, at the time, difficult to reproduce. However, with modern printers and scanners, such techniques have become vulnerable to attack.

One known method of detecting alteration of a document uses a two dimensional (2D) barcode printed on one part of a document page to encode (possibly cryptographically) a representation of some other portion of the document, such as a signature area. This 2D barcode can be decoded and a resulting image compared by an operator to the area the barcode is intending to represent to check for similarity. Existing variants of such barcode protection may be divided into two categories.

The first category of 2D-barcode protection involves embedding a portion of a document's semantic information into a 2D barcode. Often, such semantic information may be hashed and encrypted. However, this first category of barcode protection does not allow non-textual documents to be protected. The second category of 2D-barcode protection treats a document as an image and embeds a portion of the image in a barcode. However, embedding a portion of the image in the barcode may cause the barcode to become very large. In this instance, automatic verification at a fine granularity is not possible, as the image embedded in the barcode cannot be automatically lined up with the received document.

A related body of work is detection of tampering in digital images that are not subject to print/scan cycles. A number of “fragile watermark” methods are known. However, these methods are generally not applicable to tamper detection in printed documents since they cannot withstand the introduction of noise, Rotation, Scaling and Translation (RST), re-sampling, and local distortion that occurs in a print/scan cycle. Some of these fragile watermark methods operate by replacing all or some of the least significant bits of pixels of an image with some form of checksum of remaining bits in each pixel.

A number of “semi-fragile watermark” methods are also known. These include methods that use cross-correlation to detect the presence of a lightly embedded shifted copy of a portion of an image. Another known semi-fragile watermark method embeds watermarks into image blocks, and then compares the detection strength of these watermarks to discern if any blocks have been altered. These semi-fragile watermark methods tend to have less localisation ability as their detection ability improves, and as their localisation ability improves, these methods become more sensitive to noise and other distortions and so cannot be used to detect local changes in printed documents.

Other known methods of detecting alterations in digital images use special materials to make alteration difficult. Such methods include laminates covering the printed surface of a document where damage to the laminate is obvious. However using special materials introduces production complexity, and is not applicable to plain paper applications. These known methods are also not amenable to automatic detection.

An additional failing in many existing methods is weak cryptographic security. In many cases, once a cryptographic algorithm being employed is identified, identification leads directly to a subversion method to attack the identified method.

Another common failing of present methods of detecting alterations to digital images is the distribution of alteration detection information over wide areas of a page, or even areas completely separate to the image area to be authenticated (as in the barcode method above). This introduces problems if there is incidental soiling of the document in areas apart from the image area being authenticated. Many of these methods cannot be used to authenticate the entire area of a document, so documents must be specifically designed to accommodate the methods.

A still further class of methods of detecting alterations to documents uses independent transfer of information about the original unaltered form of a document to verify the document. This could be as simple as a telephone call to a person with independent knowledge, and may extend to keeping a complete copy of the document in a secure location. Such methods have many practical disadvantages since they require handling and storage of such independent information.

### SUMMARY

It is an object of the present invention to substantially overcome, or at least ameliorate, one or more disadvantages of existing arrangements.

According to one aspect of the present invention there is provided a method of generating a barcode representing one or more portions of data, said method comprising the steps of:

generating a block-based correlatable alignment pattern of data;

arranging the generated correlatable alignment pattern according to a predetermined arrangement; and

interdispersing the one or more portions of data with the arranged correlatable alignment pattern to generate the barcode.

According to another aspect of the present invention there is provided a method of generating a barcode representing one or more portions of data, said method comprising the steps of:

generating one or more data patterns based on a mathematical function having a predetermined property;

arranging the generated data patterns in a border region of said barcode;

generating a block-based correlatable pattern of data;

arranging the correlatable pattern of data in an interior region of said barcode according to a predetermined arrangement; and

interdispersing the one or more portions of data with the arranged data patterns in the interior and exterior of said barcode to generate the barcode.

According to still another aspect of the present invention there is provided a method of generating a barcode representing one or more portions of data, said method comprising the steps of:

generating one or more spiral data patterns;

arranging the spiral data patterns in a border region of said barcode;

generating a noise pattern using random data;

arranging the random data in an interior region of said barcode according to a predetermined arrangement; and

interdispersing the one or more portions of data with the arranged spirals and the random data in the interior and exterior of said barcode in order to generate the barcode.

According to still another aspect of the present invention there is provided an apparatus for generating a barcode representing one or more portions of data, said apparatus comprising:

pattern generation means for generating a block-based correlatable alignment pattern of data;

data pattern arranging means for arranging the generated correlatable alignment pattern according to a predetermined arrangement; and

interdispersing means for interdispersing the one or more portions of data with the arranged correlatable alignment pattern to generate the barcode.

According to still another aspect of the present invention there is provided a computer program for generating a barcode representing one or more portions of data, said program comprising:

code for generating a block-based correlatable alignment pattern of data;

code for arranging the generated correlatable alignment pattern according to a predetermined arrangement; and

code for interdispersing the one or more portions of data with the arranged correlatable alignment pattern to generate the barcode.

According to still another aspect of the present invention there is provided a method of generating a protected document, said method comprising the steps of:

generating a block-based correlatable alignment pattern of data;

encoding data representing a document to be protected using an error correction code to generate parity bits for the document; and

arranging the generated correlatable alignment pattern, the encoded document and the generated parity bits according to a predetermined arrangement to generate the protected document.

According to still another aspect of the present invention there is provided a method of generating a protected document, said method comprising the steps of:

generating one or more data patterns based on a mathematical function having a predetermined property;

arranging the generated data patterns in a border region of said protected document;

generating a block-based correlatable pattern of data;

arranging the correlatable pattern of data in an interior region of said protected document according to a predetermined arrangement; and

encoding data representing a document to be protected using an error correction code to generate parity bits for the document; and

arranging the encoded document and the generated parity bits in said interior region according to said predetermined arrangement to generate said protected document.

According to still another aspect of the present invention there is provided a method of generating a protected document, said method comprising the steps of:

generating one or more spiral data patterns;

arranging the spiral data patterns in a border region of said protected document;

generating a noise pattern using random data;

arranging the random data in an interior region of said protected document according to a predetermined arrangement; and

encoding data representing a document to be protected using an error correction code to generate parity bits for the document; and

arranging the encoded document and the generated parity bits in said interior region according to said predetermined arrangement to generate said protected document.

According to still another aspect of the present invention there is provided an apparatus for generating a protected document, said apparatus comprising:

generating means for generating a block-based correlatable alignment pattern of data;

data encoding means for encoding data representing a document to be protected using an error correction code to generate parity bits for the document; and

arranging means for arranging the generated correlatable alignment pattern, the encoded document and the generated parity bits according to a predetermined arrangement to generate the protected document.

According to still another aspect of the present invention there is provided a computer program for generating a protected document, said program comprising:

code for generating a block-based correlatable alignment pattern of data;

code for encoding data representing a document to be protected using an error correction code to generate parity bits for the document; and

code for arranging the generated correlatable alignment pattern, the encoded document and the generated parity bits according to a predetermined arrangement to generate the protected document.

Other aspects of the invention are also disclosed.

### BRIEF DESCRIPTION OF THE DRAWINGS

One or more embodiments of the present invention will now be described with reference to the drawings and appendices, in which:

FIG. 1 is a schematic block diagram of a general-purpose computer upon which arrangements described may be practised;

FIG. 2A shows a barcode;

FIG. 2B shows alignment codels and data codels of the barcode of FIG. 2A;

FIG. 3 shows the mapping of coordinates from barcode codels to a coarsely aligned image and a scanned image of the barcode of FIG. 2A;

FIG. 4 is a flow diagram showing a method of generating the barcode of FIG. 2A;

FIG. 5 is a flow diagram showing a method of reading the barcode of FIG. 2A;

FIG. 6 shows a plot of the real part of a Logarithmic Radial Harmonic Function (LRHF);

FIG. 7 shows a spiral bitmap;

FIG. 8 shows the location of spirals embedded in the barcode of FIG. 2A;

FIG. 9 is a flow diagram showing a method of determining a coarse alignment affine transform, as executed in the method of FIG. 5;

FIG. 10 shows the barcode of FIG. 2A with its border divided into squares;

FIG. 11 is a flow diagram showing a method of storing data in border codels of the barcode of FIG. 2A, as executed in the method of FIG. 4;

FIG. 12 is a flow diagram showing a method of extracting salt data from the border of the barcode of FIG. 2A, as executed in the method of FIG. 5;

FIG. 13 is a flow diagram showing a method of determining three fine alignment warp maps for a scanned image of the barcode of FIG. 2A, as executed in the method of FIG. 5;

FIG. 14 is a flow diagram showing a method of generating an alignment pattern in alignment codels of the barcode of FIG. 2A, as executed in the method of FIG. 4;

FIG. 15 is a flow diagram showing a method of generating a reference image for the current color channel, as executed in the method of FIG. 13;

FIG. 16A shows a correlation tile of the reference image, which may be used in the method of FIG. 13;

FIG. 16B shows a correlation tile in the coarsely-aligned image, corresponding to the correlation tile of the reference image of FIG. 16A;

FIG. 17 is a flow diagram showing a method of generating a displacement map for the color channel, as executed in the method of FIG. 13;

FIG. 18 shows an example of two overlapping correlation tiles, FIG. 19 is a flow diagram showing an alternative method for determining the Fast Fourier Transform (FFT) of correlation tiles, as executed in the method of FIG. 17;

FIG. 20 is a flow diagram showing a method of interpolating a mapping, as executed in the method of FIG. 13;

FIG. 21 is a flow diagram showing a method of determining the location of a highest peak in a correlation image to sub-pixel accuracy, as executed in the method of FIG. 17;

FIG. 22 shows a codel and it's adjacent (i.e., neighbouring) codels;

FIG. 23 is a flow diagram showing a method of encoding data and generating the barcode of FIG. 2A from the encoded data, as executed in the method of FIG. 4;

FIG. 24 is a flow diagram showing a method of extracting data from a barcode of FIG. 2A and decoding the extracted data, as executed in the method of FIG. 5;

FIG. 25 is a flow diagram showing a method of locating six peaks corresponding to each of the spirals embedded in the barcode of FIG. 2A.

FIG. 26 is a flow diagram showing a method of determining the dimensions of the barcode of FIG. 2A, as executed in the method of FIG. 9;

FIG. 27 is a flow diagram showing a method of generating a coarsely-aligned image for the cyan color channel of the scanned image, as executed in the method of FIG. 13;

FIG. 28 is a flow diagram showing a method of generating a correlation image as executed in the method of FIG. 17;

FIG. 29 is a flow diagram showing a method of generating a coarsely-aligned image, as executed in the method of FIG. 13;

FIG. 30 is a flow diagram showing a method of determining a warp map for the current color channel, as executed at in the method of FIG. 13;

FIG. 31 is a flow diagram showing a method of determining constant vectors as executed in the method of FIG. 21;

FIG. 32 is a flow diagram showing a method of determining parameters for a color model for a color channel c;

FIG. 33 is a flow diagram showing a method of determining parameters for another color model for the color channel c;

FIG. 34 is a flow diagram showing a method of determining pixel values from the scanned image of the barcode of FIG. 2A, as executed in the method of FIG. 24;

FIG. 35A shows a protected document;

FIG. 35B shows alignment pixels in the interior of the protected document of FIG. 35A;

FIG. 36 shows the mapping of coordinates from protected document interior pixels to a coarsely aligned image and a scanned image of the document of FIG. 35A;

FIG. 37 is a flow diagram showing a method of generating the protected document of FIG. 35A;

FIG. 38 is a flow diagram showing a method of reading the protected document of FIG. 35A;

FIG. 39 shows the location of spirals embedded in the protected document of FIG. 35A;

FIG. 40 is a flow diagram showing a method of determining a coarse alignment affine transform, as executed in the method of FIG. 38;

FIG. 41 shows the protected document of FIG. 35A with its border divided into squares;

FIG. 42 is a flow diagram showing a method of storing data in the border of the protected document of FIG. 35A, as executed in the method of FIG. 37;

FIG. 43 is a flow diagram showing a method of extracting salt data from the border of the protected document of FIG. 35A, as executed in the method of FIG. 38;

FIG. 44 is a flow diagram showing a method of determining a fine alignment warp map for a scanned image of the protected document of FIG. 35A, as executed in the method of FIG. 38;

FIG. 45A is a flow diagram showing a method of generating alignment pixels in the interior of the protected document of FIG. 35A for documents that do not have a dominant amount of one color, as executed in the method of FIG. 37,;

FIG. 45B is a flow diagram showing a method of generating alignment pixels in the interior of the protected document of FIG. 35A for documents that have a dominant amount of one color, as executed in the method of FIG. 37,;

FIG. 46 is a flow diagram showing a method of generating a reference image for the protected document of FIG. 35A, as executed in the method of FIG. 43;

FIG. 47 is a flow diagram showing a method of encoding a document to be protected into a one dimensional (1D) document array and a one dimensional (1D) protection array, as executed in the method of FIG. 37;

FIG. 48 is a flow diagram showing a method of arranging the two 1D arrays of FIG. 49 to form the protected document of FIG. 35A, as executed in the method of FIG. 37;

FIG. 49 is a flow diagram showing a method of extracting the two 1D arrays of FIG. 47 from the scanned image of the protected document, as executed in the method of FIG. 38;

FIG. 50 is a flow diagram showing a method of indicating the location of alterations to the protected document and generating an image correcting the alterations;

FIG. 51 is a flow diagram showing a method of locating six peaks corresponding to each of the spirals embedded in the protected document of FIG. 35A.

FIG. 52 is a flow diagram showing a method of determining the dimensions of the protected document of FIG. 35A, as executed in the protected document of FIG. 40;

FIG. 53A shows a document;

FIG. 53B shows the document of FIG. 54A with an alignment pattern generated in accordance with the method of FIG. 44A;

FIG. 53C shows the document of FIG. 54A with an alignment pattern generated in accordance with the method of FIG. 45B;

FIG. 54 is a flow diagram showing a method of generating a coarsely-aligned image for the scanned image of the protected document of FIG. 35A, as executed in the method of FIG. 44;

FIG. 55 is a flow diagram showing a method of determining a width for the protection barcode of the protected document of FIG. 35A;

FIG. 56 is a flow diagram showing a method of determining the width of the protection barcode for the protected document of FIG. 35A when verifying the protected document;

FIG. 57 is a flow diagram showing a method of generating a pseudo-random permutation, as executed in the method of FIG. 47; and

FIG. 58 is a flow diagram showing a method of generating an inverse pseudo-random permutation, as executed in the method of FIG. 47.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their respective publication and/or use. Such should not be interpreted as a representation by the present inventor(s) or patent applicant that such devices in any way form part of the common general knowledge in the art.

For ease of explanation the following description has been divided into Sections 1.0 to 15.0, each section having associated subsections.

1.0 Introduction

1.1 System for Generating and Reading Barcodes

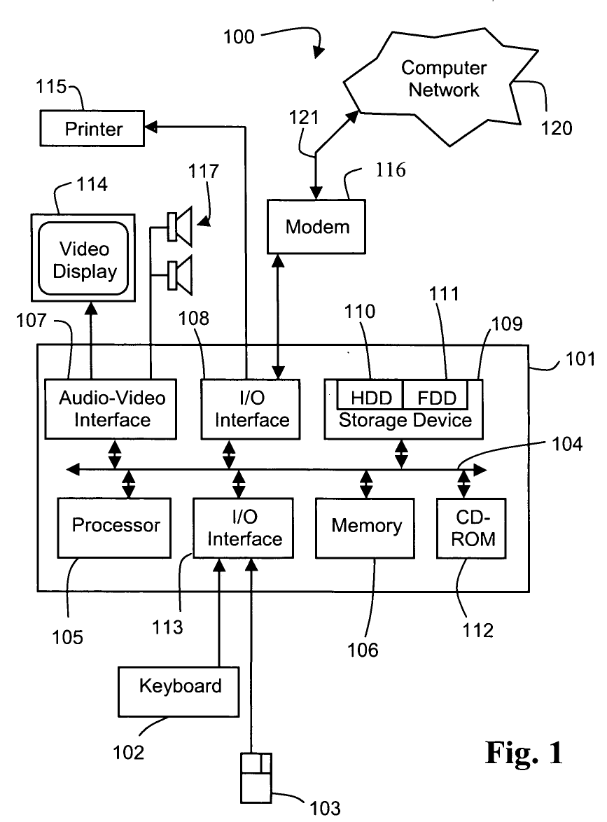

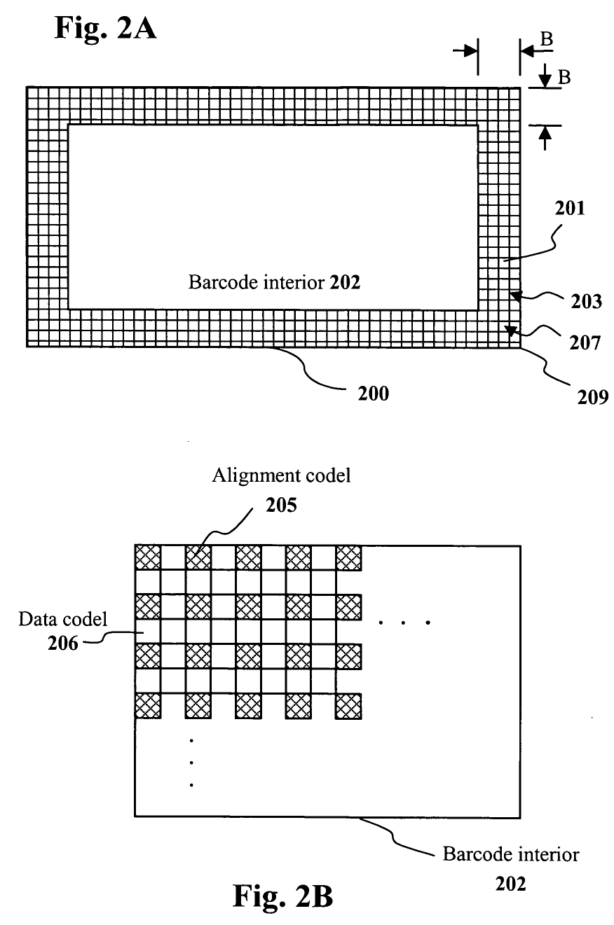

The methods described herein may be practiced using a general-purpose computer system 100, such as that shown in FIG. 1 wherein the processes of FIGS. 2 to 58 may be implemented as software, such as an application program executing within the computer system 100. In particular, the steps of the described methods may be affected by instructions in the software that are carried out by the computer. The instructions may be formed as one or more code modules, each for performing one or more particular tasks. The software may also be divided into two separate parts, in which a first part performs the described methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer affects an advantageous apparatus for implementing the described methods.

The computer system 100 is formed by a computer module 101, input devices such as a keyboard 102, mouse 103 and a scanner 119, output devices including a printer 115, a display device 114 and loudspeakers 117. The printer 115 may be in the form of an electro-photographic printer, an ink jet printer or the like. The printer may be used to print barcodes as described below. The scanner 119 may be in the form of a flatbed scanner, for example, which may be used to scan a barcode in order to generate a scanned image of the barcode. The scanner 119 may be configured within the chassis of a multi-function printer.

A Modulator-Demodulator (Modem) transceiver device 116 may be used by the computer module 101 for communicating to and from a communications network 120, for example, connectable via a telephone line 121 or other functional medium. The modem 116 may be used to obtain access to the Internet, and other network systems, such as a Local Area Network (LAN) or a Wide Area Network (WAN), and may be incorporated into the computer module 101 in some implementations. In one implementation, the printer 115 and/or scanner 119 may be connected to the computer module 101 via such communication networks.

The computer module 101 typically includes at least one processor unit 105, and a memory unit 106, for example formed from semiconductor random access memory (RAM) and read only memory (ROM). The module 101 also includes a number of input/output (I/O) interfaces. These I/O interfaces include an audio-video interface 107 that couples to the video display 114 and loudspeakers 117, an I/O interface 113 for the keyboard 102 and mouse 103 and optionally a joystick (not illustrated), and an interface 108 for the modem 116, printer 115 and scanner 119. In some implementations, the modem 116 may be incorporated within the computer module 101, for example within the interface 108. A storage device 109 may be provided and typically includes a hard disk drive 110 and a floppy disk drive 111. A magnetic tape drive (not illustrated) may also be used. A CD-ROM drive 112 may be provided as a non-volatile source of data. The components 105 to 113 of the computer module 101, typically communicate via an interconnected bus 104 and in a manner that results in a conventional mode of operation of the computer system 100 known to those in the relevant art. Examples of computers on which the described arrangements can be practised include IBM-PC's and compatibles, Sun Sparcstations or alike computer systems evolved therefrom.

Typically, the application program is resident on the hard disk drive 110 and read and controlled in its execution by the processor 105. Intermediate storage of the program and any data fetched from the network 120 may be accomplished using the semiconductor memory 106, possibly in concert with the hard disk drive 110. In some instances, the application program may be supplied to the user encoded on a CD-ROM or floppy disk and read via the corresponding drive 112 or 111, or alternatively may be read by the user from the network 120 via the modem device 116. Still further, the software may be loaded into the computer system 100 from other computer readable media. The term “computer readable medium” as used herein refers to any storage or transmission medium that participates in providing instructions and/or data to the computer system 100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 101. Examples of transmission media include radio or infra-red transmission channels as well as a network connection to another computer or networked device, and the Internet or Intranets including e-mail transmissions and information recorded on Websites and the like.

The methods described below may alternatively be implemented in dedicated hardware such as one or more integrated circuits performing the functions or sub functions of the described methods. Such dedicated hardware may include graphic processors, digital signal processors, or one or more microprocessors and associated memories.

The data to be encoded in the barcodes described below may be stored in an electronic file of a file-system configured within the memory 106 or hard disk drive 110 of the computer module 101, for example. Similarly, the data to be read from a barcode may also be stored in the hard disk drive 110 or memory 106 upon the barcode being read. Alternatively, the data to be stored in a barcode may be generated on-the-fly by a software application program resident on the hard disk drive 110 and being controlled in its execution by the processor 105. The data read from a barcode may also be processed by such an application program.

1.2 Elements Making Up a Barcode

A barcode may comprise a rectangular array of square regions. Each square region may either be printed on the printer 115, for example, using ink, or may be left blank. The presence or absence of ink may be used to store one bit of data. These square regions are elements of the barcode and are used to encode information. These elements may be referred to as coding elements, or “codels”. A codel is “on” if the codel has ink printed in the region forming the codel. Conversely, the codel is “off” if there is no ink printed in the region forming the codel.

Codels may be printed in a number of different colored inks. For example, many printers use cyan, magenta, and yellow inks. These three inks are referred to as the “primary colors”. Some of the codels described below may be printed using cyan ink, while others are printed using magenta ink. Still other codels may be printed using yellow ink. Thus, the codels described here may be printed in inks of all of the three primary colors.

The codels of a barcode may also all be printed using the same color ink (e.g., black ink) to produce monochrome barcodes. Codels that are printed in the same color ink are said to belong to the same “color channel”.

The dimensions of a barcode may be specified by width (W) and height (H). Codels may be arranged in an array with H rows, W columns, and three (3) color planes (i.e., for the cyan, magenta, and yellow inks). In this instance, the total number of codels of a barcode is equal to W×H×3. The physical size of a barcode may be determined by the size of the codels in the barcode on a printed page. For example, the codels may be printed at a codel resolution of 150 dots-per-inch. This means that each codel is a square with side-length of one 150th of an inch. However, a person skilled in the relevant art would appreciate that any suitable codel resolution may be used to generate the barcodes described here.

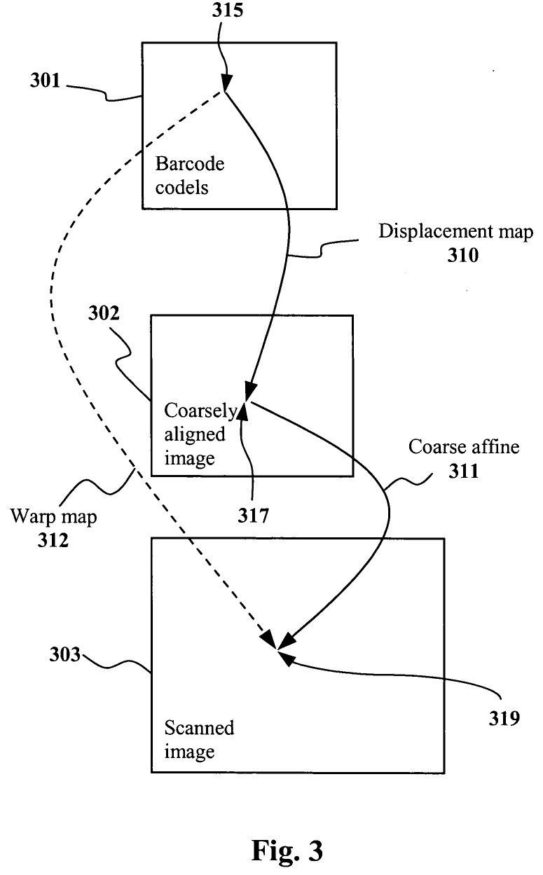

FIG. 2A shows a barcode 200. The barcode 200 will be used below as an example barcode to describe the methods of FIGS. 3 to 34. The barcode 200 comprises a border 201 and an interior 202. The border 201 of the barcode 200 comprises codels (e.g., 203) of all three color channels (i.e., cyan, magenta, and yellow). The codels of each color channel may be said to form an independent barcode for that particular color channel. Therefore, the barcode 200 may be said to comprise a plurality of independent barcodes where each of the independent barcodes is of a particular colour channel. The border 201 has a width, which may be denoted as ‘B’. For example, B may be equal to thirty-two (32) meaning that the barcode 200 has thirty two (32) codels on all four sides of the barcode 200. The codels (e.g., 203) that lie in the border 201 may be referred to as “border codels”. The interior 202 of the barcode 200 comprises all codels of the barcode 200 that are not in the border 201. In the interior 202, some of the codels may be referred to as “alignment codels” 205 and the remaining codels may be referred to as “data codels” 206, as shown in FIG. 2B. Data codels 206 may be used to store information (i.e., data). Alignment codels 205 and border codels 203 may be used to perform alignment, which will be described in detail below. As seen in FIG. 2, for the barcode 200, for each group of four codels there is one alignment codel 205 and three data codels 206. These groups of four codels may be arranged symmetrically within the interior of the barcode 200.

The alignment codels 205 are the codels whose row and column coordinates are both even, in all three color channels (i.e., cyan, magenta, and yellow). However, the alignment codels 205 may be arranged in any other suitable arrangement. For example, one eighth of the codels in the interior 202 of the barcode 200 may be selected pseudo-randomly to be alignment codels (e.g., 205).

In order to make it easier to determine the dimensions of the barcode 200 from a scanned image of the barcode 200, the possible values of height (H) and width (W) of the barcode 200 may be restricted. In one example, H and W may be multiples of the border width B.

For ease of explanation and in order to allow specific codels in the barcode 200 to be identified, a codel coordinate system will be described. In this codel coordinate system, each codel in the barcode 200 may be uniquely specified by a 3-tuple of coordinates (x, y, c). In this 3-tuple of coordinates (x, y, c), x specifies a column for the codel, where column numbers range from 0 to W-1; y specifies a row for the codel, where row numbers range from 0 to H-1); and c specifies a color channel for the codel, where c is one of cyan, magenta, or yellow. The state of the codel with coordinates (x, y, c) may be denoted by α(x, y, c). If α(x, y, c)=0, the codel at (x, y, c) is in the “off” state. If α(x, y, c)=1, the codel at (x, y, c) is in the “on” state.

2.0 Two-Stage Alignment

Determining the location of codels in a scanned image of the barcode 200, produced using the scanner 119 when reading the barcode 200, can be problematic. The barcode 200 may be printed at one resolution (e.g., 150 codels-per-inch) and scanned at a higher resolution (e.g., 600 dpi). This means that a codel in the scanned image is 4-by-4 scanned pixels in size. The location of the centre of the codel in the scanned image is required to be determined accurately. However, due to distortions and warping, the locations of codels in the scanned image may deviate from their expected locations.

The location of codels (e.g., 203) in the scanned image of the barcode 200 may be determined using “coarse alignment” and “fine alignment”. Coarse alignment represents an approximate mapping between codels and the coordinates of their centres in the scanned image. Coarse alignment may use an affine transformation. Since the mapping between codels and their location in the scanned image is usually more complicated than an affine transform, coarse alignment may not accurately represent the codel locations. Once the coarse alignment affine transform has been found, the scanned image may be transformed, undoing the effects of the affine transform, and thus producing an image that is approximately the same as the original barcode 200. This image that is approximately the same as the original barcode 200 may be referred to as the coarsely-aligned image.

FIG. 3 shows a coarsely-aligned image 302 and a scanned image 303. Each of the images 302 and 303 represent the barcode 200. A representation of a coarse alignment affine transform 311 is also shown. The coarse alignment affine transform 311 takes coordinates in the coarsely-aligned image and maps the coordinates in the coarsely-aligned image to coordinates in the scanned image.

Fine alignment may be used to determine the mapping between barcode codels 301, as shown in FIG. 3, and the coarsely-aligned image 302, using an array of displacement vectors 310. Such an array of displacement vectors may be referred to as a “displacement map”. Since color channels may be mis-registered, a particular displacement map is configured in accordance with codels of only a single color channel. Thus, three separate displacement maps are generated for the barcode 200, one for each of the cyan, magenta, and yellow color channels.

The displacement map 310 and the coarse alignment affine transform 311 together provide a mapping from the barcode codels 301 to coordinates in the scanned image 303. Given the coordinates of a codel 315 in the barcode codels 301, the displacement map 310 may be used to find the coordinates of the centre of that codel 317 in the coarsely-aligned image 302. Those coordinates may then be transformed by the coarse alignment affine transform 311, resulting in the coordinates of the centre of the codel 319 in the scanned image 303. Thus the composition of the displacement map 310 and the affine transform 311 results in a mapping from the codel coordinates (e.g., the coordinates 315) to the scanned image coordinates (e.g., the coordinates 319). The composed mapping is called a warp map. A representation of a warp map 312 is also shown in FIG. 3. A warp map 312 is generated, for each of the cyan, magenta, and yellow color channels of the barcode 200.

3.0 Generating and Reading Barcodes

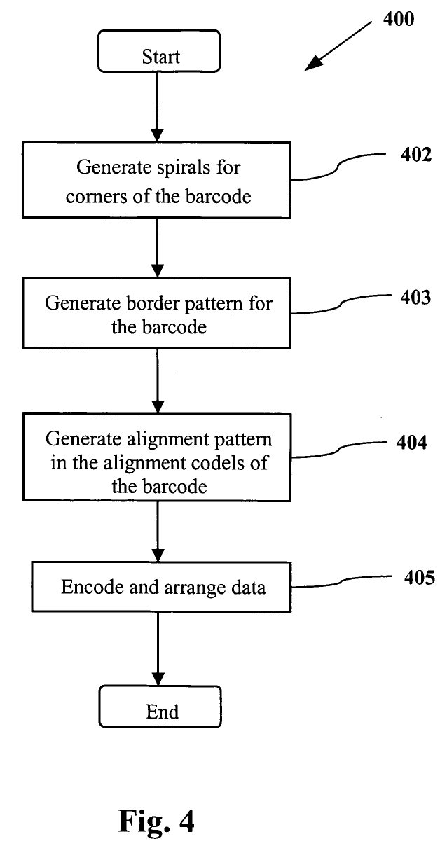

FIG. 4 is a flow diagram showing a method 400 of generating a barcode, such as the barcode 200, for example. The method 400 may be implemented as software resident on the hard disk drive 110 and be controlled in its execution by the processor 105.

The method 400 accesses data to be encoded, and produces an array of codels forming the barcode 200 representing the data. This array of codels forming the barcode 200 may then be printed using the printer 115.

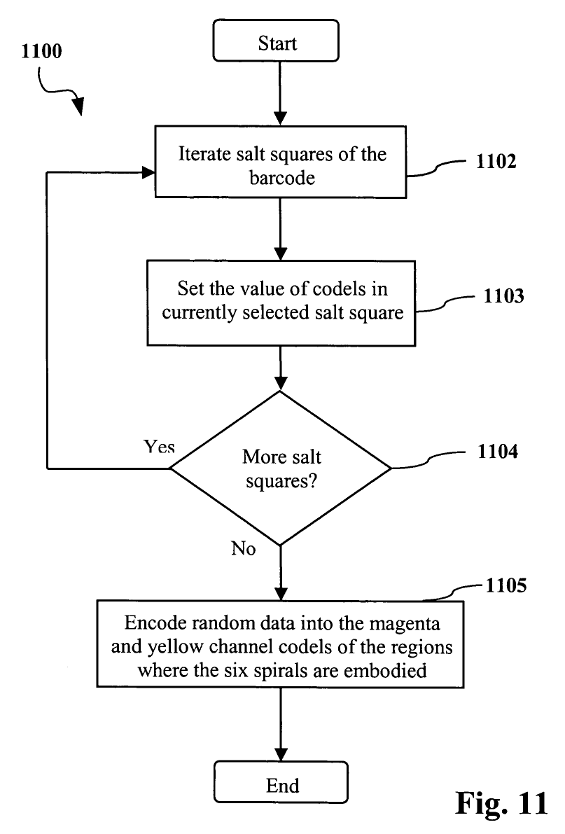

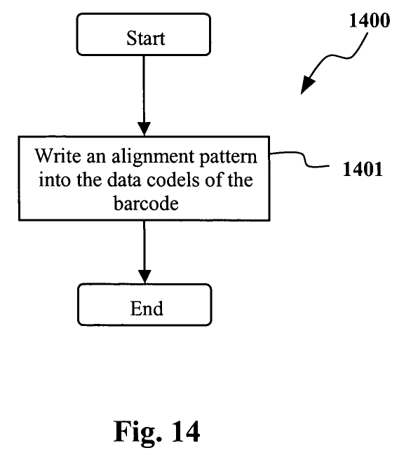

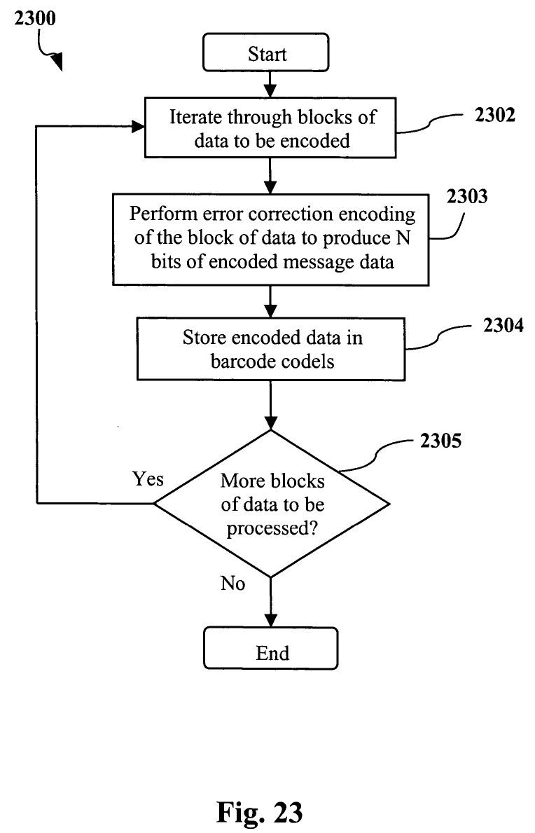

The method 400 begins at the first step 402, where the processor 105 generates spirals for corners (e.g., 209) of the barcode 200. The processor 105 encodes (or embeds) the spirals into border codels (e.g., 207) of the barcode 200. At the next step 403, the processor 105 generates a border pattern for the barcode 200, storing data in the border codels of the barcode 200. The processor 105 fills any of the codels that do not contain spirals with a small amount of data as will be described in detail below. The processor 105 may also store random data (i.e., noise) into codels of regions of the barcode border 201 where spirals have been embedded. A method 1100 of storing data in border codels of the barcode 200, as executed at step 403, will be described below with reference to FIG. 11. The method 400 continues at the next step 404, where the processor 105 generates an alignment pattern in the alignment codels (e.g., 205) of the barcode 200, in order to allow fine alignment to be performed when reading the barcode 200. A method 1400 of generating an alignment pattern in the alignment codels (e.g., 205) of the barcode 200, as executed at step 404, will be described in more detail below with reference to FIG. 14. Then at the next step 405, the processor 105 accesses the data, from memory 106 for example, encodes the data, and arranges the encoded data in the barcode 200 as one or more codels (e.g., 203). As will be described in detail below, the codels containing the encoded data are interdispersed in the barcode 200 with the alignment codels. A method 2300 of encoding data and arranging the encoded data in the barcode 200, as executed at step 405, will be described below with reference to FIG. 23.

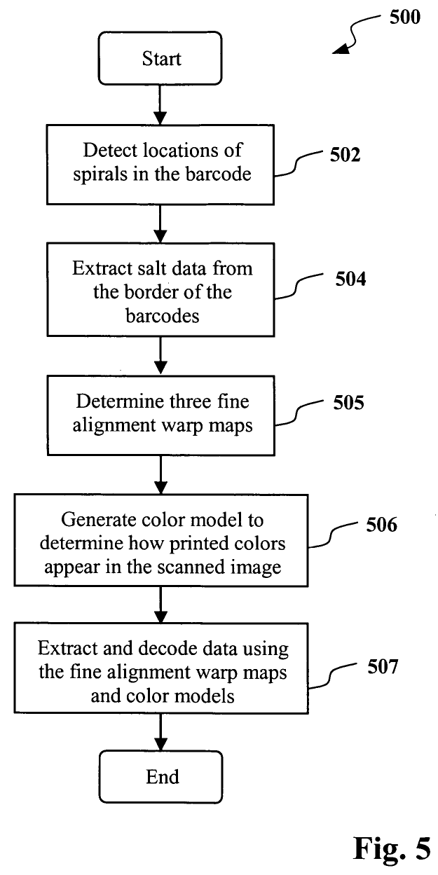

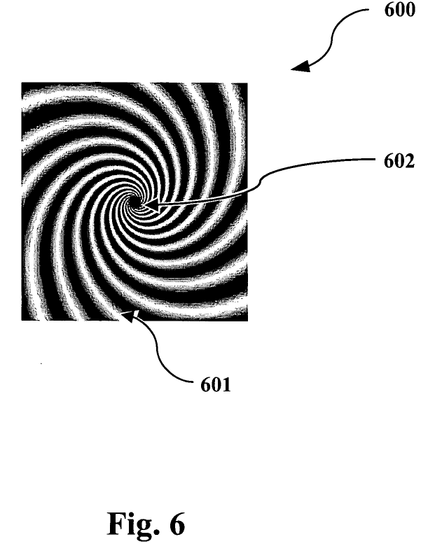

FIG. 5 is a flow diagram showing a method 500 of reading a barcode, such as the barcode 200, for example. The method 500 may be implemented as software resident in the hard disk drive 110 and being controlled in its execution by the processor 105.

The method 500 accesses an image generated by scanning the barcode 200. This image may be referred to as the ‘scanned image’ of the barcode 200. The scanned image may be accessed from memory 106, for example. The method 500 then produces data encoded in the barcode 200.

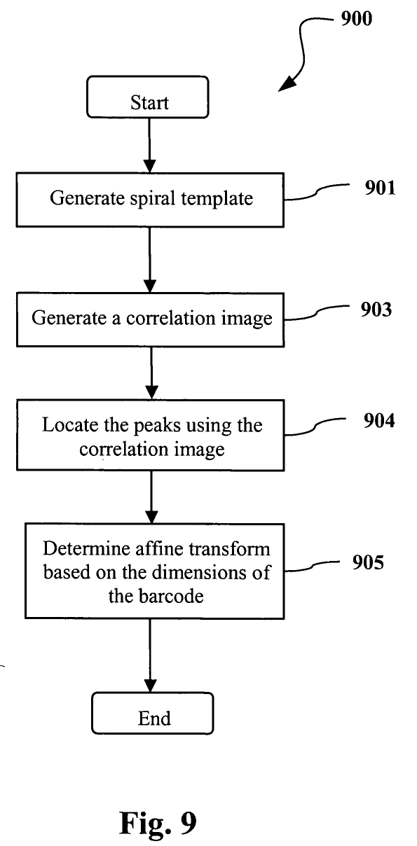

The method 500 begins at step 502, where the processor 105 determines a coarse alignment affine transform. The coarse-alignment transform is determined based on the dimensions of the barcode 200. At step 502, the processor 105 determines the locations of spirals in the scanned image of the barcode 200 and uses the detected spirals to locate the barcode 200 on a page. The processor 105 then determines the dimensions of the barcode 200, determines the resolution of the codels and determines the coarse alignment affine transform based on the determined dimensions. A method 900 of determining a coarse alignment affine transform, using the locations of the spirals, as executed at step 502, will be described below with reference to FIG. 9.

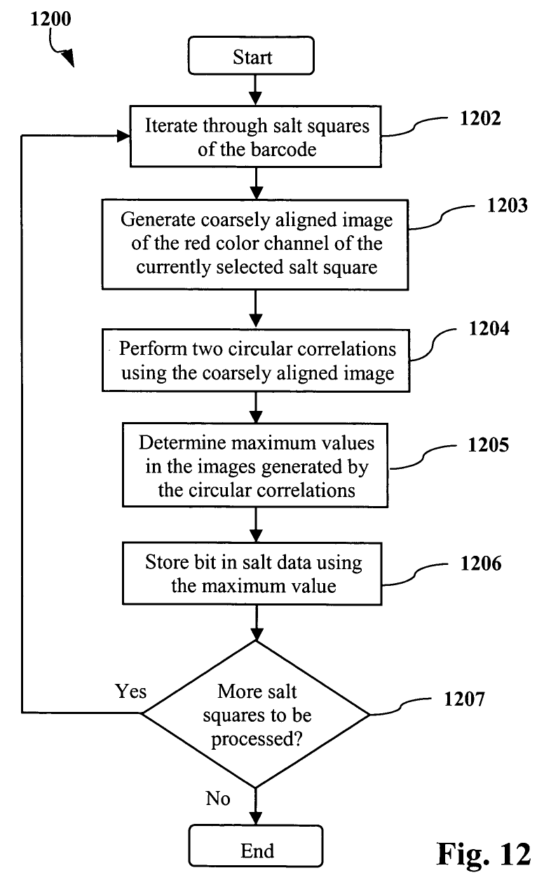

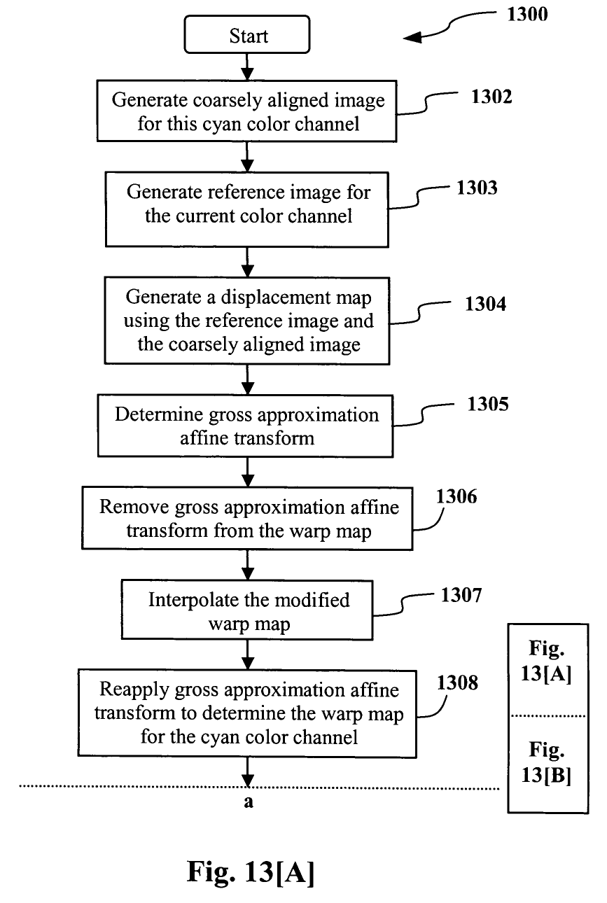

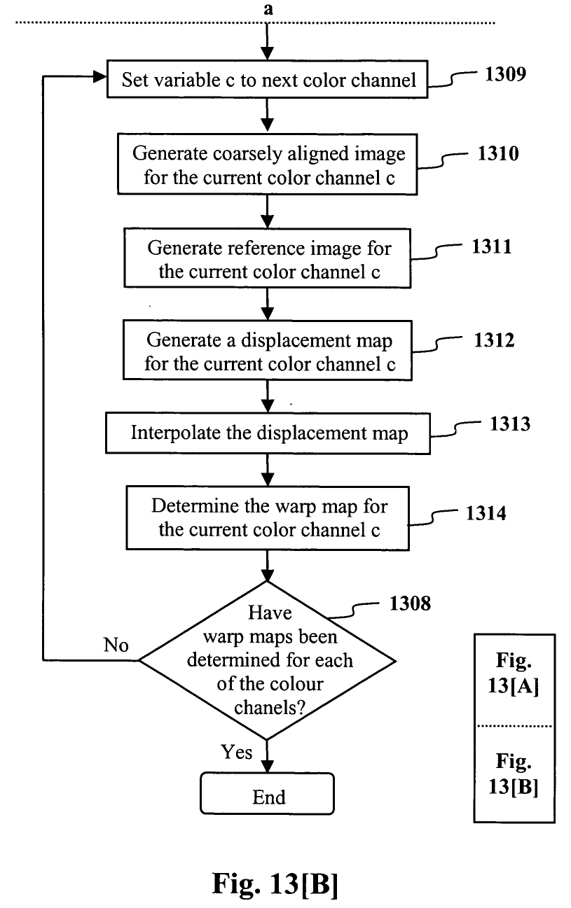

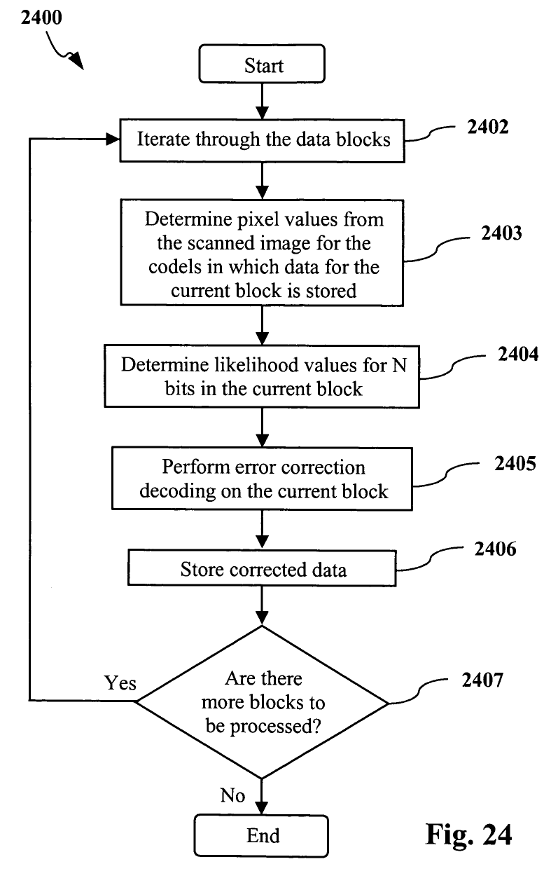

At the next step 504, the processor 105 reads the border 201 of the barcode 200 and extracts salt data. Salt data is a small amount of data from the border 201 of the barcode 200, as will be described in more detail below. A method 1200 of extracting salt data from the border 201 of the barcode 200, will be described below with reference to FIG. 12. Then at the next step 505, the processor 105 analyses the scanned image of the barcode 200 to determine three fine alignment warp maps. These alignment warp maps describe where codels in the barcode 200 as printed appear in the scanned image of the barcode 200. A method 1300 of determining three fine alignment warp maps for the scanned image of the barcode 200, as executed at step 505, will be described below with reference to FIG. 13. At the next step 506, the processor 105 generates color models that predict how printed colors appear in the scanned image. Then at step 507, the processor 105 uses the fine alignment warp maps and the color models to extract data from the barcode 200 and decode the extracted data. A method 2400 of extracting data from the barcode 200 and decoding the extracted data, as executed at step 507, will be described in detail below with reference to FIG. 24.

4.0 Spirals and Coarse Alignment

Step 402 of the method 400 and step 502 of the method 500 will now be described in more detail.

As described above, at step 402, the processor 105 generates spirals in the corners (e.g., 209) of the barcode 200 located inside the border region 201. These spirals are generated in the barcode 200 since the spirals have distinctive properties that allow the spirals to be easily detected when the barcode 200 is read.

As described above, at step 502, the processor 105 determines a coarse alignment affine transform. The coarse-alignment transform is determined based on the dimensions of the barcode 200. At step 502, the processor 105 determines the locations of spirals in the scanned image of the barcode 200 and uses the detected spirals to locate the barcode 200 on a page. The processor 105 then determines the dimensions of the barcode 200, determines the resolution of the codels and determines the coarse alignment affine transform.

The spirals used in the barcode 200 are bitmapped versions of logarithmic radial harmonic functions (LRHF). Mathematically, LRHF are complex valued functions defined on a plane. LRHF have the properties of scale and rotation invariance, which means that if an LRHF is transformed by scaling or rotation the transformed LRHF is still an LRHF. As an example, FIG. 6 shows a plot of the real part 600 of an LRHF.

An LRHF has three parameters that may be adjusted. The first parameter is referred to as the Nyquist radius R, which is the radius at which the frequency of the LRHF becomes greater than π radians per pixel. The second parameter is referred to as the spiral angle σ, which is the angle that the spiral arms (e.g., 601) make with circles centred at the origin (e.g., 602). The third parameter is referred to as the phase offset φ. An LRHF may be expressed in polar coordinates (r, θ), in accordance with Formula (1) as follows:
l(r,θ)=e^{j(mθ+n ln r+φ)} (1)
where the values of m and n may be determined in accordance with the following Formulae (2):
n=Rπ cos σ
m=└Rπ sin σ┘ (2)
In one example, σ=π6 radians, and R=B/4, where B represents the width of the barcode border 201, as shown in FIG. 2. The choice of phase φ varies for different spirals in the same barcode and will be described in more detail below.
4.1 Embedding Spirals

At step 402 of the method 400, the processor 105 generates six spirals in the barcode 200. The spirals are embedded in the border codels (e.g., 203) in the cyan channel of the barcode 200. Each spiral is generated by generating a spiral bitmap, which samples the LRHF with the Nyquist radius R, the spiral angle σ and the phase offset φ. The spiral bitmap has height and width equal to B pixels.

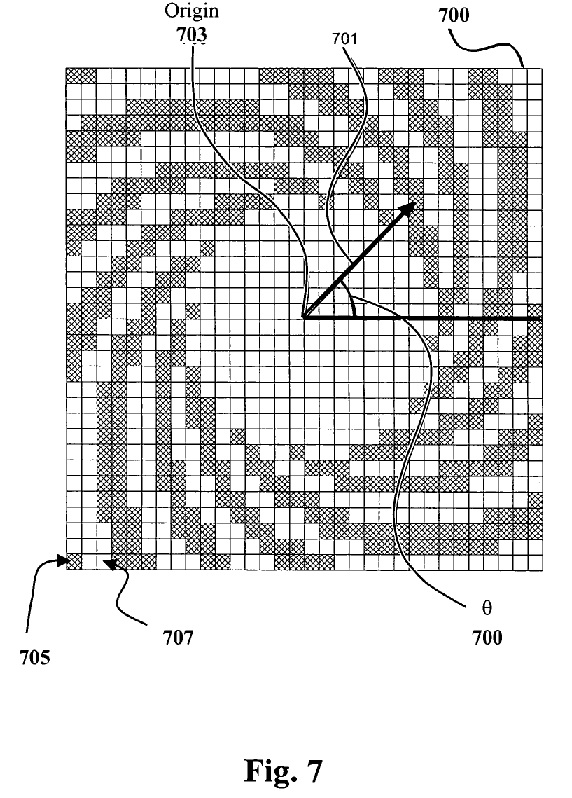

FIG. 7 shows a spiral bitmap 700. The polar coordinates in the spiral bitmap 700 will now be described. The origin 703 of the coordinate system of the spiral bitmap 700 refers to the centre of the spiral bitmap 700. The radius r 701 of a point in the spiral bitmap 700 is the distance from that point to the origin 703, measured in pixels. The angle θ 702 of a point in the spiral bitmap 700 is the angle of a ray from the origin 703 through the point. In accordance with this definition of radius r and angle θ, the value of a pixel in the spiral bitmap with coordinates (r, θ) may be determined in accordance with Formula (3) as follows:

$$\{ \begin{matrix}1 & if r > R and Re ( ℓ ( r , θ ) ) > 0 \\ 0 & otherwise\end{matrix} \qquad ( 3 )$$

Squares (e.g., 705) of the spiral bitmap 700 shown in FIG. 7 are shaded where pixel values of the bitmap 700 are equal to one (1). Squares (e.g., 707) of the bitmap 700 are unshaded where the pixel values of the bitmap 700 are equal to zero (0).

Once the spiral bitmap 700 has been generated, the spiral represented by the spiral bitmap 700 may be embedded into the codels of the barcode 200. Pixels of the spiral bitmap 700 equal to zero (0) are encoded into the barcode 200 by setting the state of a corresponding codel to “off”. Pixels of the spiral bitmap 700 equal to one (1) are encoded into the barcode 200 by setting the state of a corresponding codel to “on”.

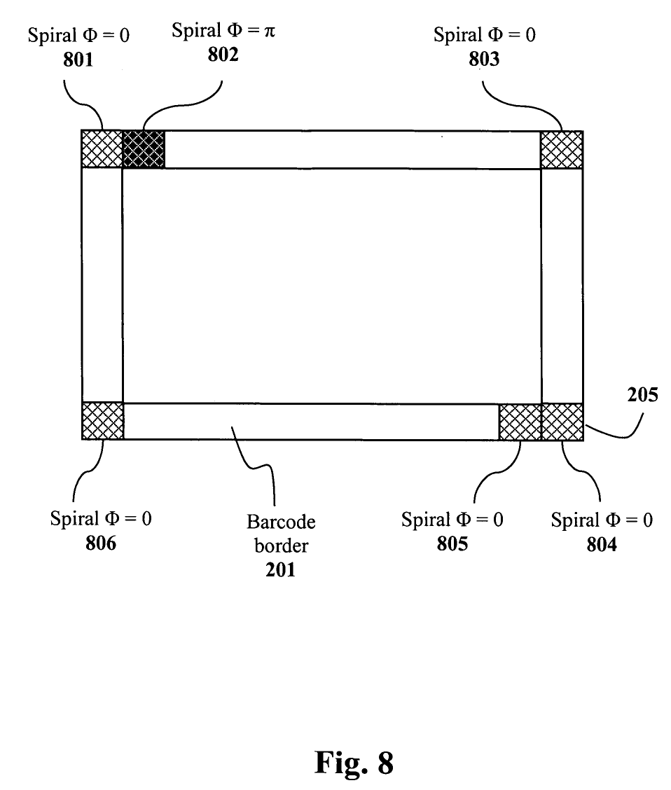

As seen in FIG. 8, six spirals 801, 802, 803, 804, 805 and 806 may be embedded in the border 201 of the barcode 200. Each of these spirals 801, 802, 803, 804, 805 and 806 is B codels wide, and B codels high. As described above, B may be equal to thirty-two (32) meaning that each of the spirals is thirty-two codels wide and thirty-two codels high. Five of the spirals (i.e., spirals 801, 803, 804, 805 and 806, as seen in FIG. 8) embedded in the barcode 200, have the same value for phase (i.e., φ=0), while the remaining spiral (i.e., spiral 802) has an opposite phase (i.e., φ=π). The locations of the six spirals 801, 802, 803, 804, 805 and 806 embedded in the border 201 of the barcode 200 will now described with reference to FIG. 8.

As seen in FIG. 8, four spirals 801, 803, 804 and 806 of the five spirals (i.e., spirals 801, 803, 804, 805 and 806, as seen in FIG. 8) with phase φ=0 are positioned in the four corners (e.g., 209) of the barcode 200. The other spiral 805 with φ=0 is positioned immediately to the left of the spiral 804 in the bottom-right corner 209 of the barcode 200. The spiral 802 with opposite phase φ=π is positioned immediately to the right of the spiral in the top-left corner of the barcode. The six spirals 801, 802, 803, 804, 805 and 806 embedded in the border 201 of the barcode 200 are encoded into cyan channel codels of the border 201 of the barcode 200.

4.2 Higher Resolution Spirals

Spirals may be printed by the printer 115, for example, at a higher resolution than the resolution of the codels (i.e., the ‘codel resolution’) of the associated barcode 200 being printed. This may allow more accurate sampling of an underlying LRHF, and better spiral detect ability when the barcode 200 is scanned by the scanner 119, for example. For example, the spirals of the barcode 200 may print at a ‘spiral resolution’ where the spiral resolution is equal to the codel resolution multiplied by an integer referred to as a ‘spiral factor’, F. The spiral resolution is preferably a highest resolution that the printer 115 can print at. Each codel (e.g., 205, 206) in the cyan channel, where a spiral is to be added to the barcode 200, is divided into an F×F array of pixels. In one example, the spiral bitmaps (e.g., 700) formed at step 402 have a height H and width W equal to BF rather than B. In this instance, the spiral bitmaps (e.g., 700) are embedded into the pixels arrays.

4.3 Detecting Spirals

As described above, at step 502 of the method 500, the processor 105 detects the locations of spirals in the scanned image of the barcode 200 and then determines a coarse alignment affine transform, using the locations of the spirals. The detection of spiral locations may be achieved by performing a correlation between a spiral template image and the scanned image of the barcode 200.

The method 900 of determining a coarse alignment affine transform, as executed at step 502, will now be described with reference to FIG. 9. The method 900 may be implemented as software resident on the hard disk drive 110 and being controlled in its execution by the processor 105.

The method 900 begins at an initial step 901, where the processor 105 generates a spiral template image, within memory 106, for example. The generation of the spiral template image at step 901 is similar to the generation of the spiral bitmap in step 402 of the method 400. However, the spiral template image is complex valued and is larger in size than the spiral bitmap. Each pixel value in the spiral template image is stored, in memory 106, as a pair of double-precision floating point numbers representing the real and imaginary parts of the pixel value. The spiral template image has height and width equal to Tₛ, the template size. The template size Tₛ may vary. In one example Tₛ=256.

Polar coordinates (r, θ) in the spiral template are defined, with the origin in the centre of the template. The pixel value at polar coordinates (r, θ) in the spiral template image may be determined in accordance with Formula (4) as follows:

$$\{ \begin{matrix}{ⅇ}^{j ( m θ + n ln r} & if r > R \\ 0 & otherwise\end{matrix} \qquad ( 4 )$$

where m and n are defined by Formulae (2) above; the Nyquist radius R represents the radius at which the frequency of the LRHF becomes greater than π radians per pixel; and the spiral angle σ represents the angle that the spiral arms of the LRHF make with circles centred at the origin of the LRHF.

At the next step 903, the processor 105 performs a correlation between a red channel of the scanned image and the complex spiral template image to generate a correlation image.

The correlation of two images I₁ and I₂ is a correlation image Iₓ. The correlation image Iₓ may be determined in accordance with Formula (5) below:

$${I}_{x} ( x , y ) = {\sum }_{{x}^{′} , {y}^{′}} {I}_{1} ( {x}^{′} , {y}^{′} ) {I}_{2} ( {x}^{′} + x , {y}^{′} + y ) \qquad ( 5 )$$

The sum of Formula (5) ranges over all x′ and y′ where I₁ is defined, and, in the image I₂, the values of pixels outside the image are considered to be zero. If either of the images I₁ or I₂ is complex-valued, the correlation image Iₓ may be complex-valued too. The reason that the red channel is used in the correlation at step 903 is that red is approximately the opposite color to cyan, and the spirals of the LRHF were embedded in the cyan channel of the barcode 200. Thus, the spirals are detectable in the red channel of the scanned image. The resulting correlation image Iₓ contains peaks (i.e., pixels with large modulus relative to neighbouring pixels), at the locations of spirals in the scanned image of the barcode 200. The phase of the pixel value of a peak is related to the phase φ of a corresponding spiral (e.g., 801) that was embedded in the barcode 200. The five spirals 801, 803, 804, 805 and 806 that were generated with φ=0 at step 402 have peaks with similar phase, while the one spiral 802 that was generated with φ=π at step 402 typically has a peak with opposite phase to the peaks of the other five spirals. Even if the scanned image of the barcode 200 is at a different resolution to the resolution that the barcode 200 was printed at, the spirals 801, 802, 803, 804, 805 and 806, will still be detected by the processor 105 since the underlying LRHF of the spirals is scale-invariant.

At the next step 904 of the method 900, the processor 105 examines the correlation image resulting from step 903, and locates the six peaks corresponding to each of the spirals 801 to 806 in accordance with the arrangement of the spirals 801 to 806 seen in FIG. 8. The six peaks corresponding to each of the spirals 801 to 806 may be located in accordance with the resolution at which the barcode 200 was printed (represented as Rₚ) and the resolution at which the barcode 200 was scanned (represented as Rₛ). If either of the resolutions Rₚ and Rₛ is not known, but there are only a few possibilities for the values of the resolutions Rₚ and Rₛ, then the six peaks of the spirals 801 to 806 may be located by trying each of the possible resolutions, and locating six peaks with a layout consistent with the corresponding possible resolution.

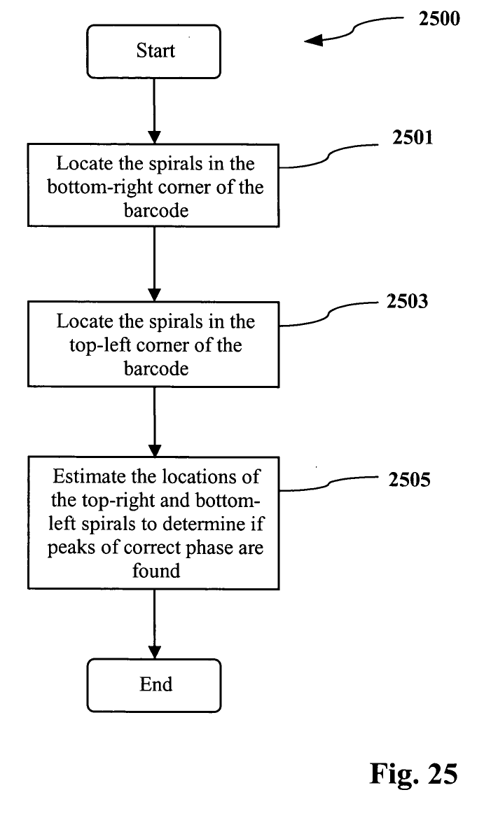

A method 2500 of locating the six peaks corresponding to each of the spirals 801 to 806, as executed at step 904, will now be described with reference to FIG. 25. The method 2500 may be implemented as software resident on the hard disk drive 110 and being controlled in its execution by the processor 105.

The method 2500 begins at step 2501, where the correlation image determined at step 903 is searched to locate the spirals 804 and 805 in the bottom-right corner 205 of the barcode 200. The spirals 804 and 805 correspond to a pair of peaks with approximately the same phase and lying approximately B×Rₛ/Rₚ pixels apart in the scanned image of the barcode 200. The coordinates of each the peaks of the spirals 804 and 805 may be denoted by q₄ and q₅, respectively.

At the next step 2503, the correlation image determined at step 903 is searched to locate the spirals 801 and 802 in the top-left corner of the barcode 200. The spirals 801 and 802 correspond to a pair of peaks lying approximately (B×Rₛ/Rₚ) pixels apart in the scanned image of the barcode 200. The peak of the spiral 801 will have approximately the same phase as the peaks at q₄ and q₅ determined previously. The peak of the spiral 802 will have approximately the opposite phase. The coordinates of the peak corresponding to the spiral 801, in the scanned image, having approximately the same phase as the peaks at q₄ and q₅ may be denoted q₁. The coordinates of the peak corresponding to the spiral 802, in the scanned image, having approximately the opposite phase as the peaks at q₄ and q₅ may be denoted q₂. If the peak at q₄ is closer in distance to the peak at q₁ than the peak at q₅ is, then the peaks at q₄ and q₅ may be swapped.

The method 2500 concludes at the next step 2505, where the locations of the top-right and bottom-left spirals 803 and 806 may be estimated, and the correlation image of step 903 may be searched to see if peaks with the correct phase are at the locations determined for the spirals 803 and 806. If peaks with the correct phase are found at the locations of the top-right and bottom-left spirals 803 and 806, then a barcode with consistent layout to the barcode 200 has been found. The expected coordinates of the top-right spiral 803 may be denoted by q′₃. The value of the expected coordinates q′₃ may be determined by projecting a point at coordinates q₄ onto a line joining the coordinates q₁ to the coordinates q₂. Similarly, the expected coordinates of the bottom-left spiral 806 may be denoted q′₆. The value of the coordinates q′₆ may be determined by projecting a point at coordinates q₁ onto the line joining the coordinates q₄ and q₅. The correlation image may be searched for peaks at coordinates q₃ and q₆ that are close to expected coordinates q′₃ and q′₆, respectively.

Some predetermined tolerance parameters may be used in the method 2500, in order to determine whether peaks are approximately the right distance apart, whether two peaks have approximately the same (or opposite) phase, or whether two peaks are close. For example, the following predetermined tolerances may be used. Two peaks may be considered to be approximately a correct distance apart if the actual distance between the two peaks is within 5% of the correct distance. The peaks at coordinates q₄ and q₅ may be considered to be of the same phase if their phases are within π/3 of each other. The peaks at coordinates q₁ and q₂ may be considered to be of opposite phase to each other if one phase is within π/3 of the other phase plus π. The peaks at coordinates q₃ and q₆ may be considered to be close to peaks at the expected coordinates q′₃ and q′₆ if the angles q′₃q₁q₃ and q′₆q₄q₆ are less than 5° respectively, and the angles q₁q₃q₄ and q₄q₆q₁ are within 5° of 90° respectively.

More than one pair of peaks may be found at the top-left hand corner of the barcode 200 when searching for either of the peaks with the same or opposite phase. In this instance, different combinations of the peaks may be tried, in order to find a correct combination.

Returning to the method 900 of FIG. 9, at the next step 905, the processor 105 determines the dimensions of the barcode 200 and generates a coarse-alignment affine transform based on the determined dimensions. The dimensions of the barcode 200 may be determined by examining the position of the peaks 801, 803 and 806 in the scanned image.

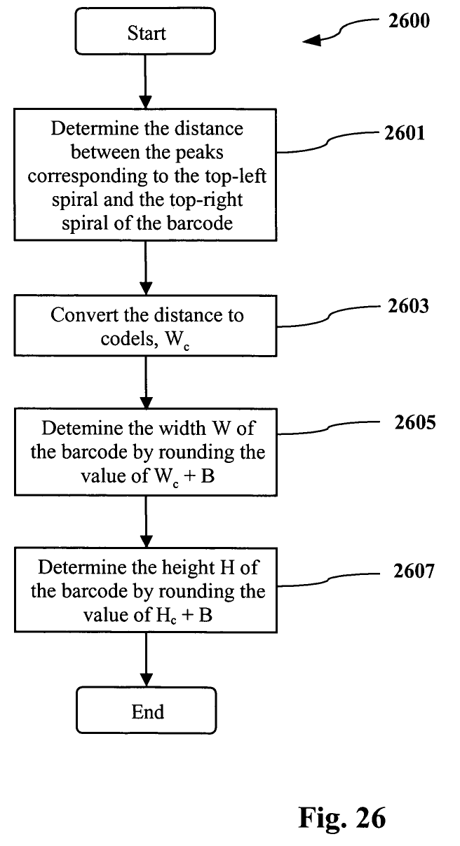

A method 2600 of determining the dimensions of the barcode 200, as executed at step 905, will now be described with reference to FIG. 26. The method 2600 may be implemented as software resident in the hard disk drive 110 and being controlled in its execution by the processor 105.

The method 2600 begins at step 2601, where the processor 105 determines the distance between the peaks corresponding to the top-left spiral 801 and top-right spiral 803. This distance may be denoted by ∥q₁−q₃∥. At the next step 2603, the distance determined at step 2601 is converted from scanned pixels to codels by multiplying the distance ∥q₁−q₃∥ by Rₚ/Rₛ in accordance with Formula (6) below, where W_{c} represents the distance measured in codels:
W_{c}=∥q₁−q₃∥×Rₚ/Rₛ (6)
The value of W_{c} is an approximation of the distance between the centres of the two spirals 801 and 803 in the original barcode 200. W_{c} is equal to the width of the barcode 200, minus half the width of the top-left spiral 801, minus half the width of the top-right spiral 803. Since the width of the spirals 801 and 803 is the border width B, the width W of the barcode 200 is approximately W_{c}+B. At the next step 2605 of the method 2600, the width W is determined by rounding the value of W_{c}+B to the nearest multiple of the border width B, on the basis that the width W and height H of the barcode 200 are both multiples of the border width B.

At the next step 2607, the processor 105 determines the barcode height H by rounding the value of H_{c}+B in accordance with Formula (7) as follows:
H_{c}+B=∥q₁−q₆∥×Rₚ/Rₛ+B (7)
to the nearest multiple of the border width B. The method 2600 concludes following step 2607.

The coarse-alignment affine transform is specified by a matrix A and a vector a. The coarse-alignment affine transform A is determined at step 905 using the width W and height H of the barcode 200 by determining the affine transform that takes the centres of the three spirals 801, 803, and 806, to the positions of the three peaks q₁, q₃, and q₆ in the scanned image. If the elements of the matrix A are denoted as follows:

$$A = ( \begin{matrix}{a}_{00} & {a}_{01} \\ {a}_{10} & {a}_{11}\end{matrix} ) \qquad ( 8 )$$

then the matrix A may be determined using Formulae (9) and (10), as follows:

$$\begin{matrix}( \begin{matrix}{a}_{00} \\ {a}_{10}\end{matrix} ) = \frac{1}{W - 2 B} ( {q}_{3} - {q}_{1} ) & ( 9 ) \\ ( \begin{matrix}{a}_{01} \\ {a}_{11}\end{matrix} ) = \frac{1}{H - 2 B} ( {q}_{6} - {q}_{1} ) & ( 10 )\end{matrix}$$

Then the vector a may be determined in accordance with Formula (11), as follows:

$$a = {q}_{1} - B ( \begin{matrix}{a}_{00} + {a}_{01} \\ {a}_{10} + {a}_{11}\end{matrix} ) \qquad ( 11 )$$

5.0 Salt and Border Patterns

Steps 403 of the method 400 of FIG. 4 and step 504 of the method 500 of FIG. 5 will now be described in more detail. As described above, at step 403, the processor 105 generates a border pattern for the barcode 200, storing data in the border codels (e.g., 203) of the barcode 200. Further, at the step 504, the processor 105 reads the border 201 of the barcode 200 and extracts data from the border 201 of the barcode 200. Each of steps 403 and 504 stores or reads a small amount of data (i.e., salt data) out of the border 201 of the barcode 200. The salt data may store metadata such as a version value representing the version of the barcode 200.

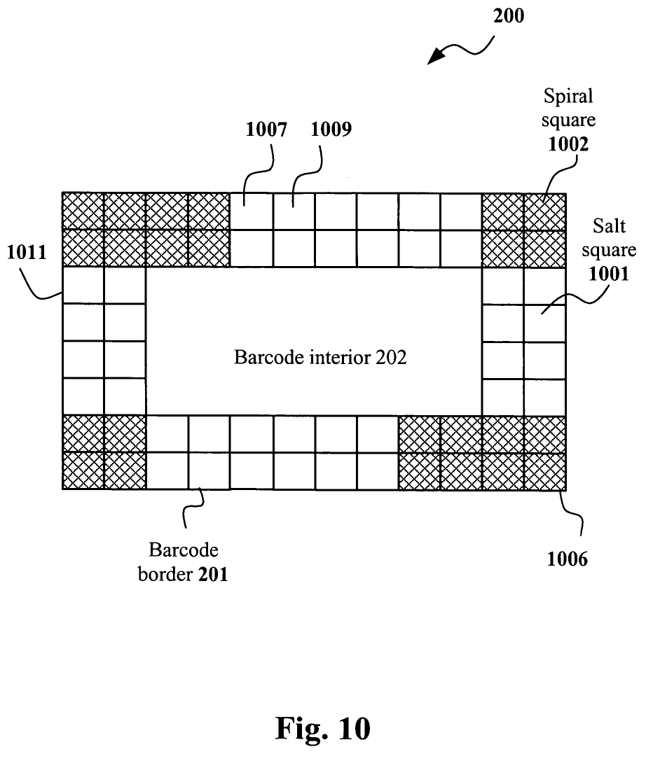

For the purposes of storing and reading the salt data, the barcode border 201 is divided into squares (e.g., 1001, 1002), as shown in FIG. 10. The barcode border 201 has width equal to B, and the barcode 200 has both height H and width W that are multiples of the border width B. Thus, the border 201 of the barcode 200 may be divided evenly into squares (e.g., 1001) with width and height equal to B/2. The square 1001 may be referred to as a ‘salt square’.

The cyan codels in the corners (e.g., 1006) of the barcode 200 contain spirals. As such, the salt squares (e.g., 1002) that lie where a spiral has been placed are removed from further consideration and are not considered as being salt squares. Each of the remaining salt squares, such as the square 1001, which have not been removed, may be used to store one bit of salt data.

For the purposes of storing and reading the salt data, two pseudo-random arrays, α₀ and α₁, may be used. These pseudo-random arrays, α₀ and α₁ represent noise patterns. Both of the arrays α₀ and α₁, at each triple of codel coordinates (x, y, c), contain a value αᵢ(x, y, c) that is either zero (0) or one (1). Since the αᵢ are pseudo-random, the values αᵢ(x, y, c) will appear random, even though the values are predetermined given x, y, and c. Any suitable pseudo-random number generation algorithm may be used to generate the arrays α₀ and α₁. For example, the arrays α₀ and α₁ may be generated using the RC4 algorithm, initialized with known seeds. The arrays α₀ and α₁ represent salt patterns, which may occur in the salt squares of the border 201, as will be described in detail below.

At step 403 the processor 105 assigns values to the codels in the border 201 of the barcode 200, in accordance with the salt data to be encoded. The number of bits of salt data that may be encoded is equal to the number of salt squares (e.g., 1001) that fit in the border 201 of the barcode 200, given the barcode dimensions (i.e., width W and height H). Thus, barcodes with different dimensions may be able to store different amounts of salt data.

The method 1100 of storing data in border codels of the barcode 200, as executed at step 403, will now be described in detail with reference to FIG. 11. The method 1100 may be implemented as software resident in the hard disk drive 110 and being controlled in its execution by the processor 105.

The method 1100 begins at step 1102 where the processor 105 iterates through the salt squares (e.g., 1001) of the barcode 200, in a predetermined order. For example, the processor 105 may iterate through the salt squares 1001 in scanline order. In this instance, on the first execution of step 1102, a leftmost salt square 1007 in the top row of salt squares is selected. This leftmost salt square 1007 becomes the currently selected salt square. On subsequent executions of 1102, subsequent salt squares (e.g., 1009 etc) in the topmost row will be selected, and then salt squares in subsequent rows will be selected, row by row. In some rows (e.g., row 1011) the salt squares may not all be adjacent.

At a following step 1103, the processor 105 sets the values of codels in a currently selected salt square (e.g., 1001). At step 1103 the processor 105 assigns the values of the codels in the currently selected salt square to corresponding values of αᵢ, as follows:
α(x, y, c)=αᵢ(x, y, c)
for all (x, y, c) in the selected salt square, where n is defined such that the currently selected salt square is the n-th salt square to be processed at step 1103, and i is the value of the n-th bit of the salt data.

At the next step 1104, if the processor 105 determines that there are more salt squares in the barcode 200 to be processed then the method 1100 returns to step 1102. Otherwise, the method 1100 proceeds to step 1105.

At step 1105, the processor 105 encodes random data into the magenta and yellow channel codels of the regions of the barcode border 201 where the six spirals 801, 802, 803, 804, 805 and 806 were embedded. For codels (x, y, c) in the magenta and yellow channel codels of the regions of the barcode border 201 where the six spirals 801, 802, 803, 804, 805 and 806 were embedded, an assignment is made as follows:
α(x, y, c)=α₀(x, y, c).
The method 1100 concludes following step 1105.
5.2 Reading the Salt Data

The method 1200 of extracting salt data from the border 201 of the barcode 200, as executed at step 504, will now be described with reference to FIG. 12. The method 1200 may be implemented as software resident on the hard disk drive 110 and being controlled in its execution by the processor 105.

In the method 1200, the processor 105 uses the coarse-alignment affine transform determined at step 905 and the scanned image of the barcode 200 to extract the salt data from the border 201 of the barcode 200.

The method 1200 begins at step 1202, where the processor 105 iterates through the salt squares (e.g., 1001) of the barcode 200. For example, the processor 105 may iterate through the salt squares in the same predetermined order used in step 1102 described above. The following steps 1203 to 1206 of the method 1200 determine which of the two salt patterns represented by the pseudo-random arrays α₀ or α₁ occur in a selected salt square 1001. This may be achieved by correlating both salt patterns with the selected salt square, and determining which of the salt patterns provides a larger result. Knowing which of the salt patterns correlate with the selected salt square enables the value of the data bit encoded in the selected salt square to be determined.

At step 1203, a coarsely-aligned image of the red color channel of the currently selected salt square is generated by the processor 105. The coarsely aligned image may be generated by interpolating the scanned image, in order to determine values for the coarsely aligned image at non-integer coordinates. The scanned image may be interpolated using bicubic interpolation. A vector of RGB values interpolated from the scanned image at the coordinates (x, y) in the scanned image coordinate system may be denoted as s(x, y).

The coarsely-aligned image of the red color channel of the currently selected salt square may be denoted by Uₛ. The image Uₛ has both height and width equal to half the border width (i.e., B/2). As an example, if the currently selected salt square has a top-left codel at coordinates (xₛ, yₛ, c), then pixels in Uₛ correspond to the codels with x-coordinates between xₛ and xₛ+B/2−1, and y-coordinates between yₛ and yₛ+B/2−1. If the x- and y-coordinates of Uₛ range from 0 to B/2−1, then the image Uₛ may be generated in accordance with Formula (12) as follows:

$${U}_{s} ( x , y ) = the red component of s ( A ( \begin{matrix}x + xs \\ y + ys\end{matrix} ) + a ) \qquad ( 12 )$$

That is, the codel coordinates are transformed using the coarse alignment affine transform, resulting in coordinates in the scanned image. The scanned image may then be interpolated at these coordinates, and the red component may be encoded into the coarsely-aligned image Uₛ.

Two images, U₀ and U₁, may also be generated at step 1203. The images U₀ and U₁ contain the expected salt patterns in the cyan channel, as represented by the arrays α₀ and α₁. The images U₀ and U₁ may be generated as follows:
U₀(x, y)=α₀(x+xₛ, y+yₛ).
U₁(x, y)=α₁(x+xₛ, y+yₛ) (13)

The method 1200 continues at the next step 1204, where the processor 105 performs two circular correlations. The circular correlation of two images I₁ and I₂ with the same dimensions generates a third image Iₓ with the same dimensions, according to Formula (14) below:

$${I}_{x} ( x , y ) = {\sum }_{{x}^{′} , {y}^{′}} {I}_{1} ( {x}^{′} , {y}^{′} ) {I}_{2} ( {x}^{′} + x , {y}^{′} + y ) \qquad ( 14 )$$

The sum of Formula (14) ranges over all x′ and y′ where I₁ is defined, and, in the image I₂, the values of pixels outside the image I₂ may be obtained by considering I₂ to be periodic.

Two circular correlations are performed at step 1204 in accordance with the Formula (14). The first of these circular correlations is the correlation of Uₛ and U₀, resulting in a correlation image U_{X0}. The second of these correlations is the correlation of Uₛ and U₁, resulting in a correlation image U_{X1}.

At the next step 1205, the processor 105 determines maximum values in the correlation images U_{X0} and U_{X1}. Then at the next step 1206, the processor 105 stores a salt bit in a buffer containing salt data, using the maximum values determined at step 1205. If the maximum value in image U_{X0} is greater than the maximum value in image U_{X1}, then the salt bit stored in the buffer is a zero (0). Otherwise, the largest value in U_{X1} is greater than the largest value in U_{X0}, and the salt bit stored in the buffer is a one (1). The buffer containing the salt data may be configured within memory 106. At the next step 1207, if the processor 105 determines that there are more salt squares to be processed, then the method 1200 returns to step 1202. Otherwise, the method 1200 concludes.

6.0 Fine Alignment

The method 1400 of generating an alignment pattern in the alignment codels (e.g., 205) of the barcode 200, as executed at step 404, will now be described in more detail with reference to FIG. 14. The method 1300 of determining three fine alignment warp maps for the scanned image of the barcode 200, as executed at step 505, will also be described. The three fine alignment warp maps are determined in the method 1300 using the alignment pattern generated in accordance with the method 1400.

The method 1400 may be implemented as software resident on the hard disk drive 110 and being controlled in its execution by the processor 105. The method 1400 comprises one step 1401, where the processor 105 encodes an alignment pattern into the data codels (e.g., 203) of the barcode 200. The alignment pattern used may be represented as a pseudo-random (i.e., noise) array of bits. For example, the pseudo-random array of bits α₀ described above may be used at step 1401. At step 1401, the processor 105 sets the value of each alignment codel (x, y, c) (e.g., 205) of the barcode 200 to α₀(x, y, c). The alignment pattern may be distributed uniformly across the data codels of the barcode 200. Alternatively, the alignment pattern may be distributed in one or more particular areas of the barcode 200.

The method 1300 of determining three fine alignment warp maps for the scanned image of the barcode 200, as executed at step 505, will now be described with reference to FIG. 13. The method 1300 may be implemented as software resident in the hard disk drive and being controlled in its execution by the processor 105.

The method 1300 generates three warp maps, one for each of the cyan, magenta, and yellow color channels of the scanned image of the barcode 200. The method 1300 uses the scanned image of the barcode 200, and the coarse alignment affine transform specified by the matrix A and the vector a according to Formula (11) and determines the warp map for the cyan color channel. The warp map for the cyan color channel may then be used to determine the warp maps for the magenta and yellow color channels of the scanned image. The method 1300 uses a variable c that is set to the color channel of a warp map that is currently being generated (i.e., the current color channel). The initial value of c is cyan.

The method 1300 begins at step 1302 where the processor 105 generates a coarsely-aligned image for the cyan color channel of the scanned image. The coarsely-aligned image is generated from the scanned image using the coarse alignment affine transform specified by the matrix A and the vector a. The dimensions of the coarsely-aligned image are the same as the dimensions of the barcode 200. In generating the coarsely-aligned image at step 1302, the processor 105 performs a color conversion on the scanned image, which extracts the cyan channel from the RGB colors in the scanned image.

A linear transform from RGB space may be used to perform the color conversion at step 1302. The cyan component of the scanned image may be generated from the red, green, and blue components of the scanned image in accordance with the following Formula (15):
cyan=−1.13×red+0.21×green+0.03×blue (15)

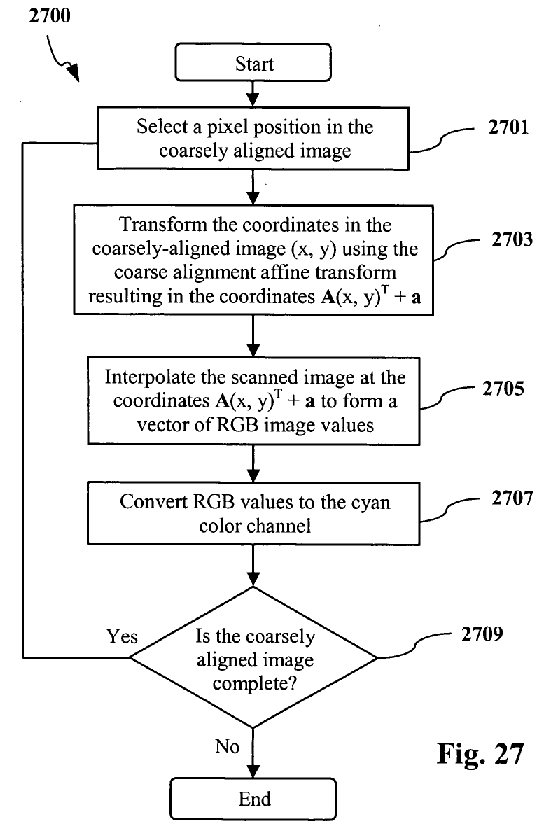

A method 2700 of generating a coarsely-aligned image for the cyan color channel of the scanned image, as executed at step 1302, will now be described with reference to FIG. 27. The method 2700 may be implemented as software resident in the hard disk drive 110 and being controlled in its execution by the processor 105.

The method 2700 begins at step 2701, where the processor 105 selects the coordinates for a first pixel position (i.e., a current pixel position) in the coarsely-aligned image. The coarsely-aligned image may be generated in memory 106, for example. At the next step 2703, the processor 105 transforms the selected coordinates in the coarsely-aligned image (x, y) using the coarse alignment affine transform, resulting in coordinates A(x, y)^{T}+a for the selected pixel in the scanned image. Then at the next step 2705, the processor 105 interpolates the scanned image at the coordinates A(x, y)^{T}+a, using bicubic interpolation, resulting in a vector of RGB image values. Then at the next step 2707, the processor 105 converts the RGB values to the cyan color channel, using Formula (15). The resulting cyan value is stored in the coarsely-aligned image configured within memory 106 as a pixel value in the cyan color channel at the current pixel position. Then at the next step 2709, if the coarsely aligned image is complete (i.e., all pixel values in the cyan color channel have been generated for the coarsely-aligned image), the method 2700 concludes. Otherwise, the method 2700 returns to step 2701 to select a next pixel position in the coarsely aligned image.

Alternatively, the scanned image may first be blurred with a low-pass filter prior to execution of the method 2700. Blurring the scanned image using the low-pass filter may reduce the effects of aliasing introduced when a high-resolution scanned image is transformed to produce a lower-resolution coarsely-aligned image. Any suitable low-pass filter may be used to blur the scanned image. The selection of the low-pass filter may be based on the ratio between the resolution of the scanned image and the resolution of the barcode 200.

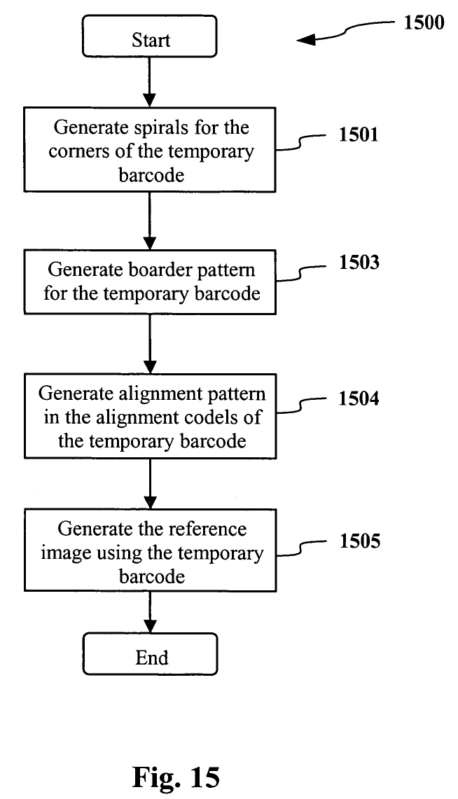

Following step 1302 of the method 1300, at the next step 1303, the processor 105 generates a reference image for the current color channel c. A method 1500 for generating a reference image for the current color channel, as executed at step 1303, will now be described with reference to FIG. 15. The method 1500 may be implemented as software resident on the hard disk drive 110 and being controlled in its execution by the processor 105.

The method 1500 generates a temporary barcode with the same parameters (i.e., dimensions and salt value) as the barcode 200. The temporary barcode may be configured within memory 106. The temporary barcode may be used to generate the reference image. The barcode dimensions and salt value used in the method 1500 have been determined previously in steps 502 and 504 of the method 500.

The method 1500 begins at step 1501, where the processor 105 generates spirals for the corners of the temporary barcode, in a similar manner to the generation of the spirals for the barcode 200 at step 402 of the method 400. At the next step 1503, the processor 105 generates a border pattern for the temporary barcode, storing data in the border codels of the temporary barcode, in a similar manner to the generation of the border pattern for the barcode 200 at step 402 of the method 400. Then at the next step 1504, the processor 105 generates an alignment pattern in the alignment codels of the temporary barcode, in a similar manner to the generation of the alignment pattern at step 404 of the method 400 for the barcode 200. Accordingly, at step 1504, all of the codels in the temporary barcode have been assigned values, except for the data codels.

The method 1500 continues at the next step 1505 where the processor 105 generates the reference image, within memory 106, using the temporary barcode. Initially the reference image is empty. When the codels in the temporary barcode of the color channel c are “on”, a corresponding pixel in the reference image is set to a value of +1, and when the codels are “off”, the corresponding pixel in the reference image is set to a value of −1. For the data codels which have not been assigned values previously, the corresponding pixel in the reference image is given a value of 0. The method 1500 concludes following step 1505.

At step 1303, where spirals are printed at a higher resolution than the resolution of the codels of the barcode 200 in the cyan channel where the spirals are to be embedded, rather than dividing these codels into F×F pixels, the codels may be left undefined. In this instance, the pixels in the reference image corresponding to undefined codels in the temporary barcode may be assigned the value 0.

At the next step 1304 of the method 1300, the processor 105 uses the coarsely-aligned image and the reference image to generate a displacement map d_{c} for the color channel c. The displacement map d_{c} stores displacement vectors. Each displacement vector stored is associated with a location in the reference image, and measures the amount of shift between the reference image and the coarsely-aligned image at that location.

The displacement map d_{c} may be generated at step 1304 using a tiled correlation method. The generation of the displacement map d_{c} involves selection of a tile size 2 Q and a step size P. The tile size and step size may be varied. Larger values of Q give more measurement precision, at the expense of averaging the increased precision over a larger spatial area, and possibly more processing time. Smaller values of step size P give more spatial detail. However, again using smaller values of step size P may increase processing time. As an example, in the cyan color channel, Q=64, and P=32. This represents a tile of 128 pixels high by 128 pixels wide, stepped along the reference image and the coarsely-aligned image, in both horizontal and vertical directions, in 32 pixel increments.

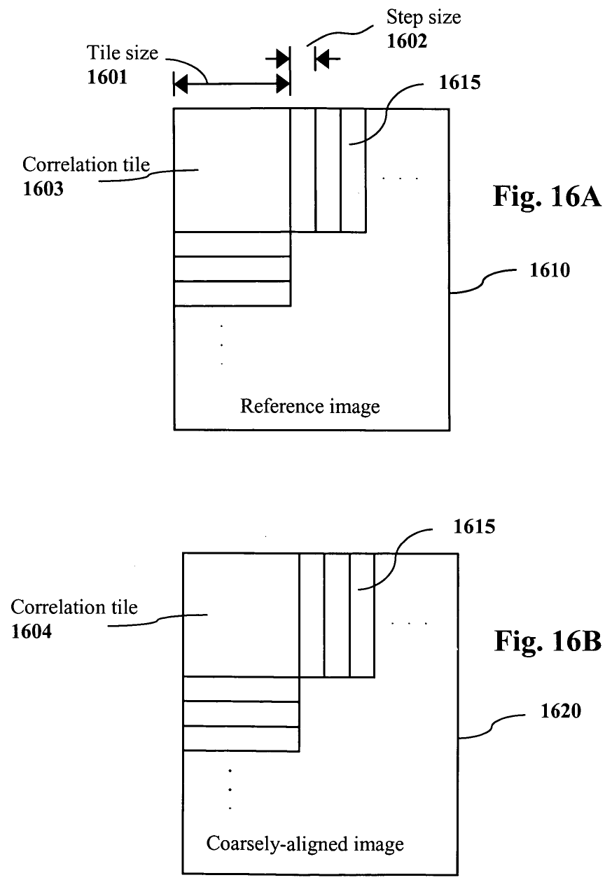

FIG. 16A shows a correlation tile 1603 of the reference image 1610, which may be used in step 1304. The correlation tile 1603 has a corresponding correlation tile 1604 in the coarsely-aligned image 1620, as seen in FIG. 16B. Both of the correlation tiles 1603 and 1604 have vertical and horizontal dimensions equal to 2 Q, shown as 1601. The correlation tiles 1603 and 1604 are stepped in horizontal and vertical increments according to the step size P, shown as 1602.

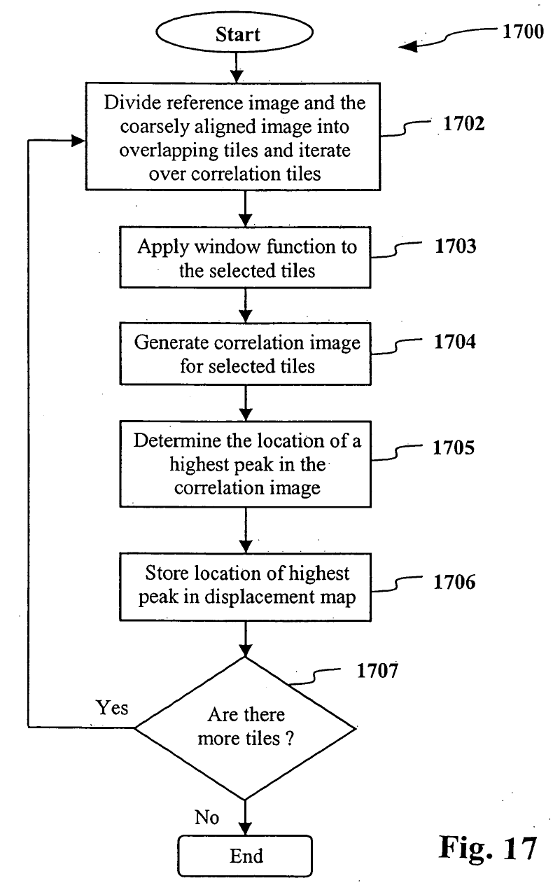

A method 1700 of generating a displacement map d_{c} for the color channel c, as executed at step 1304, will now be described with reference to FIG. 17. The method 1700 may be implemented as software resident in the hard disk drive 110 and being controlled in its execution by the processor 105.

The method 1700 begins at step 1702, where the processor 105 divides the reference image 1610 and the coarsely-aligned image 1620 into overlapping tiles as described with reference to FIG. 16 and iterates through the tiles in both images 1610 and 1620. On a first execution of step 1702, top-left corner tiles 1603 and 1604 from both the reference image 1610 and the coarsely-aligned image 1620, respectively, are selected. On subsequent executions of step 1702, subsequent pairs of corresponding tiles are selected, from left to right in each row of tiles, starting with a first row of tiles (e.g., 1615), and finishing at a bottom row of tiles. The tile 1603 selected at step 1702 from the reference image may be denoted as T₁, and the selected tile 1604 from the coarsely-aligned image may be denoted T₂. Furthermore, the coordinates of the centre of the tiles 1603 and 1604 may be denoted as (x, y).

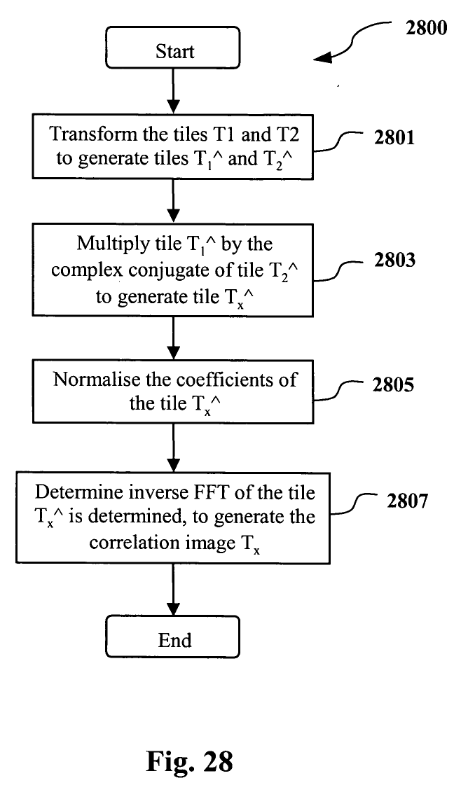

Once the pair of corresponding tiles T₁ and T₂ has been selected at step 1702, at a next step 1703, the selected tiles T₁ and T₂ are windowed. The tiles T₁ and T₂ may be windowed at step 1703 by a Hanning window in a vertical direction, and a Hanning window in a horizontal direction. At the next step 1704, the selected tiles T₁ and T₂ are then circular phase correlated to generate a correlation image for the selected tiles. The correlation image for the selected tiles may be configured within memory 106. The circular phase correlation is performed at step 1704 via the frequency domain. A method 2800 of generating a correlation image for the selected tiles as executed at step 1704 will now be described with reference to FIG. 28.

The method 2800 begins at the first step 2801, where the processor 105 transforms the selected tiles T₁ and T₂ using a Fast Fourier Transform (FFT), to generate tiles T₁ˆ and T₂ˆ. At the next step 2803, the processor 105 multiplies the tile T₁ˆ by the complex conjugate of tile T₂ˆ to generate tile Tₓˆ. Then at the next step 2805, the processor 105 normalises the coefficients of the tile Tₓˆ, so that each coefficient has unit magnitude. The method 2800 concludes at the next step 2807, where the inverse FFT of the tile Tₓˆ is determined, to generate the correlation image Tₓ, for the tiles T₁ and T₂ selected at step 1702. The correlation image Tₓ is an array of dimensions 2 Q by 2 Q of real values and may be configured within memory 106.

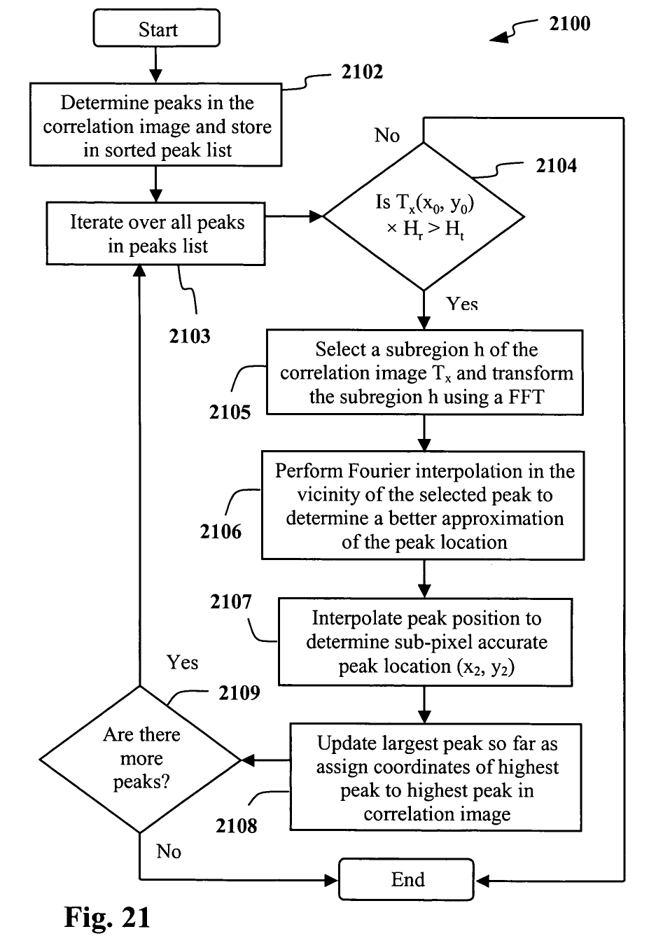

Returning to the method 1700, at the next step 1705, the processor 105 processes the correlation image Tₓ to determine a displacement vector representing the location, denoted (Δx, Δy)^{T}, of a highest peak in the correlation image Tₓ, to sub-pixel accuracy. A method 2100 of determining the location of the highest peak in the correlation image Tₓ to sub-pixel accuracy, as executed at step 1705, will be described below with reference to FIG. 21. The location of the peak represented by the displacement vector (Δx, Δy)^{T}, in the correlation image Tₓ measures the amount of shift between the tiles T₁ and T₂, and hence the displacement, or warping, between the reference image and the coarsely-aligned image in the vicinity of T₁ and T₂.

The method 1700 continues at the next step 1706, where the processor 105 stores the location (Δx, Δy)^{T} of the highest peak in the displacement map d_{c} at the location of the centre of the selected tiles. At step 1706, the processor 105 assigns d_{c} (x, y)=(Δx, Δy)^{T}, where (x, y) represents the coordinates of the centre of the tiles T₁ and T₂. However, if a peak in the correlation image Tₓcould not be determined at step 1705, no peak location is stored in the displacement map d_{c}(x, y).

At the next step 1707, if the processor 105 determines that there are more tiles in the reference image and the coarsely-aligned image to be processed, then the method 1700 returns to step 1702. Otherwise, the method 1700 concludes.

The displacement map d_{c} generated in accordance with the method 1700 is defined at some locations (x, y), where the possible locations (x, y) are the centres of correlation tiles. Since the tiles were stepped with a horizontal and vertical increment of step size P, the displacement map d_{c} may be defined at a set of points lying in a regular grid with spacing P.

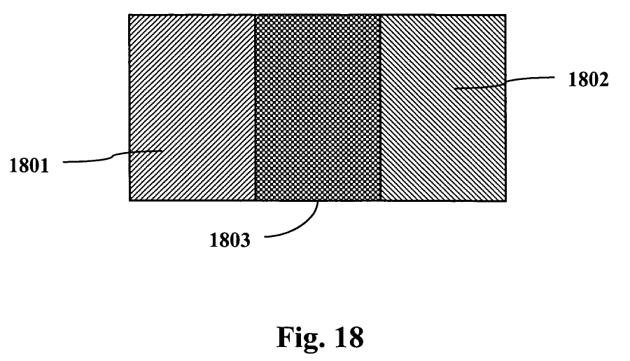

Since the tiles (e.g., 1603, 1604) used for correlations in the method 1700 are overlapping, some of the calculations performed in determining the FFT of previous tiles, may be reused when calculating the FFT of subsequent tiles. This may increase the speed of the fine alignment. An alternative method 1900 for determining the Fast Fourier Transform (FFT) of correlation tiles, as executed at steps 1703 and 1704, will now be described with reference to FIGS. 18 and 19.

FIG. 18 shows two overlapping tiles 1801 and 1802. The tile 1801 is shaded with north-easterly lines and the tile 1802 is shaded with south-easterly lines. A region 1803 as shown in FIG. 18 represents the overlap of the tiles 1801 and 1802. The amount of overlap of the tiles 1801 and 1802 represented by the region 1803 is equal to 2 Q−P columns, where 2 Q represents the tile size and P represents the step size as described above.

The method 1900 may be implemented as software resident on the hard disk drive 110 and being controlled in its execution by the processor 105. The method 1900 begins at step 1902, where if the processor 105 determines that the tiles T₁ and T₂ overlap with the tiles T₁ and T₂ from a previous execution of the loop (i.e., defined by steps 1702 to 1707) of the method 1700, the method 1900 proceeds to step 1904. Otherwise, the method 1900 proceeds to step 1903. At step 1903, each column of the tiles T₁ and T₂ is windowed vertically, and then a vertical FFT is applied to the tiles T₁ and T₂, resulting in processed data for T₁ and T₂. At the next step 1906, the method 1900 stores the right-most 2 Q−P columns of processed data from both of the tiles T₁ and T₂ in a cache of processed columns configured within memory 106. Any data in the cache may be overwritten at step 1906. The method 1900 concludes at the next step 1907 where the processor 105 windows and applies a horizontal FFT to each row of the processed data for the tiles T₁ and T₂. Data resulting from step 1907 represents a two-dimensional windowed FFT of the tiles T₁ and T₂.

At step 1904, there is no need to determine the leftmost 2 Q−P columns of processed data. Rather these columns of data may be copied out of the cache of processed columns configured within memory 106. Then at the next step 1905, the processor 105 applies the window and vertical FFT to each of the remaining P columns of the tiles T₁ and T₂. Following step 1905, the method 1900 proceeds to the step 1906 and the method 1900 concludes.

Returning to the method 1300 of FIG. 13, following the generation of the displacement map d_{c} for the cyan color channel at step 1304, the following steps of the method 1300 may use the displacement map d_{c} to generate a warp map w_{c} for the cyan color channel. The warp map w_{c} maps each codel in the cyan color channel of the barcode 200 to a location in the coordinate space of the scanned image of the barcode 200. Some parts of the warp map w_{c} may map codels in the barcode 200 to coordinates outside the scanned image, since the scanner 119 may not have scanned the entire barcode 200.

If (x, y) are the coordinates of a pixel in the reference image, then the displacement map d_{c}(x, y) represents the shift to a corresponding location in the coarsely-aligned image. Therefore, the corresponding coordinates in the coarsely-aligned image may be determined as (x, y)^{T}+d_{c}(x, y). Applying the coarse alignment affine transform to the reference image provides the coordinates in the scanned image. The warp map w_{c} maps each codel (x, y, c) in the cyan color channel of the barcode 200 to a location in the coordinate space of the scanned image of the barcode 200 in accordance with Formula (16) as follows:
w_{c}(x, y)=A((x, y)^{T}+d_{c}(x, y))+a (16)

However, the displacement map d_{c}(x, y) is only defined at a few places, namely the locations of the centres of some correlation tiles (e.g., 1603 and 1604). In order to determine a value for Formula (16) at the locations of all codels in the cyan color channel of the barcode 200, the displacement map d_{c} is interpolated.

The method 1300 continues at the next step 1305, where the processor 105 determines an affine transform defined by a matrix G and vector g. The affine transform determined at step 1305 may be referred to as a gross approximation affine transform. The gross approximation affine transform approximates the warp map w_{c} with an affine transform. The error function to be minimized in determining the affine transform is the Euclidean norm measure E that may be defined according to Formula (17) as follows:

$$E = {\sum }_{( x , y )} {‖ G ( \begin{matrix}x \\ y\end{matrix} ) + g - {w}_{c} ( x , y ) ‖}^{2} \qquad ( 17 )$$

Formula (17) may be solved using least squares minimisation methods to determine the affine transform in accordance with Formula (18) as follows:

$$( G \vert g ) = ( {\sum }_{( x , y )} {w}_{c} ( x , y ) {( \begin{matrix}x \\ y \\ 1\end{matrix} )}^{T} ) {( {\sum }_{( x , y )} ( \begin{matrix}x \\ y \\ 1\end{matrix} ) {( \begin{matrix}x \\ y \\ 1\end{matrix} )}^{T} )}^{- 1} \qquad ( 18 )$$

For both Formulae (17) and (18), the sums are taken over all coordinate pairs (x, y) where the displacement map d_{c}(x, y) is defined, and hence the warp map w_{c}(x, y) is defined, via Formula (16).

At the next step 1306 of the method 1300, the processor 105 removes the gross approximation affine transform from the warp map w_{c} to generate a modified warp map w_{c}′ in accordance with Formula (19) as follows:
w_{c}′(x, y)=w_{c}(x, y)−G(x, y)−g (19)
where the modified warp map w_{c}′ is defined at coordinates (x, y) at which d_{c}(x, y) is defined. Thus, the modified warp map w_{c}′ is defined at some points (x, y) that lie on the grid formed by the centres of the correlation tiles (e.g., 1603, 1604).

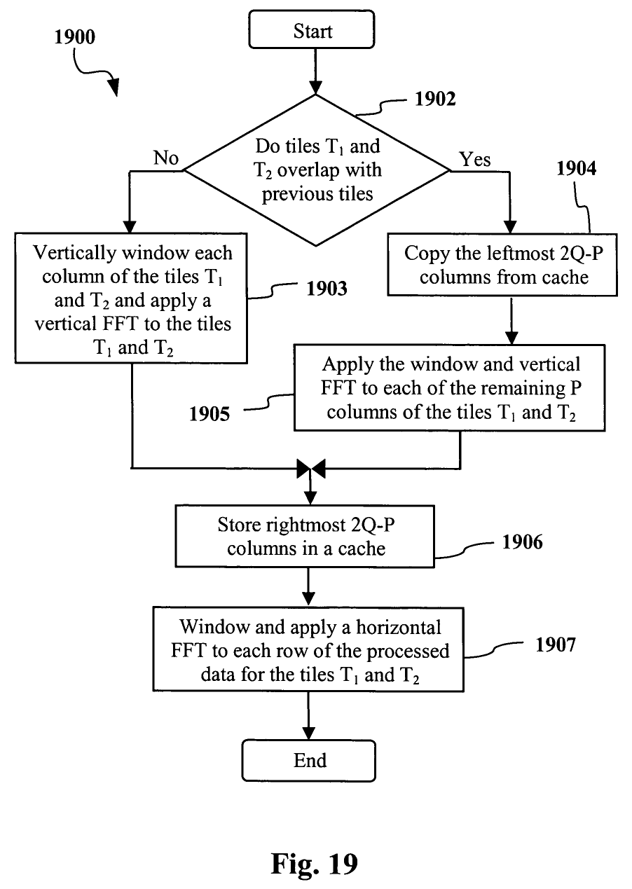

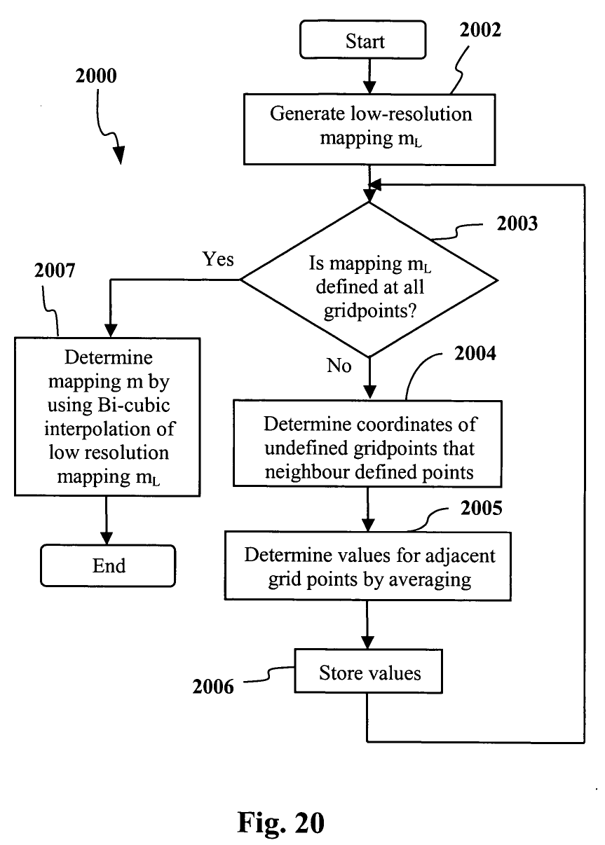

The method 1300 continues at the next step 1307, where the processor 105 interpolates the modified warp map w_{c}′, so that the modified warp map w_{c}′ is defined at all codel coordinates (x, y, c) in the barcode 200. A method 2000 of interpolating a mapping, as executed at step 1307, will be described in detail below with reference to FIG. 20.

At the next step 1308, the processor 105 then reapplies the previously removed gross approximation affine transform to the modified warp map w_{c}′ to generate the warp map w_{c} in accordance with Formula (20) as follows:
w_{c}(x, y)=w_{c}′(x, y)+G(x, y)^{T}+g (20)
The warp map for the cyan color channel is now defined at all codels in the barcode 200 and may be denoted w_{cyan}. The warp map w_{cyan} for the cyan color channel may be used to determine the warp maps for the magenta w_{magenta} and yellow w_{yellow} color channels of the scanned image of the barcode 200.

At the next step 1309, the processor 105 sets the value of the variable c to magenta such that c becomes the current color channel. In the following execution of step 1309, the processor 105 sets the value of c to yellow, as will be described below. The method 1300 continues at the next step 1310, where the processor 105 generates a coarsely-aligned image for the current color channel c (i.e., magenta in the first execution of step 1309). The coarsely-aligned image may be generated from the scanned image using the warp map for the cyan channel w_{cyan}. The size of the coarsely-aligned image is the same as the dimensions of the barcode 200. In generating the coarsely-aligned image for the current color channel c, the processor 105 performs a color conversion, which extracts the color channel c from the RGB colors in the scanned image.

A linear transform from the RGB space may be used to perform the color conversion at step 1310. The magenta or yellow components for the coarsely-aligned images may be generated from the red, green, and blue components in accordance with Formulae (21) and (22) as follows:
magenta=0.79×red−1.51×green+0.13×blue (21)
yellow=−0.20×red+1.24×green−1.58×blue (22)

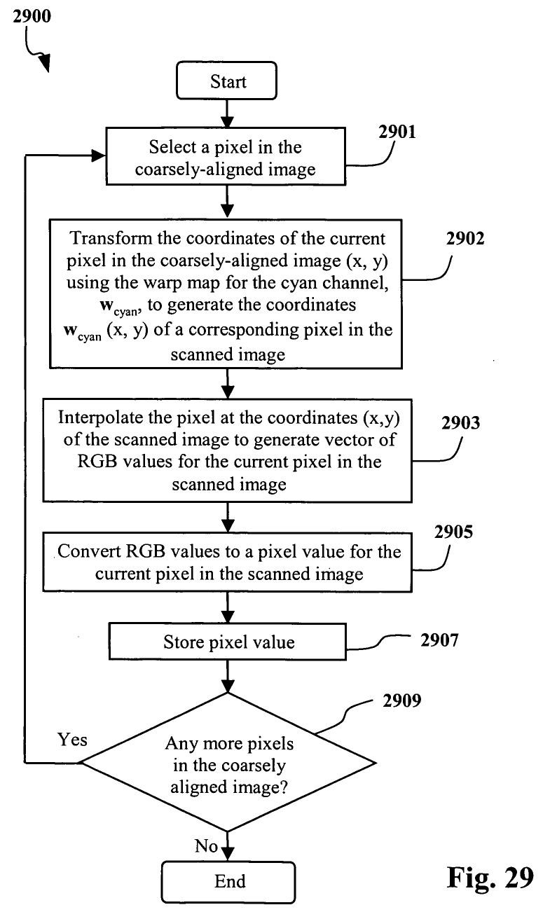

A method 2900 of generating a coarsely-aligned image, as executed at step 1310, will now be described with reference to FIG. 29. The method 2900 may be implemented as software resident on the hard disk drive 110 and being controlled in its execution by the processor 105. In the method 2900, the processor 105 generates each pixel value in the coarsely-aligned image for the current color channel c.

The method 2900 begins at step 2901, where the processor 105 selects a first pixel in the coarsely-aligned image. At the next step 2902, the processor 105 transforms the coordinates of the selected pixel in the coarsely-aligned image (x, y) using the warp map for the cyan channel, w_{cyan}, to generate the coordinates w_{cyan}(x, y) of a corresponding pixel in the scanned image. At the next step 2903, the pixel at the coordinates (x,y) of the scanned image determined at step 2901 is then interpolated, using bicubic interpolation, resulting in a vector of RGB image values. Then at the next step 2905, these RGB values determined at step 2903 are converted to a pixel value for the current color channel c, using Formula (21), or (22), depending on the current color component being determined. At the next step 2907, the pixel value for the current color channel c is stored in the coarsely aligned image in memory 106. Then at step 2909, if the processor 105 determines that there are more pixels in the coarsely aligned image to be generated for the current color channel c, the method 2900 returns to step 2901 to select a next pixel in the coarsely-aligned image. Otherwise, the method 2900 concludes.

The method 1300 continues at the next step 1311, where the processor 105 generates a reference image for the current color channel c. The reference image is generated at step 1311, in accordance with the method 1500 described above.

The method 1300 continues at the next step 1312, where the processor 105 uses the coarsely-aligned image and the reference image to generate a displacement map d_{c} for the current color channel c. The displacement map d_{c} is generated for the current color channel c in accordance with the method 1700 described above. In determining the displacement map d_{c} for the current color channel c the following values for tile size Q and step size P may be used, Q=32 and P=32, for each of the color channels. These values for Q and P represent a tile of sixty-four (64) pixels high by sixty-four (64) pixels wide, stepped along the reference image and the coarsely-aligned image, in both horizontal and vertical directions, in thirty two (32) pixel increments. Alternatively different values of Q and P may be selected for each of the magenta and yellow color channels.

The method 1300 continues at the next step 1313, where the processor 105 interpolates the displacement map d_{c}for the current color channel c to determine a displacement map which is defined at every codel in the barcode 200. The partially defined displacement map d_{c} is interpolated in accordance with the method 2000, which will be described in detail below with reference to FIG. 20. At the next step 1314, the processor 105 determines the warp map w_{c} for the current color channels c. The warp map w_{c} for the current color channel c is equal to the composition of the displacement map d_{c} and the warp map w_{cyan} for the cyan color channel.

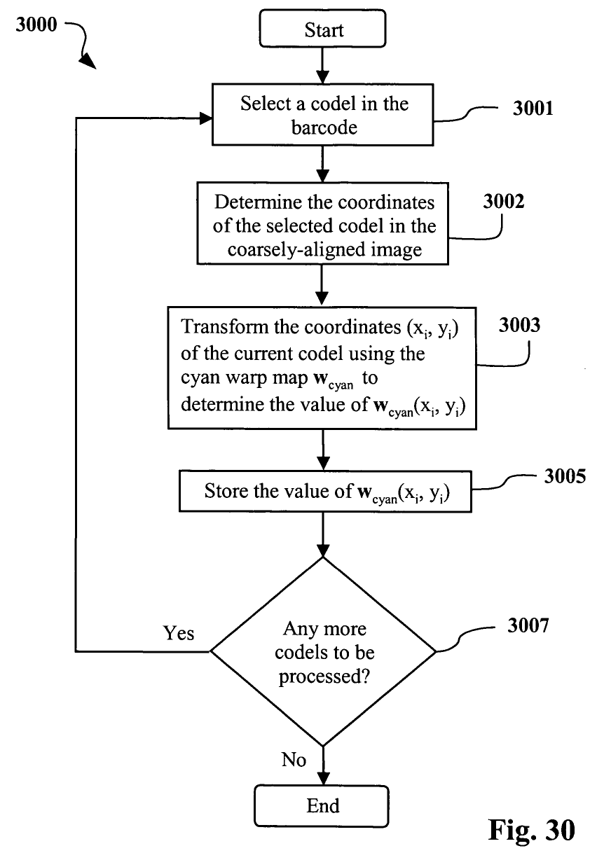

A method 3000 of determining a warp map w_{c} for the current color channel, as executed at step 1314, will now be described in detail below with reference to FIG. 30. The method 3000 begins at step 3001, where the processor 105 selects a first codel (x, y, c) in the color channel c of the barcode 200. At the step 3002, the processor 105 determines the coordinates (xᵢ, yᵢ) for the currently selected codel in accordance with Formula (23) as follows:
(xᵢ, yᵢ)=(x, y)+d_{c}(x, y) (23)
The codel i may be referred to as the current codel. Then at the next step 3003, the processor 105 transforms the coordinates (xᵢ, yᵢ) of the current codel using the cyan warp map w_{cyan} to determine the value of w_{cyan}(xᵢ, yᵢ). However, the values of xᵢ and yᵢ are not integers in general. Therefore, the warp map for the cyan color channel w_{cyan} is interpolated at step 3003. The interpolation may be performed using a low-resolution mapping m_{L} generated in accordance with the method 2000 when interpolating the cyan warp map w_{cyan}. The low-resolution mapping m_{L} may be interpolated at (xᵢ, yᵢ) using bicubic interpolation. Then, the gross approximation affine transform is added to the low-resolution mapping m_{L}(xᵢ, yᵢ) in accordance with Formula (24) as follows:
w_{cyan}(xᵢ, yᵢ)=m_{L}(xᵢ, yᵢ)+G(xᵢ, yᵢ)+g (24)
Following the addition of the gross approximation affine transform to the low-resolution mapping m_{L}(xᵢ, yᵢ) at step 3003, at the next step 3005, the value of w_{cyan}(xᵢ, yᵢ) is stored in the warp map w_{c} configured within memory 106 at w_{c}(x, y). At the next step 3007, if the processor 105 determines that the warp map w_{c} for the current color channel c is defined at all codels in the barcode 200, then the method 3000 concludes. Otherwise, the method 3000 returns to step 3001 to select a next codel in the barcode 200.

At the next step 1315 of the method 1300, if the processor 105 determines that warp maps have been determined for each color channel of the barcode 200, then the method 1300 concludes concluding the fine alignment. Otherwise, the method 1300 returns to step 1309.

6.1 Map Interpolation

The method 2000 of interpolating a mapping, as executed at step 1307 in relation to the modified warp map w_{c}′, and as executed at step 1313 in relation to the displacement map d_{c}, will be described in detail below with reference to FIG. 20. The method 2000 may be implemented as software resident in the hard disk drive 110 and being controlled in its execution by the processor 105.

The method 2000 uses a mapping m defined at the centre of one or more correlation tiles (e.g., 1603 and 1604). The mapping m is either the modified warp map w′_{c} as determined at step 1306, or the displacement map d_{c} as determined at step 1312. The mapping m is interpolated in accordance with the method 2000 to be defined at coordinates (x, y) for all codels (x, y, c) in the barcode 200.

The method 2000 begins at step 2002 where the processor 105 generates a low-resolution mapping m_{L} within memory 106 and initializes the values of the mapping m_{L}. At step 2002, the mapping m_{L} is defined at coordinates (x, y) where m is defined, and is assigned the same values as m at those points. Thus, the mapping m_{L} is defined at some of the points at the centres of correlation tiles. The centres of the correlation tiles form a grid with a spacing equal to the tile step size, P.

A set of points referred to as “gridpoints” may be defined. The gridpoints comprise the points that are the centres of correlation tiles, and additionally include other points which are not at the centre of a correlation tile. These other points may be obtained by extending the regular grid formed by the tile centres. Gridpoints may be defined as those points (x, y) in the extended grid whose coordinates lie in the range as follows:
−2P<x<W+2P (25)
−2P<y<H+2P (26)
With gridpoints defined as above, the coordinates of the gridpoints may be determined in accordance with Formula (27) as follows:
(x, y)=(Q+XP, Q+YP) (27)
where X and Y are integers, and X and Y lie in the following ranges:

$$\begin{matrix}⌊ - \frac{Q}{P} - 1 ⌋ \leq X \leq ⌈ \frac{W - Q}{P} + 1 ⌉ & ( 28 ) \\ ⌊ - \frac{Q}{P} - 1 ⌋ \leq Y \leq ⌈ \frac{H - Q}{P} + 1 ⌉ & ( 29 )\end{matrix}$$

The value of points in the mapping m_{L} at each of the gridpoints (x, y) may be determined in accordance with steps 2003 to 2007 described below. The mapping m_{L} was defined where m is defined in step 2002. At step 2003, the method 2000 begins a loop (i.e., defined by steps 2003 to 2006) that determines the remaining values of the mapping m_{L}. At step 2003, if the processor 105 determines that the mapping m_{L} has been defined at all gridpoints (x, y) then the method 2000 continues at the next step 2007. Otherwise, the method 2000 proceeds to step 2004. At step 2004, the processor 105 determines the coordinates of all undefined gridpoints that are adjacent to (i.e., neighbour) defined gridpoints. Then at step 2005, the processor 105 determines values for each of the gridpoints found in step 2004. The value for adjacent gridpoints is set to the average of the values of the low resolution mapping m_{L} at adjacent defined gridpoints. Then at the next step 2006, the values determined at step 2005 are stored in the low resolution mapping m_{L} configured within memory 106. The method 2000 then returns to step 2003.

As described above, at step 2003, if the processor 105 determines that the low resolution mapping m_{L} has been defined at all gridpoints (x, y) then the method 2000 continues at the next step 2007. At step 2007, the low resolution mapping m_{L} has been determined at all gridpoints, and may be used to interpolate the mapping m. At step 2007, the mapping m is interpolated at all codel coordinates (x, y, c) using bi-cubic interpolation on the mapping m_{L}.

6.2 Peak Detection

The method 2100 of determining the location (Δx, Δy) of a highest peak in the correlation image Tₓ, to sub-pixel accuracy, as executed at step 1705, will now be described with reference to FIG. 21. The location (Δx, Δy) of the highest peak in the correlation image Tₓ represents the shift between the two tiles T₁ and T₂ being correlated. The method 2100 may be implemented as software resident in the hard disk drive 110 and being controlled in its execution by the processor 105.

The method 2100 analyses the correlation image Tₓ and determines the location (Δx, Δy) of the highest peak in the correlation image Tₓ to sub-pixel accuracy. The method 2100 selects an initial peak height threshold Hᵢ and a peak height ratio Hᵣ. The initial peak height threshold Hᵢ and the peak height ratio Hᵣ parameters may be varied. Increasing the initial peak height threshold Hᵢ decreases the number of peaks considered acceptable. Decreasing the peak height ratio Hᵣ increases the speed of execution of the method 2100 and also increases the chance that a wrong peak will be selection as the highest peak. The initial peak height threshold Hᵢ and the peak height ratio Hᵣ parameters may be set to Hᵢ=0.1 and Hᵣ=4.

The method 2100 begins at step 2102, where the processor 105 determines all “peaks” in the correlation image Tₓ. A “peak” is a pixel in the correlation image Tₓ with coordinates (x₀, y₀), whose pixel value Tₓ(x₀, y₀) is larger than the values of eight neighbouring pixels of the pixel. This means that pixels on the edges of the correlation image Tₓ may be regarded as having eight neighbours, since the correlation image Tₓ uses periodic boundary conditions. Pixels on the left edge may be regarded as adjacent to the corresponding pixels on the right edge, and similarly the pixels on the top edge may be regarded as adjacent to the corresponding pixels on the bottom edge. The peaks in the correlation image Tₓ may be stored in a list configured within memory 106. The peaks may be stored in the list in decreasing order of peak pixel value.

Each peak in the peak list has integer coordinates (x₀, y₀). These coordinates (x₀, y₀) provide a good first approximation to the shift between the reference and coarsely-aligned images. However, to obtain sub-pixel accurate coordinates (Δx, Δy) for the location of the highest peak, the correlation image Tₓ is interpolated in the vicinity of each peak. The method 2100 processes each peak in the peak list, and interpolates the correlation image Tₓ to determine the sub-pixel accurate peak location.

Also at step 2102, a variable Hₜ is initialized to an initial value of the initial peak height threshold Hᵢ. At the next step 2103, the processor 105 iterates over all of the peaks in the peak list. On the first execution of step 2103, a first peak in the peak list is selected. On subsequent executions of step 2103 subsequent peaks in the peak list are selected. At step 2104, the value of the peak pixel Tₓ(x₀, y₀) selected at step 2103 is analysed by the processor 105 to determine whether the peak pixel value Tₓ(x₀, y₀) multiplied by the peak height ratio Hᵣ is larger than the current peak height threshold Hₜ. That is, the processor 105 determines whether:
Tₓ(x₀, y₀)×Hᵣ>Hₜ (30)

If the peak pixel value Tₓ(x₀, y₀) multiplied by the peak height ratio Hᵣ is larger than the current peak height threshold Hₜ, then the method 2100 proceeds to step 2105. Otherwise, the method 2100 concludes. At step 2105, the processor 105 selects a sub-region, h, of the correlation image Tₓ. The sub-region, h, has width and height of 2 Z pixels, where Z=8. The sub-region h is also centred at the coordinates (x₀, y₀) of the peak selected at step 2103. The value of the sub-region, h, may be determined in accordance with Formula (31) as follows:
h(x, y)=Tₓ(x₀+x−Z, y₀+y−Z) (31)
for x and y in the range 0 to 2Z−1, where the values of the correlation image Tₓ outside the image are obtained by again applying periodic boundary conditions to the correlation image Tₓ. That is, the values of the correlation image Tₓ outside the image are obtained by making the correlation image periodic. At step 2105, the selected sub-region, h, is then transformed with the Fast Fourier Transform (FFT) to determine a transformed image hˆ.

The transformed image, hˆ, is then used at the next step 2106, where the processor 105 interpolates the correlation image Tₓ in the vicinity of the peak (x₀, y₀) to determine an approximation (x₁, yᵢ) of the location of the peak. The correlation image Tₓ may be interpolated at twenty-five (25) points, where x and y coordinates may be determined as follows:
x ε {x₀−0.5, x₀−0.25, x₀+0, x₀+0.25, x₀+0.5}
y ε {y₀−0.5, y₀−0.25, y₀+0, y₀+0.25, y₀+0.5}
The interpolation performed at step 2106 is Fourier interpolation and is executed using Formula (32) as follows:

$$\begin{matrix}C ( {x}_{ 0} + δ x , {y}_{ 0} + δ y ) = h ( Z + δ x , Z + δ y ) \\ = {\sum }_{k = - Z}^{Z} {\sum }_{n = - Z}^{Z} \hat{h} ( k , n ) {β}_{k} ( Z + δ x ) {β}_{n} ( Z + δ y )\end{matrix} \qquad ( 32 )$$

where β is defined as follows:

$${β}_{k} ( x ) = \{ \begin{matrix}{ⅇ}^{jπ kx / Z} & if k \neq \pm Z \\ \frac{1}{2} {ⅇ}^{jπ kx / Z} & if k = \pm Z\end{matrix} \qquad ( 33 )$$

A better approximation to the peak location may be found using the value of (x₁, y₁) at which the interpolated value Tₓ(x₁, y₁) is largest.

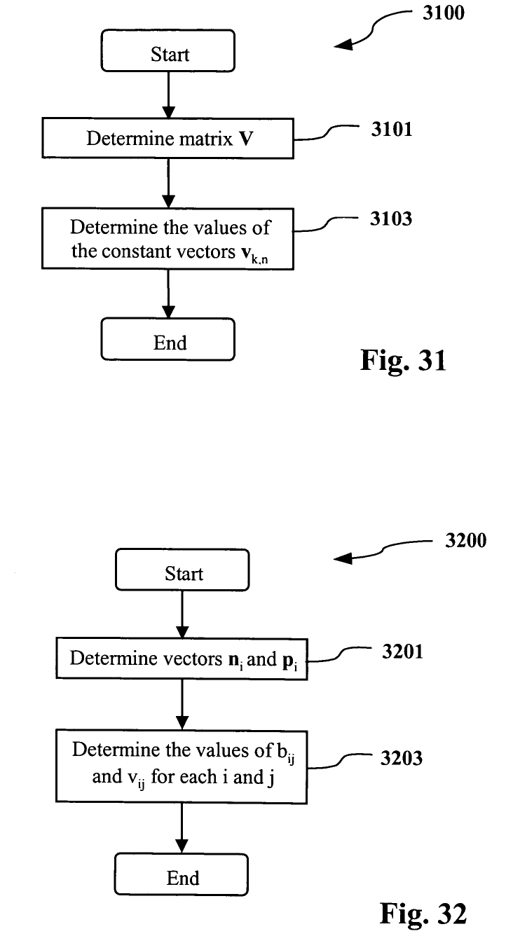

At the next step 2107, the processor 105 determines a sub-pixel accurate estimate of the location (x₂, y₂) of the selected peak. The interpolated correlation image Tₓ may be approximated by a bi-parabolic function, f, in a region close to (x₁, y₁). A bi-parabolic function f has a form in accordance with Formula (34) as follows:
f(x,y)=a₀x²+a₁xy+a₂y²+a₃x+a₄y+a₅ (34)
The coefficients (a₀, a₁, . . . , a₅) that make f(x−x₁, y−y₁) approximately equal to the interpolated image Tₓ(x, y) when x and y are close to x₁ and y₁, respectively, may be determined in order to determine the sub-pixel accurate estimate of the location of the selected peak. Equivalently, the function f(x, y) may be approximated to Tₓ(x+x₁, y+y₁) when x and y are small. The coefficients (a₀, a₁, . . . , a₅) may be determined in accordance with Formula (36) below in order to minimize E in accordance with Formula (35) as follows:

$$\begin{matrix}E = {\int }_{- 0.125}^{0.125} {\int }_{- 0.125}^{0.125} {( f ( x , y ) - {T}_{x} ( {x}_{1} + x , {y}_{1} + y ) )}^{2} ⅆ x ⅆ y & ( 35 ) \\ ( \begin{matrix}{a}_{0} \\ {a}_{1} \\ {a}_{2} \\ {a}_{3} \\ {a}_{4} \\ {a}_{5}\end{matrix} ) = {\sum }_{k = - Z}^{Z} {\sum }_{n = - Z}^{Z} \hat{h} ( k , n ) exp ( j π ( {kx}_{h} + {ny}_{h} ) ) {v}_{k , n} & ( 36 )\end{matrix}$$

where xₕ=x₁−x₀+Z and yₕ=y₁−y₀+Z, and where the v_{k,n} are constant vectors. The constant vectors v_{k,n} may be determined in accordance with a method 3100, which will now be described with reference to FIG. 31.

The method 3100 of determining the constant vectors v_{k,n} as executed at step 2107 may be implemented as software resident in the hard disk drive 110 and being controlled in its execution by the processor 105.

The method 3100 begins at step 3101, where the processor 105 determines the matrix V defined in accordance with Formula (37) as follows:

$$V = {\int }_{- 0.125}^{0.125} {\int }_{- 0.125}^{0.125} ( \begin{matrix}{x}^{2} \\ xy \\ {y}^{2} \\ x \\ y \\ 1\end{matrix} ) ( \begin{matrix}{x}^{2} \\ xy \\ {y}^{2} \\ x \\ y \\ 1\end{matrix} ) ⅆ x ⅆ y \qquad ( 37 )$$

Each element in the matrix V is the integral of a polynomial in x and y, and may be determined analytically. Then at the next step 3103, the processor 105 determines the values of the constant vectors v_{k,n} in accordance with the Formula (38) as follows:

$${v}_{k , n} = \frac{1}{{( 2 Z )}^{2}} {V}^{- 1} {\int }_{- 0.125}^{0.125} {\int }_{- 0.125}^{0.125} {β}_{k} ( x ) {β}_{n} ( y ) ( \begin{matrix}{x}^{2} \\ xy \\ {y}^{2} \\ x \\ y \\ 1\end{matrix} ) ⅆ x ⅆ y \qquad ( 38 )$$

Each element in the constant vectors v_{k,n} is the integral of an exponential in x and y multiplied by a polynomial in x and y, and may be evaluated analytically. The method 3100 concludes after step 3103.

The sub-pixel accurate peak location (x₂, y₂) may be set to the position of the maximum value of the bi-parabolic function f. The sub-pixel accurate peak location (x₂, y₂) may be determined in accordance with Formula (39) as follows:

$$( \begin{matrix}{x}_{2} \\ {y}_{2}\end{matrix} ) = ( \begin{matrix}{x}_{1} \\ {y}_{1}\end{matrix} ) + \frac{1}{{a}_{1}^{2} - 4 {a}_{0} {a}_{2}} ( \begin{matrix}2 {a}_{2} {a}_{3} - {a}_{1} {a}_{4} \\ 2 {a}_{0} {a}_{4} - {a}_{1 {a}_{3}}\end{matrix} ) \qquad ( 39 )$$

The height of the selected peak, H, in the interpolated correlation image Tₓ is also determined at step 2107 in accordance with Formula (40) as follows:
H=f(x₂−x₁, y₂−y₁) (40)

The method 2100 continues at the next step 2108, where the processor 105 determines whether the height of the selected peak, H, at the location (x₂, y₂) determined at step 2107 is the largest peak determined in a current execution of the method 2100. If the height of the selected peak, H, at the location (x₂, y₂) is larger than the current peak height threshold Hₜ then the location (x₂, y₂) represents the location of the highest peak found in the current execution of the method 2100. In this instance, the current peak height threshold Hₜis assigned a new value of the selected peak H, and the sub-pixel accurate coordinates (Δx, Δy) representing the location of the highest peak in the correlation image Tₓ is assigned the value of the location (x₂, y₂) determined at step 2107. Otherwise, if the height of the selected peak H is not larger than the current peak height threshold Hₜ, no highest peak location was found in the current iteration of the loop defined by steps 2103 to 2108.

The method 2100 continues at the next step 2109, where if the processor 105 determines that there are more peaks in the peak list, then the method 2100 returns to step 2103. Otherwise, the method 2100 concludes.

During the execution of the method 2100, no highest peak may be found. For example, if at every execution of step 2108 the height of the selected peak, H, at the location (x₂, y₂) is not larger than the current peak height threshold Hₜthen the sub-pixel accurate coordinates (Δx, Δy) will not be set to any given values. However, if step 2108 did find a highest peak, then the values of the sub-pixel accurate coordinates (Δx, Δy) represent the location of the highest peak.

7.0 Color Models

As described above, at step 506 the processor 105 generates color models that predict how printed colors appear in the scanned barcode image. At step 506 the processor 105 analyses the scanned image of the barcode 200 in order to determine a color model. The color model described here describes how the printed colors appear in the scanned image of the barcode 200.

Barcodes contain cyan, magenta and yellow codels, which are encoded on a page by the presence or absence of cyan, magenta, and yellow inks (or toners) respectively. Since the inks used in printers can differ considerably, the colors in the barcode 200 printed on different printers may also vary. Furthermore, the color of the barcode 200 depends on other factors apart from ink characteristics. For example, the characteristics of the scanner 119, the type of paper, whether the printed barcode 200 was left sitting around in the sun, and other environmental factors, may affect the color of the barcode 200. For these reasons, the color of cyan ink, when represented in an RGB color space in the scanned image of the barcode 200 may vary. Similarly, the color of magenta and yellow inks may also vary for the barcode 200.

There are further complications, arising from the fact that cyan, magenta, and yellow inks are printed on top of each other. The combination of two or more inks results in red, green, blue, or black, depending on the combination of primary colors. For example, a cyan codel which is “on” (i.e., in which ink has been printed) may appear cyan, but the codel may also appear blue, green, or black depending on whether magenta and yellow inks were also present. The appearance of magenta and yellow codels varies similarly.

A color model is described below which allows the data encoded in codels (e.g., the codels 203 of the barcode 200) to be recovered. The color model may be determined by sampling the colors of codels in the alignment pattern and the border 201 of the barcode 200. Since the state of these codels is known in advance, the typical color of the codels may be determined. Thus, the colors of known codels may be used to build a model that allows the state of unknown codels to be determined.

7.1 Color Model Parameters

Three color models may be determined, one for each of the cyan, magenta and yellow inks. Consider the color model for color channel c, where c is one of cyan, magenta or yellow. Codels of color channel c that are “on” are likely to be one of four colors, depending on the presence or absence of the other two color inks. When RGB values of codels where color channel c is “on” are plotted in RGB color space, the RGB values may be modelled by a planar surface. Similarly, the codels where color channel c is “off” are likely to be one of four colors, depending on the presence or absence of the two other color inks. When the RGB values of codels where color channel c is “off” are plotted in RGB color space, the RGB values of the codels also may be modelled by a planar surface.

For each codel (x, y, c), let the vector x(x, y, c)=s(w_{c}(x, y)). The vector x(x, y, c) represents the RGB value of the interpolated scanned image at the location of the codel (x, y, c). The parameters of the color model for color c are as follows:

(i) n₀ and n₁: nᵢ represents the normal vector for the plane that best fits the RGB values of codels where color c is in state i, where i=1 means “on”, and i=0 means “off”;

(ii) bᵢⱼ, for i=0, 1 and j=0, 1: bᵢⱼ represents the mean value of x(x, y, c)·nⱼ over all codels (x, y, c) in color channel c that are in state i; and

(iii) vᵢⱼ, for i=0, 1 and j=0, 1: vᵢⱼ represents the variance of x(x, y, c)·nⱼ over all codels (x, y, c) in color channel c that are in state i.

In the following sections, x·nⱼ denotes the dot product of the vectors x and nⱼ.

7.2 Determining a Color Model

A method 3200 of determining the parameters for the color model for the color channel c, will now be described with reference to FIG. 32. The method 3200 may be implemented as software resident on the hard disk drive 110 and being controlled in its execution by the processor 105.

The method 3200 begins at step 3201, where the processor 105 determines the vectors nᵢ. The vectors nᵢ may be determined by determining the matrix M in accordance with Formula (41) below, where M represents the number of alignment codels and border codels of the color channel c whose state is i.

$$\begin{matrix}M = {\sum }_{( x , y , c )} x ( x , y , c ) x {( x , y , c )}^{T} - \\ \frac{1}{ M} ( {\sum }_{( x , y , c )} x ( x , y , c ) ) {( {\sum }_{( x , y , c )} x ( x , y , c ) )}^{T}\end{matrix} \qquad ( 41 )$$

The sums of Formula (41) range over all codels (x, y, c) in color channel c that is in state i. The matrix M is positive definite, so all eigenvalues of the matrix M are positive and real. The vector nᵢ may be set to the eigenvector of M that has the smallest eigenvalue. At the next step 3203, the values of bᵢⱼ and vᵢⱼ are determined for each i and j. The values of bᵢⱼ and vᵢⱼ may be determined by determining the values of x(x, y, c)·nⱼ for all codels (x, y, c) in color channel c that are in state i, given i and j, and then determining the mean and variance of the determined values of x(x, y, c)·nⱼ for all codels (x, y, c).
7.3 Using the Color Model

Once the color model for a color channel c has been determined in accordance with the method 3200, the color model may be used to determine whether a codel of color channel c is “on” or “off”, based on the RGB pixel value of the scanned image at the codel location. A likelihood ratio λ for the codel may also be determined. The likelihood ratio λ for the codel represents the probability that the codel is “on” divided by the probability that the codel is “off”. The likelihood ratio λ the codel (x, y, c) may be determined in accordance with Formula (42) as follows:

$$λ = \frac{g ( \frac{x ( x , y , c ) \cdot {n}_{1} - {b}_{11}}{\sqrt{{v}_{11}}} ) g ( \frac{x ( x , y , c ) \cdot {n}_{0} - {b}_{10}}{\sqrt{{v}_{10}}} )}{g ( \frac{x ( x , y , c ) \cdot {n}_{1} - {b}_{01}}{\sqrt{{v}_{01}}} ) g ( \frac{x ( x , y , c ) \cdot {n}_{0} - {b}_{00}}{\sqrt{{v}_{00}}} )} \qquad ( 42 )$$

where g(t)=exp(−t²/2).
7.4 Incorporating Deconvolution into the Color Model

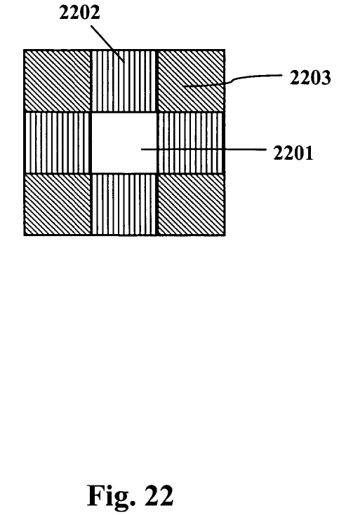

An alternative color model will now be described. The alternative color model may be determined by incorporating a deconvolution into the likelihood ratio λ. Deconvolution may reduce the effects of blurring in the scanned image of the barcode 200. As described above, blurring may be introduced in either the printing or scanning of the barcode 200. When using deconvolution, the likelihood ratio λ for a codel (x, y, c) depends not only on the RGB pixel value x(x, y, c)=s(w_{c}(x, y)) of the scanned image at the codel location, but also on the RGB pixel values of the scanned image at adjacent codels. For example, FIG. 22 shows a codel 2201 and adjacent (i.e., neighbouring) codels (e.g., codels 2202 and 2203). A six-element vector y(x, y, c) may be defined as follows for the codel 2201. The first three elements of the vector y(x, y, c) represent the sum of the RGB pixel values of the four neighbouring codels (e.g., codel 2202) of the codel 2201. The codel 2202 is one of four neighbouring codels of the codel 2201. The first three elements of the vector y(x, y, c) are as follows:
s(w_{c}(x−1, y))+s(w_{c}(x+1, y))+s(w_{c}(x, y−1))+s(w_{c}(x, y−1)) (43)
The last three elements of the vector y(x, y, c) are the sum of the RGB pixel values of the four diagonally neighbouring codels. The codel 2203 is one of the four diagonally neighbouring codels. The last three elements of the vector y(x, y, c) may be determined as follows:
s(w_{c}(x−1, y−1)+s(w_{c}(x+1, y−1))+s(w_{c}(x−1, y+1))+s(w_{c}(x+1, y+1)) (44)
In the alternative color model, the likelihood ratio λ for the codel at coordinates (x, y, c) depends on the vector x(x, y, c) and the vector y(x, y, c).

The parameters of the alternative color model are as follows:

(i) p₀ and p₁: pᵢ represents a vector of deconvolution weights for codels of color c in state i, where i=1 means “on”, and i=0 means “off”;

(ii) n₀ and n₁: nᵢ represents the normal vector for the plane that best fits the RGB values of codels where color c is in state i, where i=1 means “on”, and i=0 means “off”;

(iii) bᵢⱼ, for i=0, 1 and j=0, 1: bᵢⱼ represents the mean value of x(x, y, c)·nⱼ+y(x, y, c)·pⱼ over all codels (x, y, c) in color channel c that are in state i; and

(iv) vᵢⱼ, for i=0, 1 and j=0, 1: vᵢⱼ is the variance of x(x, y, c)·nⱼ+y(x, y, c)·pⱼ over all codels (x, y, c) in color channel c that are in state i.

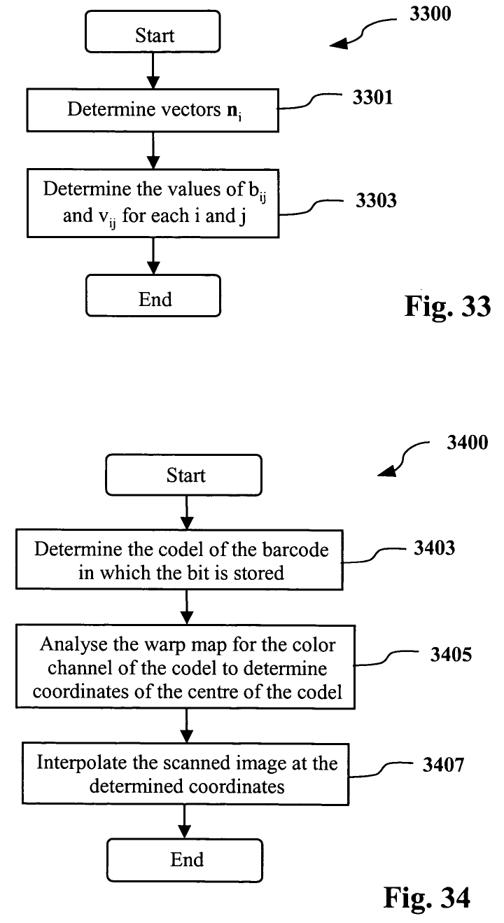

A method 3300 of determining the parameters for the alternative color model for the color channel c, will now be described with reference to FIG. 33. The method 3300 may be implemented as software resident in the hard disk drive 110 and being controlled in its execution by the processor 105.

The method 3300 begins at step 3301, where the processor 105 determines the vectors nᵢ. The parameters (i) to (iv) directly above may be determined by determining the matrices M, B, C, D and E, in accordance with Formulae (45), (46), (47), (48) and (49), below, where M represents the number of alignment codels and border codels of the color channel c whose state is i for the scanned image of the barcode 200.

$$\begin{matrix}\begin{matrix}M = {\sum }_{( x , y , c )} x ( x , y , c ) x {( x , y , c )}^{T} - \\ \frac{1}{ M} ( {\sum }_{( x , y , c )} x ( x , y , c ) ) {( {\sum }_{( x , y , c )} x ( x , y , c ) )}^{T}\end{matrix} & ( 45 ) \\ \begin{matrix}B = {\sum }_{( x , y , c )} y ( x , y , c ) x {( x , y , c )}^{T} - \\ \frac{1}{ M} ( {\sum }_{( x , y , c )} y ( x , y , c ) ) {( {\sum }_{( x , y , c )} x ( x , y , c ) )}^{T}\end{matrix} & ( 46 ) \\ \begin{matrix}C = {\sum }_{( x , y , c )} y ( x , y , c ) y {( x , y , c )}^{T} - \\ \frac{1}{ M} ( {\sum }_{( x , y , c )} y ( x , y , c ) ) {( {\sum }_{( x , y , c )} y ( x , y , c ) )}^{T}\end{matrix} & ( 47 )\end{matrix}$$

D=C⁻¹B (48)
E=M−B^{T}D (49)
where the sums range over all codels (x, y, c) of color channel c that are in state i for the scanned image of the barcode 200. The matrix E is positive definite, so all the eigenvalues of the matrix E are positive and real. The vector nᵢ may be set to the eigenvectors of E that has a smallest eigenvalue. The vector pᵢ may be set to the value of the matrix D multiplied by the vector nᵢ.

At the next step 3303, the values of bᵢⱼ and vᵢⱼ are determined for each i and j. The values of bᵢⱼ and vᵢⱼ may be determined by determining the values of x(x, y, c)·nⱼ for all codels (x, y, c) in color channel c that are in state i, given i and j, and then determining the mean and variance of the determined values of x(x, y, c)·nⱼ+y(x, y, c)·pⱼ for all codels (x, y, c).

In the alternative color model, the likelihood ratio λ of the codel (x, y, c) may be determined in accordance with Formula (50) as follows:

$$λ = \frac{\begin{matrix}g ( \frac{x ( x , y , c ) \cdot {n}_{1} + y ( x , y , c ) \cdot {p}_{1} - {b}_{11}}{\sqrt{{v}_{11}}} ) \\ g ( \frac{x ( x , y , c ) \cdot {n}_{0} + y ( x , y , c ) \cdot {p}_{0} - {b}_{10}}{\sqrt{{v}_{10}}} )\end{matrix}}{\begin{matrix}g ( \frac{x ( x , y , c ) \cdot {n}_{1} + y ( x , y , c ) \cdot {p}_{1} - {b}_{01}}{\sqrt{{v}_{01}}} ) \\ g ( \frac{x ( x , y , c ) \cdot {n}_{0} + y ( x , y , c ) \cdot {p}_{0} - {b}_{00}}{\sqrt{{v}_{00}}} )\end{matrix}} \qquad ( 50 )$$

where g(t)=exp(−t²/2).
8.0 Data Encoding and Decoding

As described above, at step 405 of the method 400, the processor 105 accesses data, encodes the data, and arranges the data in the barcode 200. As also described above, the processor 105 uses the fine alignment warp maps and the color models to extract data from the barcode 200 and decode the extracted data.

The data is binary data to be stored in the barcode 200. The data may be pre-processed to ensure that the data has a random appearance before the data is stored in the barcode 200. The pre-processed data may be obtained by compressing the data. Any suitable compression algorithm may be used to compress the data. For example, the Lempel-Ziv compression method or bzip2 compression method may be used to compress the data. The data may be compressed before storing the compressed data in the barcode 200, and decompressed after extraction from the barcode 200.

Alternatively, the pre-processed data may be obtained by XORing the data with a pseudo-random sequence of binary data. In this instance, when the data is extracted from the barcode 200, the data is again XORed with the pseudo-random sequence of binary data resulting in the original data.

Further, the data may be encrypted. For example, either symmetric key methods (e.g., the Data Encryption Standard (DES), or blowfish), or public key methods (e.g., RSA encryption) may be used to encrypt the data.

Error-correction coding may be applied to the pre-processed data so that imperfections in the printing and scanning of the barcode 200 do not result in corruption of the data stored in the barcode 200. In this instance, low density parity check (LDPC) coding may be used to apply error-correction coding to the pre-processed data. The publication “Low-density parity-check codes”, IRE Transactions on Information Theory, Vol. 8, January 1962, describes one error-correction coding method which may be applied to the pre-processed data. Alternatively, other error-correction coding methods may also be applied to the pre-processed data. For example, Reed-Solomon (RS) coding or Turbo codes may be applied to the pre-processed data.

Low density parity check (LDPC) coding is a block coding scheme, in which the pre-processed data is first divided into blocks of length K bits, and each block is encoded to produce encoded blocks of length N bits, where N and K are parameters of the particular LDPC code in use. If the length of the pre-processed data is not a multiple of K bits, the pre-processed data may be padded with arbitrary data to make the length a multiple of K bits.

Given the dimensions of the barcode 200, the number of encoded blocks that can be stored in the barcode 200 may be determined. The number of encoded blocks may be determined in accordance with Formula (51) as follows:

$$⌊ \frac{9 ( W - 2 B ) ( H - 2 B )}{4 N} ⌋ \qquad ( 51 )$$

Formula (51) represents the barcode width W less twice the border width, multiplied by the barcode height less twice the border width, multiplied by nine (9), divided by the product of four (4) and the encoded block length N, rounded down to the nearest integer.

The dimensions of the barcode 200 in which the data is to be stored are selected such that the number of blocks that can be stored is greater than the number of error-corrected blocks. If the length of the pre-processed data is such that the number of error-corrected corrected blocks is less than the number of blocks that can be stored, the pre-processed data may be padded with arbitrary data until the number of error-corrected blocks is equal to the number of blocks that can be stored. As such, given the dimensions of the barcode 200, the number of blocks that have been stored may be determined when reading the barcode 200. The barcode dimensions are determined as described above with reference to step 502.

8.1 Embedding Data in a Barcode

The method 2300 of encoding data and arranging the encoded data in the barcode 200, as executed at step 405 of the method 400, will now be described with reference to FIG. 4. The method 2300 may be implemented as software resident in the hard disk drive 110 and being controlled in its execution by the processor 105.

The method 2300 accesses the data to be stored in the barcode 200, and encodes codels into the barcode 200. The data may be accessed from memory 105, for example. The method 2300 begins at step 2302, where the processor 105 iterates through blocks of the data. On the first execution of step 2302, a first K bits of the data are selected for processing. On subsequent executions of step 2302, the following K bits of the data are selected.

At the next step 2303, the processor 105 performs error correction encoding of the K bits of data selected in step 2302. Step 2303 produces N bits of encoded data. Then at the next step 2304, the processor 105 stores the N bits of encoded data in the codels (e.g., 203) of the barcode 200. Each bit in the encoded data is stored in one data codel in the barcode 200. At step 2304, the N bits of encoded data are mapped to data codels in the barcode 200.

A mapping ψ may be defined to map encoded data bits to data codels, based on an ordering idea. An ordering of the encoded data bits may be referred to as a “bit-wise order”. In bit-wise ordering, all of the first bits of all blocks come before all the second bits of all blocks, which come before all the third bits of all blocks, and so on. Within all of the encoded data bits in the same position in their blocks, the bits from the first block come before the bits from the second block, which come before the bits from the third block, and so on. This defines an order in which to consider the encoded data bits.

An ordering of the data codels of the barcode 200 may be referred to as “scanline order”. In scanline ordering, the data codels in the cyan color plane come before the data codels in the magenta color plane, which come before the data codels in the yellow color plane. Within each color plane, the codels in the top row come before the codels in the second row, which come before the codels in the third row, and so on. Within each row, the data codels are ordered from left to right. This defines an order in which to consider the data codels.

In the mapping ψ between encoded data bits and data codels, the first data bit (i.e., using the bit-wise ordering) is mapped to the first data codel (i.e., using the scanline ordering). The second data bit is mapped to the second data codel and so on. The value of each encoded bit may be stored in the codel that the encoded bit maps to under ψ.

Once the encoded data for each bit in the current block of N encoded data bits has been stored in the data codels of the barcode 200, at the next step 2305, if the processor 105 determines that there are more blocks of data to be processed, the method 2300 returns to step 2302. Otherwise, the method 2300 concludes.

Some data codels (e.g., 206) may not have been mapped to by an encoded data bit. These data codels will not have been assigned a value. Values may be assigned at random to these data codels that were not mapped to in order to ensure that all data codels in the barcode 200 have been assigned a value. For example, values from the random array α₀ may be assigned to the data codels that were not mapped to.

8.2 Extracting Data from a Barcode

The method 2400 of extracting data from the barcode 200 and decoding the extracted data as executed at step 507, will now be described with reference to FIG. 24. The method 2400 may be implemented as software resident in the hard disk drive 110 and being controlled in its execution by the processor 105. The method 2400 extracts the data from the data codels (e.g., 203) of the barcode 200.

The method 2400 begins at step 2402, where the processor 105 iterates through blocks of the encoded data. On a first execution of step 2402, the first block of data is selected for processing. On subsequent executions of step 2402, the following blocks are selected. The number of blocks that are iterated through is equal to a maximum number of blocks that may be stored in the barcode 200 in accordance with the dimensions determined for the barcode 200, as described above. At the next step 2403, for each bit of encoded data for a current block, the processor 105 determines pixel values from the scanned image of the barcode 200 at the centres of the codels in which data for the current block is stored. A method 3400 of determining pixel values from the scanned image of the barcode, as executed at step 2403, will be described in detail below with reference to FIG. 34.

The method 3400 may be implemented as software resident in the hard disk drive 110 and being controlled in its execution by the processor 105. The method 3400 begins at step 3403, where the processor 105 uses the mapping ψ to determine the codel of the barcode 200 in which the bit is stored. The codel coordinates may be represented as (x, y, c).

The method 3400 continues at the next step 3405, where the processor 105 analyses the warp map for the color channel of the codel determined at step 3403, to determine the coordinates w_{c}(x, y) of the centre of that codel in the scanned image of the barcode 200. Then at the next step 3407, the processor 105 interpolates the scanned image at the coordinates w_{c}(x, y), to determine an RGB pixel value s(w_{c}(x, y)) for the current data bit. If the color model being used in the method 3400 includes deconvolution, the pixel values from the scanned image at the centres of the neighbouring codels to the codel determined at step 3403 are also determined.

The method 2400 continues at the next step 2404, where the processor 105 uses the pixel value(s) determined at step 2403, and the color model generated in step 506 of the method 500, to determine likelihood values λ for the N bits in the encoded block, in accordance with Formula (43) or Formula (51) above. Then at the next step 2405, the processor 105 performs error-correction decoding, using the N likelihood values λ determined at step 2404 to determine K corrected bits. The method 2400 continues at the next step 2406, where the processor 105 stores the corrected K bits in memory 106. At the next step 2407, if the processor 105 determines that there are more blocks of data to be processed, then the method 2400 returns to step 2402. Otherwise, the method 2400 concludes.

As described above the codels (e.g., 203) of the barcode 200 are printed in cyan, magenta, and yellow colored inks. However, any suitable colored ink may be used to print the codels of the barcode 200. Further, a different number of different colored inks may be used to print the codels of the barcode 200. Monochrome barcodes may also be generated by using only codels printed with black ink.

As described above, the codels (e.g., 203, 207) are square regions, arranged in a rectangular array. Non-square codels may also be generated. For example, the codels of the barcode 200 may be rectangular in shape.

The interpolation of the scanned image using bi-cubic interpolation at steps 1203, 1302, 1402, and 2403 may be alternatively performed using any suitable interpolation. For example, bi-linear interpolation may be used at steps 1203, 1302, 1402, and 2403.

The interpolation of the mapping in accordance with the method 2000 using bi-cubic interpolation may alternatively be executed using any suitable interpolation method. For example, bi-linear interpolation may be used to interpolate the mapping in the method 2000.

As described above, the color conversion from RGB to cyan, magenta and yellow in steps 1302 and 1402 is performed using Formulae (15), (21), and (22). However, any suitable color conversion method may be used in the described methods. For example, different linear conversions may be performed by modifying the constants in Formulae (15), (21), and (22).

In the method 1300, the warp maps for the three color channels are determined by first producing a coarsely-aligned image using an approximation to an actual warp map, and then tiled correlations are performed to produce a more accurate warp map. In the cyan channel, the coarsely-aligned image may be generated using the coarse-alignment affine transform. In the magenta and yellow channels, the coarsely-aligned image may be generated using the cyan warp map. However, other arrangements are possible. For example, the coarse-alignment affine transform may be used to generate the coarsely-aligned images for the magenta and yellow channels. In another example, the cyan warp map may be determined using two stages of tiled correlations, where the warp map resulting from the first tiled correlations may be used to generate the coarsely-aligned image that is used for the second tiled correlations. Determining the cyan warp map using two stages of tiled correlations may generate a more accurate warp map for the cyan channel. Additional stages of tiled correlations may be more accurate still. Additional stages of tiled correlations may also be used for the magenta and yellow color channels.

Further, the peak detection step 1705 uses Fourier interpolation and a bi-parabolic fit to estimate the location of a peak to sub-pixel accuracy. However, any suitable peak finding method may be used in the described methods. For example, a chirp-z transform may be used to interpolate the correlation image at a large number of points, and the point with the largest value may be taken as the peak location.

9.0 Elements Making Up a Protected Document

A document to be protected, as described below, may be stored in an electronic file of a file-system configured within the memory 106 or hard disk drive 110 of the computer module 101, for example. Similarly, the data read from a protected document may also be stored in the hard disk drive 110 or memory 106 upon the protected document being read. Alternatively, the document to be protected may be generated on-the-fly by a software application program resident on the hard disk drive 110 and being controlled in its execution by the processor 105. The data read from a protected document may also be processed by such an application program.

The term ‘document’ as referred to below refers to a bi-level image. Text documents and the like may be converted into bi-level images before being tamper-protected in accordance with the methods described below. The term ‘protected document’ refers to a document (i.e., a bi-level image) with additional features appended to the document that allow for automatic per-pixel tamper detection and correction of the document.

When a protected document is printed, pixels of the protected document are represented as squares of ink on paper, for example. Each pixel, or square of ink, represents one bit of information. The presence or absence of ink at the position of a particular square on the paper indicates whether the bit represented by the particular square is “on” or “off” respectively. Ink of one color may be used in the printing of protected documents. This color may be black.

The dimensions of a protected document may be specified by the width (Wₚ) and height (Hₚ) in pixels of an interior region of the protected document, as will be described in detail below. The physical size of a printed protected document may be determined by the size of each pixel in the printed protected document on a page. The physical size of the printed protected document is determined by the resolution of printing. For example, the protected document may be printed at a resolution of 150 dots-per-inch. This means that each pixel is a square with side-length of one 150th of an inch. However, a person skilled in the relevant art would appreciate that any suitable printing resolution may be used to generate the protected documents described here.

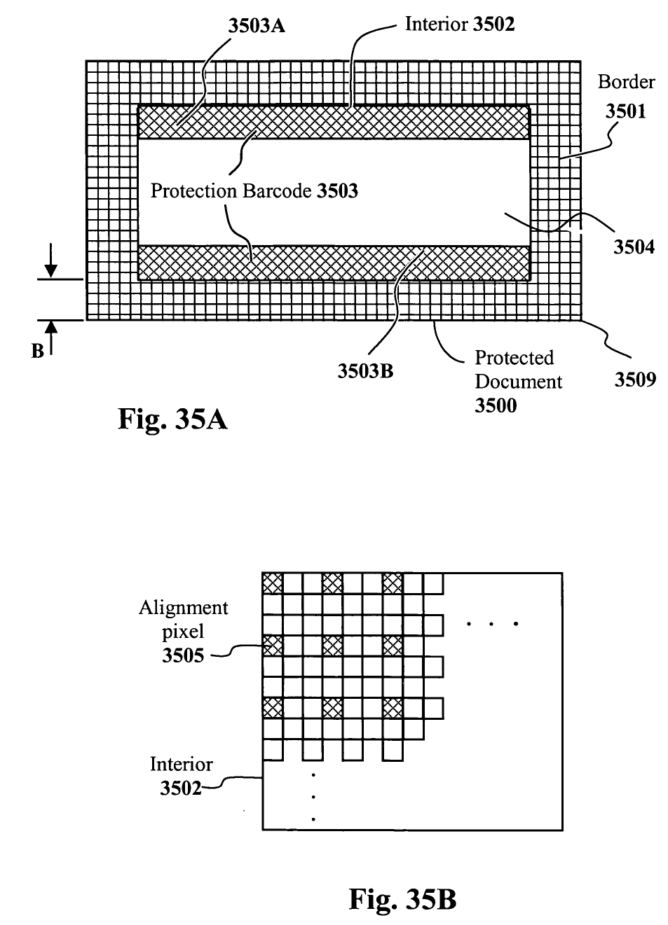

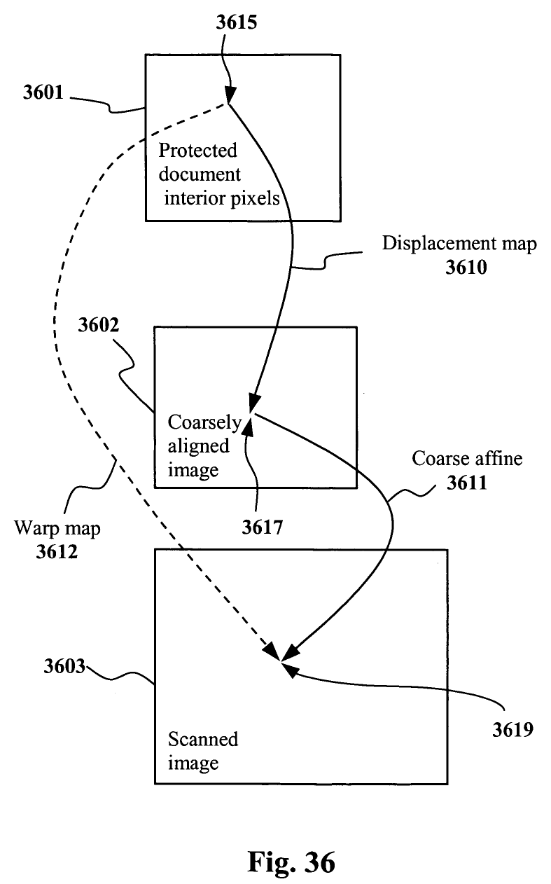

FIG. 35 shows a protected document 3500. The protected document 3500 will be used below as an example protected document to describe the methods of FIGS. 36 to 58. The protected document 3500 comprises a coarse alignment border 3501 and an interior 3502. The border 3501 of the protected document 3500 comprises pixels. The border 3501 has a width, which may be denoted as ‘B’. For example, B may be equal to thirty-two (32) meaning that the protected document 3500 has a border 3501 thirty two (32) pixels on all four sides of the protected document 3500. The pixels that lie in the border 3501 may be referred to as “border pixels”. The interior 3502 of the protected document 3500 comprises all pixels of the protected document 3500 that are not in the border 3501. In the interior 3502, some of the pixels may be referred to as “alignment pixels” 3505, as seen in FIG. 35B. Alignment pixels 3501 and border pixels 3503 may be used to perform fine alignment on the protected document 3500, which will be described in detail below.

The alignment pixels 3505 are pixels whose row and column coordinates are divisible by three (3). However, the alignment pixels 3505 may be arranged in any other suitable arrangement. For example, one eighth of the pixels in the interior 3502 of the protected document 3500 may be selected pseudo-randomly to be alignment pixels.

The remaining pixels in the interior 3502 may be divided into a protection barcode 3503 and a document 3504. The document 3504 is a bi-level image as described above. For example, the document 3504 may be a bi-level image of a text document. The protection barcode 3503 comprises error-correction code parity bits that protect the document 3504 from alterations. The protection barcode 3503 may be appended to the top and bottom of the document 3504. The width of the protection barcode 3503 is the same on both sides of the protection barcode 3503. The protection barcode 3503 of FIG. 35A comprises two distinct regions 3503A and 3503B. However, the protection barcode 3503 of FIG. 35A is processed as a single contiguous barcode 3503, which may be read from top to bottom. The protection barcode 3503 may also be arranged in many other shapes, such as a four-sided border, for example.

The protection barcode 3503 and the document 3504 contain alignment pixels (e.g., 3505), as both the protection barcode 3503 and the document 3504 may be fine aligned.

As described above, the dimensions of the protected document 3500 may be specified by the width (Wₚ) and height (Hₚ) in pixels of the interior region 3502 of the protected document 3500. In order to make it easier to determine the dimensions of the protected document 3500 from a scanned image of the protected document 3500, the possible values of height (Hₚ) and width (Wₚ) for the protected document 3500 may be limited.

In one example, Hₚ and Wₚ may be limited to multiples of the width B of the border 3501. If the interior 3502 is not a multiple of the border width B, the dimensions of the interior 3502 may be rounded up to a nearest multiple of B, as will be described in detail below.

For ease of explanation and in order to allow specific pixels in the interior 3502 of the protected document 3500 to be identified, a pixel coordinate system will be described. In this pixel coordinate system, each pixel in the interior 3502 may be uniquely specified by a 2-tuple of coordinates (x, y). In this 2-tuple of coordinates (x, y), x specifies a column for the pixel, where column numbers range from 0 to W-1; y specifies a row for the pixel, where row numbers range from 0 to H-1. The state of the pixel with coordinates (x, y) may be denoted by α(x, y). If α(x, y)=0, the pixel at (x, y) is in the “off” state. If α(x, y)=1, the pixel at (x, y) is in the “on” state.

10.0 Two-Stage Alignment

Determining the location of pixels in a scanned image of the protected document 3500, produced using the scanner 119 when reading the protected document 3500, can be problematic. A major problem with conventional methods of determining the location of pixels in a scanned image is their inability to accurately determine the location of pixels at anything except trivially low resolutions. This problem prevents conventional methods from automatically verifying documents at a per-pixel level. However, using the methods described herein, pixel locations in a scanned image of the protected document 3500 generated using the scanner 119 (e.g., a standard commercial scanner) and printer 115 may be accurately determined at resolutions up to 200 dpi. This upper resolution is due to the quality of the printing and scanning process, and is not an intrinsic limitation of the methods described herein. As printers and scanners improve in quality, higher resolutions will be possible using the described methods without modification.

Determination of the location of pixels in a scanned image of the protected document 3500 can be problematic since the protected document 3500 may be printed at one resolution (e.g., 150 pixels-per-inch) and scanned at a higher resolution (e.g., 600 dpi). This means that a pixel in the scanned image is 4-by-4 scanned pixels in size. The location of the centre of the pixel in the scanned image is required to be determined accurately. However, due to distortions and warping, the locations of pixels in the scanned image of the protected document may deviate from their expected locations.

The location of pixels in the scanned image of the protected document 3500 may be determined using “coarse alignment” and “fine alignment”. Coarse alignment represents an approximate mapping between pixels and the coordinates of their centres in the scanned image of the protected document 3500. Coarse alignment may use an affine transformation. Since the mapping between pixels and their location in the scanned image is usually more complicated than an affine transform, coarse alignment may not accurately represent the pixel locations. Once the coarse alignment affine transform has been found, the scanned image may be transformed, undoing the effects of the affine transform, and thus producing an image that is approximately the same as the original printed protected document 3500. This image that is approximately the same as the original protected document 3500 may be referred to as the coarsely-aligned image.

FIG. 36 shows a coarsely-aligned image 3602 and a scanned image 3603. Each of the images 3602 and 3603 represent the protected document 3500, which includes the protection barcode 3503 and the document 3504 (i.e., the bi-level image of a document to be protected). A representation of a coarse alignment affine transform 3611 is also shown. The coarse alignment affine transform 3611 takes coordinates in the coarsely-aligned image and maps the coordinates in the coarsely-aligned image to coordinates in the scanned image.

Fine alignment may be used to determine the mapping between interior pixels 3601 (i.e., the pixels in the protection barcode 3503 and the document 3504 of the interior 3502 of the protected document 3500), as shown in FIG. 36, and the coarsely-aligned image 3602, using a displacement map 3610.

The displacement map 3610 and the coarse alignment affine transform 3611 together provide a mapping from the interior pixels 3601 to coordinates in the scanned image 3603 of the protected document 3500. Given the coordinates of a pixel 3615 in the interior pixels 3601, the displacement map 3610 may be used to find the coordinates of the centre of that pixel 3617 in the coarsely-aligned image 3602 of the protected document 3500. Those coordinates may then be transformed by the coarse alignment affine transform 3611, resulting in the coordinates of the centre of the pixel 3619 in the scanned image 3603 of the protected document 3500. Thus the composition of the displacement map 3610 and the affine transform 3611 results in a mapping from the pixel coordinates (e.g., the coordinates at point 3615) to the scanned image coordinates (e.g., the coordinates of the point 3619). The composed mapping is called a warp map. A representation of a warp map 3612 is also shown in FIG. 36.

11.0 Generating and Reading Protected Documents

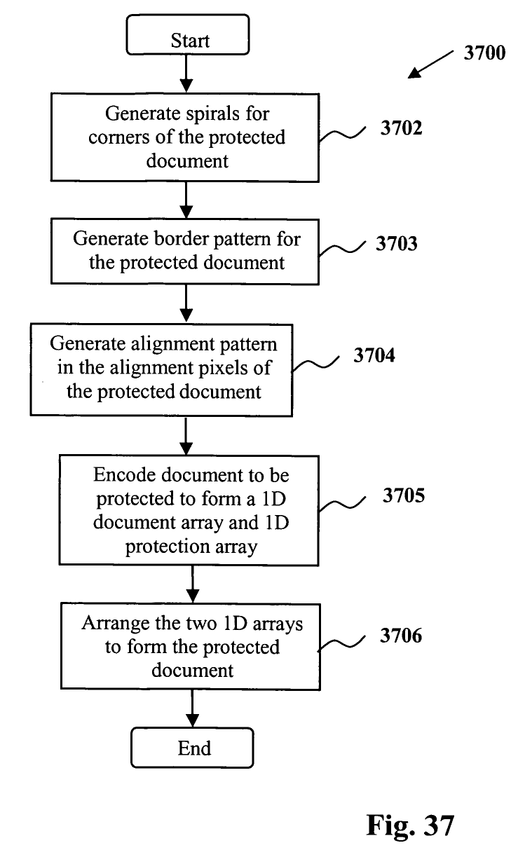

FIG. 37 is a flow diagram showing a method 3700 of generating a protected document, such as the protected document 3500, for example. The method 3700 may be implemented as software resident on the hard disk drive 110 and be controlled in its execution by the processor 105.

The method 3700 accesses data in the form of a bi-level image representing a document to be protected, and produces a 2D bi-level image representing the protected document 3500. The 2D bi-level image represents the protection barcode 3503, the document 3504 and the border 3501. This 2D bi-level image forming the protected document 3500 may then be printed using the printer 115.

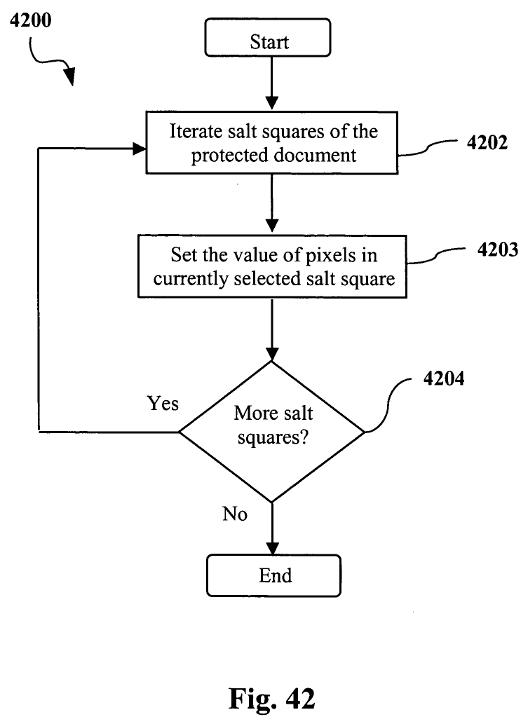

The method 3700 begins at the first step 3702, where the processor 105 generates spirals for corners (e.g., 3509) of the protected document 3700. The processor 105 encodes (or embeds) the spirals into border pixels of the protected document 3500. At the next step 3703, the processor 105 generates a border pattern for the border 3501 of the protected document 3500, storing data in the border pixels of the protected document 3500. The processor 105 fills any of the border pixels that do not contain spirals with a small amount of data as will be described in detail below. The processor 105 may also store random data (i.e., noise) into pixels of the barcode border 3501 where spirals have been embedded. A method 4200 of storing data in border pixels of the protected document 3500, as executed at step 3703, will be described below with reference to FIG. 42.

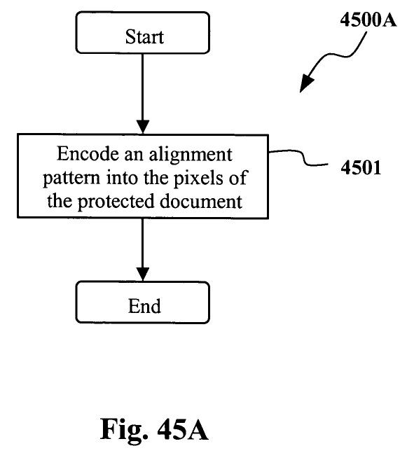

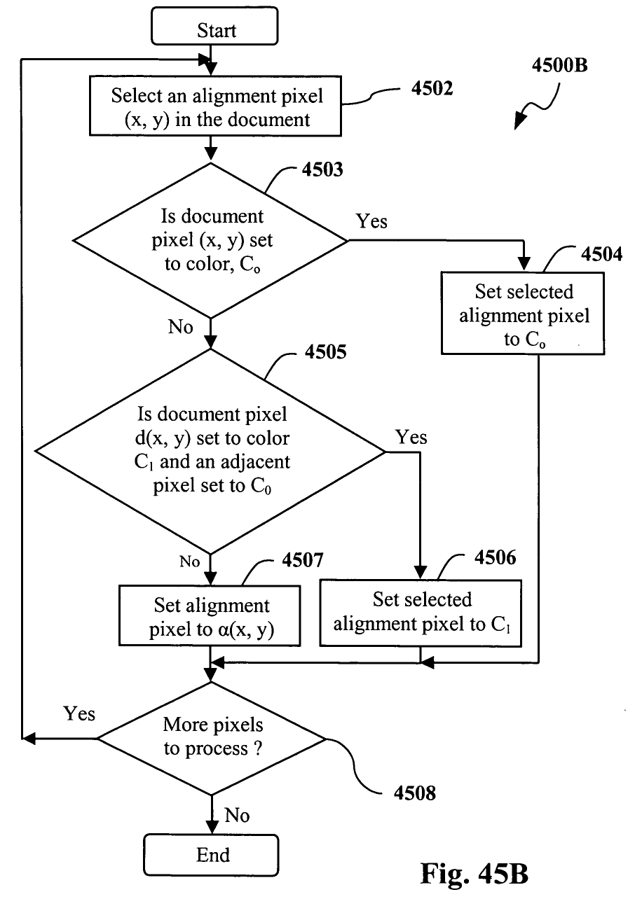

The method 3700 continues at the next step 3704, where the processor 105 generates an alignment pattern in the alignment pixels (e.g., 3505) of the protected document 3500, in order to allow fine alignment to be performed when reading the protected document 3500. Step 3704 may degrade the visual quality of the document 3504 by corrupting every ninth pixel. Therefore, during generation of the protected document 3500 two methods of generating an alignment pattern in the alignment pixels (e.g., 3505) of the protected document 3500 will be described below. Firstly, a method 4500A of generating an alignment pattern in the alignment pixels (e.g., 3505) of the protected document 3500 will be described in more detail below with reference to FIG. 45A, for execution at step 3704. The method 4500A may be used for documents that do not have a dominant amount of one color (e.g., a monochrome image). For documents that do have a dominant amount of one color (e.g., text documents with a white background), a different method 4500B of generating an alignment pattern in the alignment pixels (e.g., 3505) of the protected document 3500 may be executed at step 3704. The method 4500B will be described in detail below with reference to FIG. 45B.

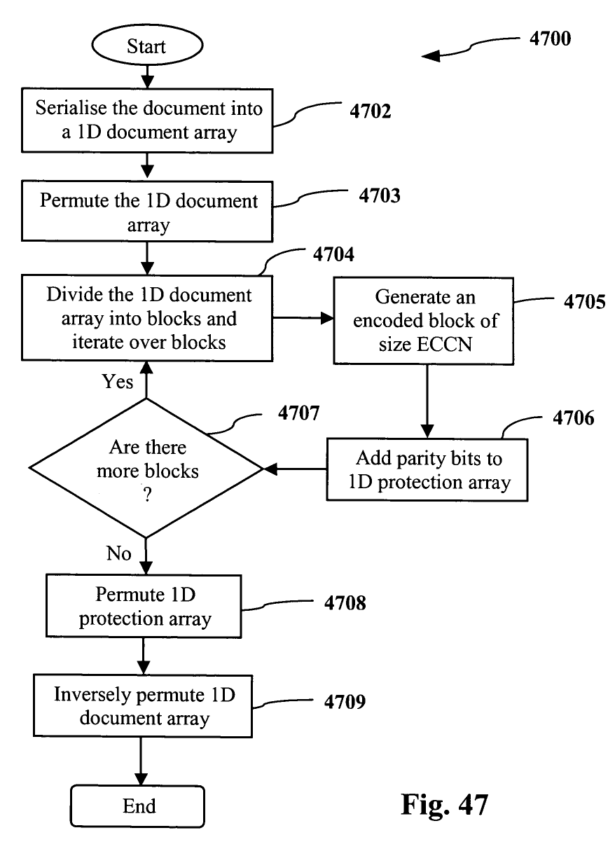

The method 3700 continues at the next step 3705, where the processor 105 accesses data in the form of a bi-level image representing the document 3504 to be protected and encodes the data to form a one dimensional (1D) document array and a 1D protection array. The bi-level image representing the document 3504 (e.g., a text document) to be protected may be accessed from memory 106, for example. A method 4700 of encoding a document 3504 to be protected into a 1D document array and a 1D protection array, as executed at step 3705, will be described in detail below with reference to FIG. 47. As will be described in detail below, the 1D document array stores a serialised version of the document 3504 to be protected. The 1D protection array comprises protection or parity bits.

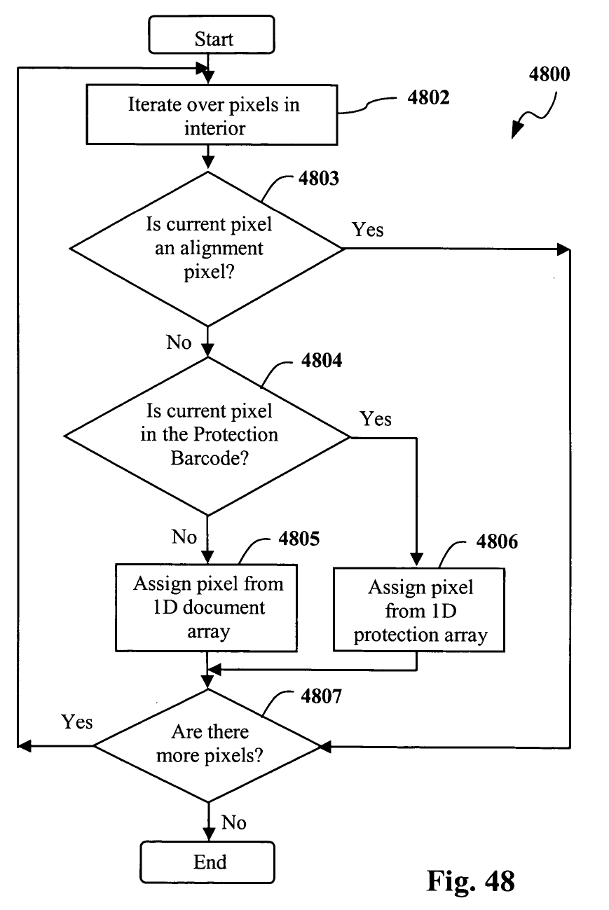

The method 3700 concludes at the next step 3706, where the processor 105 arranges the 1D document array and the 1D protection array as the document 3504 and the protection barcode 3503, respectively, to form the protected document 3500. A method 4800 of arranging the two 1D arrays to form the protected document 3500, as executed at step 3706, will be described below with reference to FIG. 48.

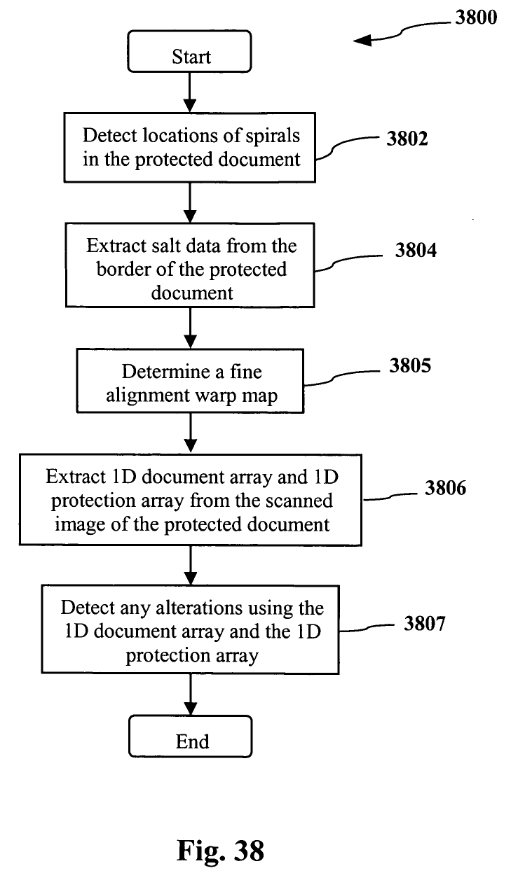

FIG. 38 is a flow diagram showing a method 3800 of reading a protected document, such as the protected document 3500, for example. The method 3800 may be implemented as software resident in the hard disk drive 110 and being controlled in its execution by the processor 105.

The method 3800 accesses an image generated by scanning a printed version of the protected document 3500. This image may be referred to as the ‘scanned image’ of the protected document 3500. The scanned image may be accessed from memory 106, for example. The method 3800 then produces data encoded in the printed version of the protected document 3500.

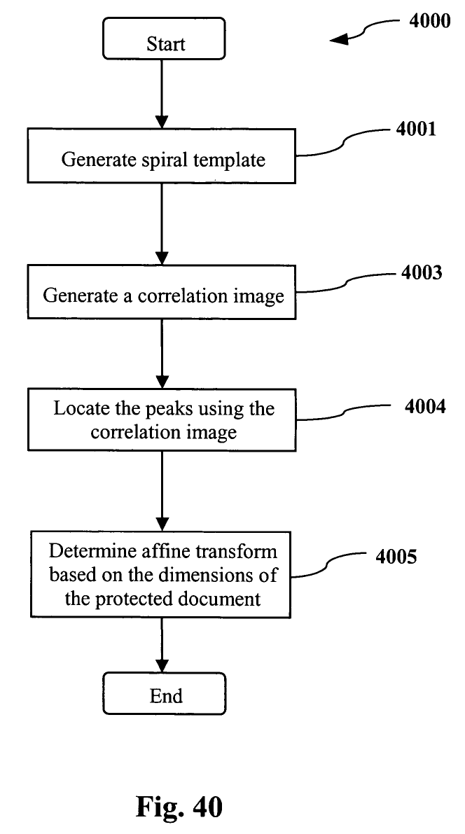

The method 3800 begins at step 3802, where the processor 105 determines a coarse alignment affine transform based on the dimensions (i.e., width Wₚ and height Hₚ) of the protected document 3500. At step 3802, the processor 105 determines the locations of spirals in the scanned image of the protected document 3500 and uses the detected spirals to locate the protected document 3500 on a page. The processor 105 then determines the dimensions of the protected document 3500, the resolution of the pixels of the protected document 3500 and the coarse alignment affine transform based on the determined dimensions. A method 4000 of determining a coarse alignment affine transform, using the locations of the spirals, as executed at step 3802, will be described below with reference to FIG. 40.

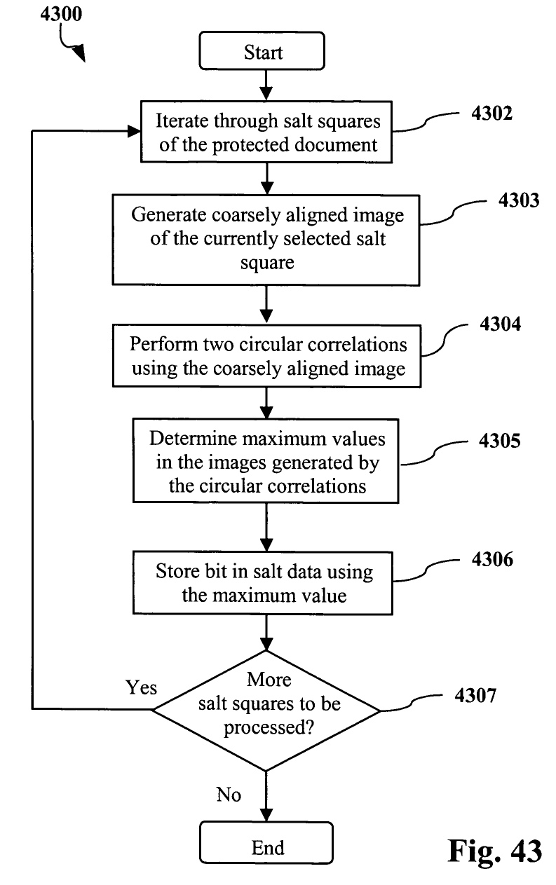

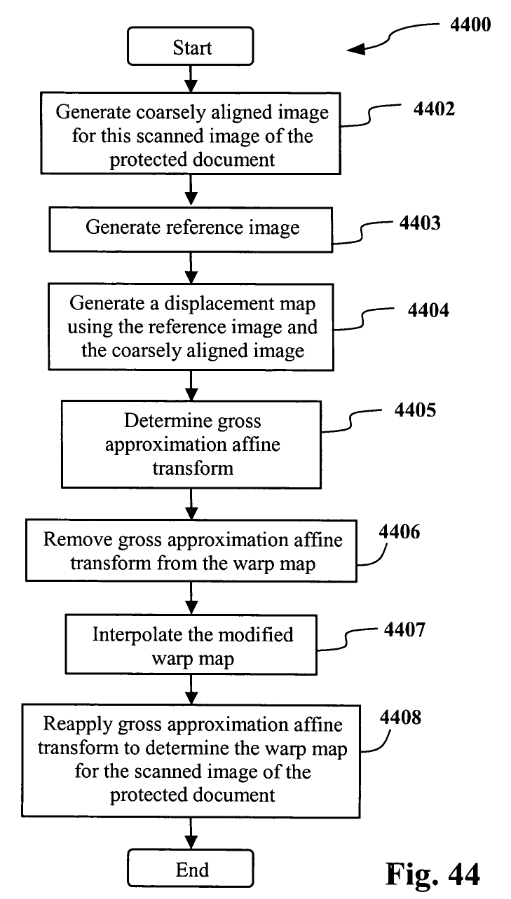

At the next step 3804, the processor 105 reads the border 3501 of the protected document 3500 and extracts salt data. Salt data is a small amount of data from the border 3501 of the protected document 3500, as will be described in more detail below. A method 4300 of extracting salt data from the border 3501 of the protected document 3500, will be described below with reference to FIG. 43. Then at the next step 3805, the processor 105 analyses the scanned image of the protected document 3500 to determine a fine alignment warp map. The fine alignment warp map describes where pixels in the protected document 3500 as printed appear in the scanned image of the protected document 3500 and may be used to align the scanned image of the protected document 3500 to the printed version of the protected document 3500. The fine alignment warp map determined at step 3805 may be used to align the scanned image of the protected document 3500 to the printed version of the protected document 3500. A method 4400 of determining a fine alignment warp map for aligning the scanned image of the protected document 3500, as executed at step 505, will be described below with reference to FIG. 44.

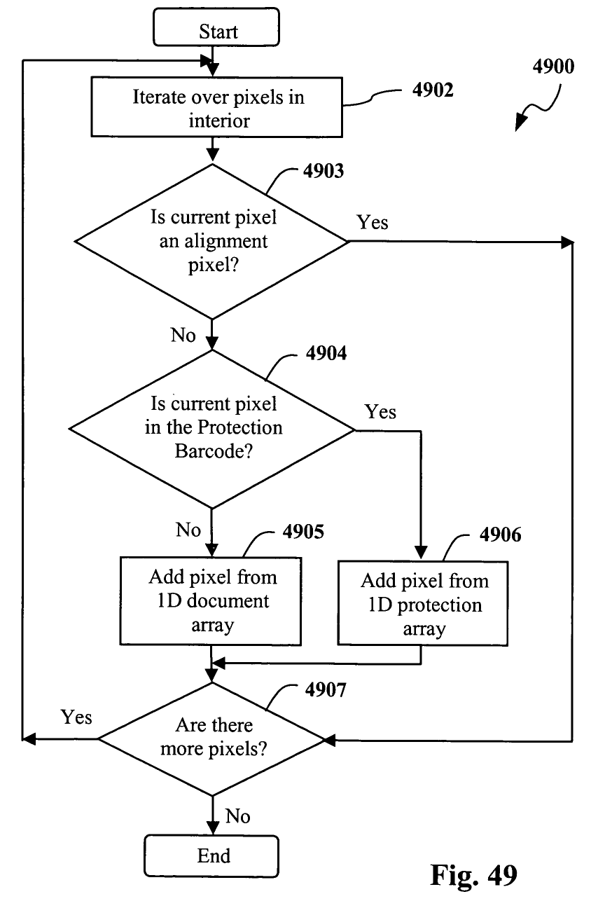

The method 3800 continues at the next step 3806, where the processor 105 extracts a 1D document array and a 1D protection array from the aligned scanned image of the protected document 3500. A method 4900 of extracting the 1D document array and 1D protection array from the scanned image of the protected document 3500, as executed at step 3806, will be described in detail below with reference to FIG. 49. As will be described in detail below, in the method 4900, the protection barcode 3503 and the document 3504 of the protected document 3500 are serialised into the 1D protection array and the 1D document array, respectively.

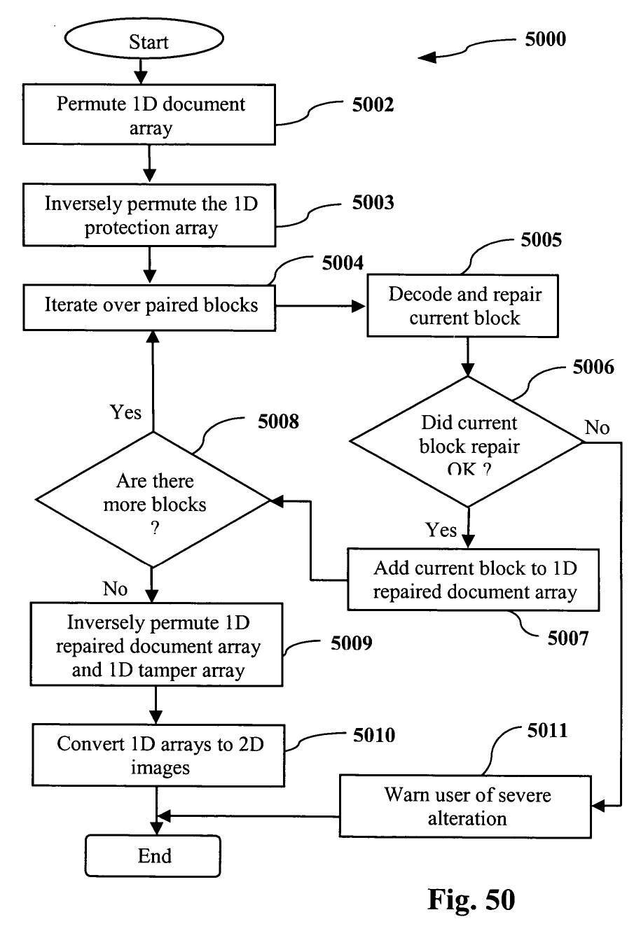

Then at the next step 3807 of the method 3800, the processor 105 uses the 1D document array and 1D protection array to detect alterations in the printed document 3500. At step 3807, the processor 105 produces two images, a first image showing the location of the alterations to the protected document 3500 and a second image correcting the alterations. A method 5000 indicating the location of the alterations to the protected document 3500 and generating an image correcting the alterations, will be described in detail below with reference to FIG. 50.

12.0 Spirals and Coarse Alignment

Step 3702 of the method 3700 and step 3802 of the method 3800 will now be described in more detail.

As described above, at step 3702, the processor 105 generates spirals in the corners (e.g., 3509) of the protected document 3500 located inside the border 3501 of the protected document 3500. These spirals are generated in the protected document 3500 since the spirals have distinctive properties that allow the spirals to be easily detected when the protected document 3500 is read.

As described above, at step 3802, the processor 105 determines a coarse alignment affine transform. The coarse-alignment transform is determined based on the dimensions of the protected document 3500. At step 3802, the processor 105 determines the locations of spirals in the scanned image of the protected document 3500 and uses the detected spirals to locate the protected document 3500 on a page. The processor 105 then determines the dimensions of the protected document 3500, the resolution of the pixels in the protected document 3500 and the coarse alignment affine transform.

The spirals used in the protected document 200 are bitmapped versions of logarithmic radial harmonic functions (LRHF) as described above.

12.1 Embedding Spirals

At step 3702 of the method 3700, the processor 105 generates six spirals in the protected document 3500. The spirals are embedded in the coarse alignment border pixels (e.g., 3504) of the protected document 3500. Each spiral is generated by generating a spiral bitmap (e.g. spiral bitmap 700 of FIG. 7), which samples the LRHF with the Nyquist radius R, the spiral angle σ and the phase offset φ. The spiral bitmap has height and width equal to B pixels.

Once the spiral bitmap 700 has been generated, the spiral represented by the spiral bitmap 700 may be embedded into the pixels of the protected document 3500. Pixels of the spiral bitmap 700 equal to zero (0) are encoded into the protected document 3500 by setting the state of a corresponding protected document pixel to “off”. Pixels of the spiral bitmap 700 equal to one (1) are encoded into the protected document 3500 by setting the state of a corresponding protected document pixel to “on”.

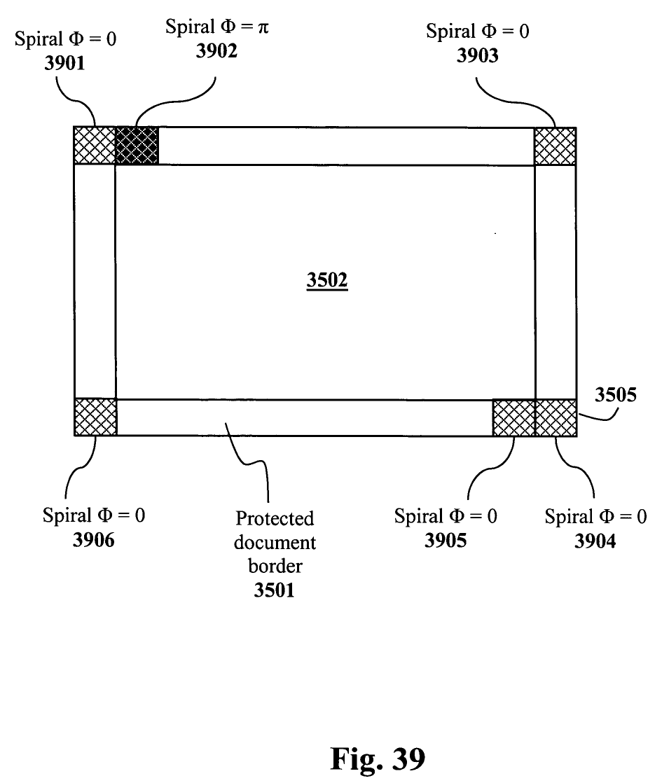

As seen in FIG. 39, six spirals 3901, 3902, 3903, 3904, 3905 and 3906 may be embedded in the border 3501 of the protected document 3500. Each of these spirals 3901, 3902, 3903, 3904, 3905 and 3906 is B pixels wide, and B pixels high. As described above, B may be equal to thirty-two (32) meaning that each of the spirals is thirty-two pixels wide and thirty-two pixels high. Five of the spirals (i.e., spirals 3901, 3903, 3904, 3905 and 3906, as seen in FIG. 39) embedded in the protected document 3500, have the same value for phase (i.e., φ=0), while the remaining spiral (i.e., spiral 3902) has an opposite phase (i.e., φ=π). The locations of the six spirals 3901, 3902, 3903, 3904, 3905 and 3906 embedded in the border 3501 of the protected document 3500 will now be described with reference to FIG. 39.

As seen in FIG. 39, four spirals 3901, 3903, 3904 and 3906 of the five spirals (i.e., spirals 3901, 3903, 3904, 3905 and 3906, as seen in FIG. 39) with phase φ=0 are positioned in the four corners (e.g., 3509) of the protected document 3500. The other spiral 3905 with φ=0 is positioned immediately to the left of the spiral 3904 in the bottom-right corner 3505 of the protected document 3500. The spiral 3902 with opposite phase φ=π is positioned immediately to the right of the spiral in the top-left corner of the protected document 3500. The six spirals 3901, 3902, 3903, 3904, 3905 and 3906 embedded in the border 3501 of the protected document 3500 are encoded into pixels of the border 3501 of the protected document 3500.

12.2 Higher Resolution Spirals

Spirals may be printed by the printer 115, for example, at a higher resolution than the resolution of the protected document 3500 being printed. This may allow more accurate sampling of an underlying LRHF, and better spiral detect ability when the protected document 3500 is scanned by the scanner 119, for example. For example, the spirals of the protected document 3500 may print at a ‘spiral resolution’, where the spiral resolution is equal to the resolution of printing of the protected document 3500 (i.e., the protected document resolution) multiplied by an integer referred to as a ‘spiral factor’, F. The spiral resolution is preferably a highest resolution at which the printer 115 is able to print. Each pixel at the protected document resolution in the coarse alignment border 3501, where a spiral is to be added to the protected document 3500, is divided into an F×F array of pixels at the spiral resolution. Thus, each spiral is composed of an array of pixels with a height of BF pixels and a width of BF pixels. In one example, the spiral bitmaps (e.g., 700) formed at step 3702 have a height H and width W equal to BF rather than B. In this instance, the spiral bitmaps (e.g., 700) are embedded into the pixel arrays.

12.3 Detecting Spirals

As described above, at step 3802 of the method 3800, the processor 105 detects the locations of spirals in the scanned image of the protected document 3500 and then determines a coarse alignment affine transform, using the locations of the spirals. The detection of spiral locations may be achieved by performing a correlation between a spiral template image and the scanned image of the protected document 3500.

The method 4000 of determining a coarse alignment affine transform, as executed at step 3802, will now be described with reference to FIG. 40. The method 4000 may be implemented as software resident on the hard disk drive 110 and being controlled in its execution by the processor 105.

The method 4000 begins at an initial step 4001, where the processor 105 generates a spiral template image, within memory 106, for example. The generation of the spiral template image at step 4001 is similar to the generation of the spiral bitmap in step 3702 of the method 3700. However, the spiral template image is complex valued and is larger in size than the spiral bitmap. Each pixel value in the spiral template image is stored in memory 106 as a pair of double-precision floating point numbers representing the real and imaginary parts of the pixel value. The spiral template image has height and width equal to Tₛ, the template size. The template size Tₛmay vary. In one example Tₛ=256.

Polar coordinates (r, θ) in the spiral template are defined, with the origin in the centre of the template. The pixel value at polar coordinates (r, θ) in the spiral template image may be determined in accordance with Formula (52) as follows:

$$\{ \begin{matrix}{ⅇ}^{j ( m θ + n ln r )} & if r > R \\ 0 & otherwise\end{matrix} \qquad ( 52 )$$

where m and n are defined by Formulae (2) above; the Nyquist radius R represents the radius at which the frequency of the LRHF becomes greater than π radians per pixel; and the spiral angle σ represents the angle that the spiral arms of the LRHF make with circles centred at the origin of the LRHF.

At the next step 4003, the processor 105 performs a correlation between the scanned image and the complex spiral template image to generate a correlation image.

The correlation of two images I₁ and I₂ is a correlation image Iₓ. The correlation image Iₓ may be determined in accordance with Formula (53) below:

$${I}_{x} ( x , y ) = {\sum }_{{x}^{′} , {y}^{′}} {I}_{1} ( {x}^{′} , {y}^{′} ) {I}_{2} ( {x}^{′} + x , {y}^{′} + y ) \qquad ( 53 )$$

The sum of Formula (53) ranges over all x′ and y′ where I₁ is defined, and, in the image I₂, the values of pixels outside the image are considered to be zero. If either of the images I₁ or I₂ is complex-valued, the correlation image Iₓ may be complex-valued too. The resulting correlation image Iₓ contains peaks (i.e., pixels with large modulus relative to neighbouring pixels), at the locations of spirals in the scanned image of the protected document 3500. The phase of the pixel value of a peak is related to the phase φ of a corresponding spiral (e.g., 3901) that was embedded in the protected document 3500. The five spirals 3901, 3903, 3904, 3905 and 3906 that were generated with φ=0 at step 3702 have peaks with similar phase, while the one spiral 3902 that was generated with φ=π at step 3702 typically has a peak with opposite phase to the peaks of the other five spirals. Even if the scanned image of the protected document 3500 is at a different resolution to the resolution that the protected document 3500 was printed at, the spirals 3901, 3902, 3903, 3904, 3905 and 3906, will still be detected by the processor 105 since the underlying LRHF of the spirals is scale-invariant.

At the next step 4004 of the method 4000, the processor 105 examines the correlation image resulting from step 4003, and locates the six peaks corresponding to each of the spirals 3901 to 3906 in accordance with the arrangement of the spirals 3901 to 3906 seen in FIG. 39. The six peaks corresponding to each of the spirals 3901 to 3906 may be located in accordance with the resolution at which the protected document 3500 was printed (represented as Rₚ) and the resolution at which the protected document 3500 was scanned (represented as Rₛ). If either of the resolutions Rₚ and Rₛ is not known, but there are only a few possibilities for the values of the resolutions Rₚ and Rₛ, then the six peaks of the spirals 3901 to 3906 may be located by trying each of the possible resolutions, and locating six peaks with a layout consistent with the corresponding possible resolution.

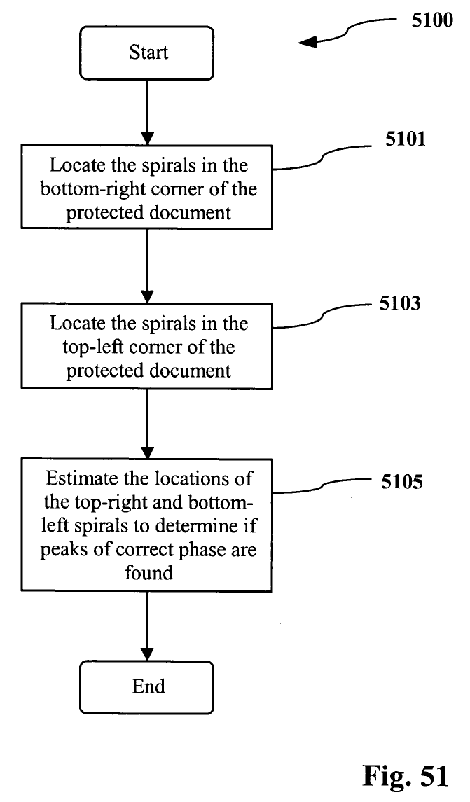

A method 5100 of locating the six peaks corresponding to each of the spirals 3901 to 3906, as executed at step 4004, will now be described with reference to FIG. 51. The method 5100 may be implemented as software resident on the hard disk drive 110 and being controlled in its execution by the processor 105.

The method 5100 begins at step 5101, where the correlation image determined at step 4003 is searched to locate the spirals 3904 and 3905 in the bottom-right corner 3505 of the protected document 3500. The spirals 3904 and 3905 correspond to a pair of peaks with approximately the same phase and lying approximately B×Rₛ/Rₚ pixels apart in the scanned image of the protected document 3500. The coordinates of each the peaks of the spirals 3904 and 3905 may be denoted by q₄ and q₅, respectively.

At the next step 5103, the correlation image determined at step 4003 is searched to locate the spirals 3901 and 3902 in the top-left corner of the protected document 3500. The spirals 3901 and 3902 correspond to a pair of peaks lying approximately (B×Rₛ/Rₚ) pixels apart in the scanned image of the protected document 3500. The peak of the spiral 3901 will have approximately the same phase as the peaks at q₄ and q₅ determined previously. The peak of the spiral 3902 will have approximately the opposite phase. The coordinates of the peak corresponding to the spiral 3901, in the scanned image, having approximately the same phase as the peaks at q₄ and q₅ may be denoted q₁. The coordinates of the peak corresponding to the spiral 3902, in the scanned image, having approximately the opposite phase as the peaks at q₄ and q₅ may be denoted q₂. If the peak at q₄ is closer in distance to the peak at q₁ than the peak at q₅ is, then the peaks at q₄ and q₅ may be swapped.

The method 5100 concludes at the next step 5105, where the locations of the top-right and bottom-left spirals 3903 and 3906 may be estimated. At step 5105 the correlation image of step 4003 is searched to see if peaks with the correct phase are at the locations determined for the spirals 3903 and 3906. If peaks with the correct phase are found at the locations of the top-right and bottom-left spirals 3903 and 3906, then a protected document with consistent layout to the printed version of the protected document 3500 has been found.

More than one pair of peaks may be found at the top-left hand corner of the protected document 3500 when searching for either of the peaks with the same or opposite phase. In this instance, different combinations of the peaks may be tried in order to find a correct combination.

Returning to the method 4000 of FIG. 40, at the next step 4005, the processor 105 determines the dimensions of the protected document 3500 and generates a coarse-alignment affine transform based on the determined dimensions. The dimensions of the protected document 3500 may be determined by examining the position of the peaks 3901, 3903 and 3906 in the scanned image of the protected document 3500.

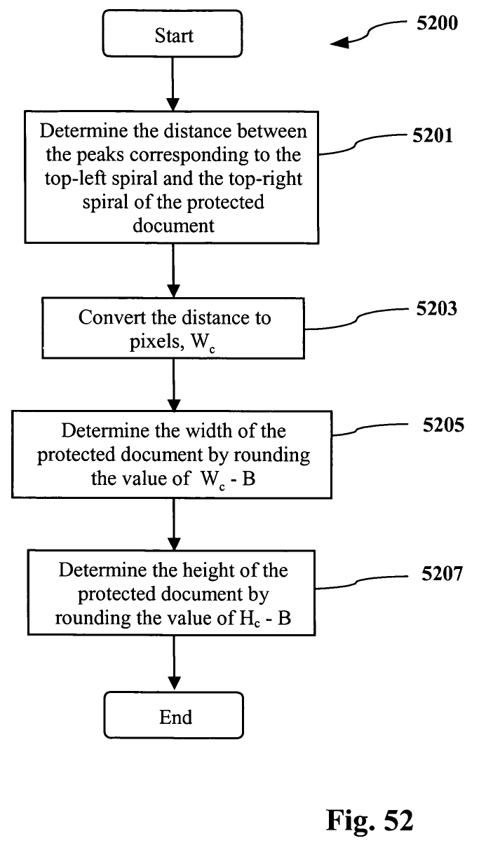

A method 5200 of determining the dimensions of the protected document 3500, as executed at step 4005, will now be described with reference to FIG. 52. The method 5200 may be implemented as software resident in the hard disk drive 110 and being controlled in its execution by the processor 105.

The method 5200 begins at step 5201, where the processor 105 determines the distance between the peaks corresponding to the top-left spiral 3901 and top-right spiral 3903. This distance may be denoted by ∥q₁−q₃∥. At the next step 5203, the distance determined at step 5201 is converted from scanned pixels to pixels in the printed version of the protected document 3500 by multiplying the distance ∥q₁−q₃∥ by Rₚ/Rₛ in accordance with Formula (54) below, where W_{c} represents the distance measured in protected document pixels:
W_{c}=∥q₁−q₃∥×Rₚ/Rₛ (54)

The value of W_{c} is an approximation of the distance between the centres of the two spirals 3901 and 3903 in the printed version of the protected document 3500. W_{c} is equal to the width of the protected document 3500 (i.e., Wₚ), plus half the width of the top-left spiral 3901, plus half the width of the top-right spiral 3903. Since the width of the spirals 3901 and 3903 is the border width B, the width Wₚ of the protected document 3500 is approximately W_{c}−B. At the next step 5205 of the method 5200, the width Wₚ is determined by rounding the value of W_{c}−B to the nearest multiple of the border width B, on the basis that the width Wₚ and height Hₚ of the protected document 3500 are both multiples of the border width B.

At the next step 5207, the processor 105 determines the protected document height Hₚ by rounding the value of H_{c}−B in accordance with Formula (55) as follows:
H_{c}−B=∥q₁−q₆∥×Rₚ/Rₛ−B (55)
to the nearest multiple of the border width B. The method 5200 concludes following step 5207.

The coarse-alignment affine transform is specified by a matrix A and a vector a. The coarse-alignment affine transform A is determined at step 4005 using the width W and height H of the protected document 3500 by determining the affine transform that takes the centres of the three spirals 3901, 3903, and 3906, to the positions of the three peaks q₁, q₃, and q₆ in the scanned image of the protected document 3500. If the elements of the matrix A are denoted as follows:

$$A = ( \begin{matrix}{a}_{00} & {a}_{01} \\ {a}_{10} & {a}_{11}\end{matrix} ) \qquad ( 56 )$$

then the matrix A may be determined using Formulae (57) and (58), as follows:

$$\begin{matrix}( \begin{matrix}{a}_{00} \\ {a}_{10}\end{matrix} ) = \frac{1}{{W}_{p}} ( {q}_{3} - {q}_{1} ) & ( 57 ) \\ ( \begin{matrix}{a}_{01} \\ {a}_{11}\end{matrix} ) = \frac{1}{{H}_{p}} ( {q}_{6} - {q}_{1} ) & ( 58 )\end{matrix}$$

Then the vector a may be determined in accordance with Formula (59), as follows:

$$a = {q}_{1} - B ( \begin{matrix}{a}_{00} + {a}_{01} \\ {a}_{10} + {a}_{11}\end{matrix} ) \qquad ( 59 )$$

13.0 Salt and Border Patterns

Steps 3703 of the method 3700 of FIG. 37 and step 3804 of the method 3800 of FIG. 38 will now be described in more detail. As described above, at step 3703, the processor 105 generates a border pattern for the protected document 3500, storing data in the border pixels (e.g., 3503) of the protected document 3500. Further, at the step 504, the processor 105 reads the border 3501 of the protected document 3500 and extracts data from the border 3501 of the protected document 3500. Each of steps 3703 and 3804 stores or reads a small amount of data (i.e., salt data) out of the border 3501 of the protected document 3500. The salt data may store metadata such as a version value representing the version of the protected document 3500.

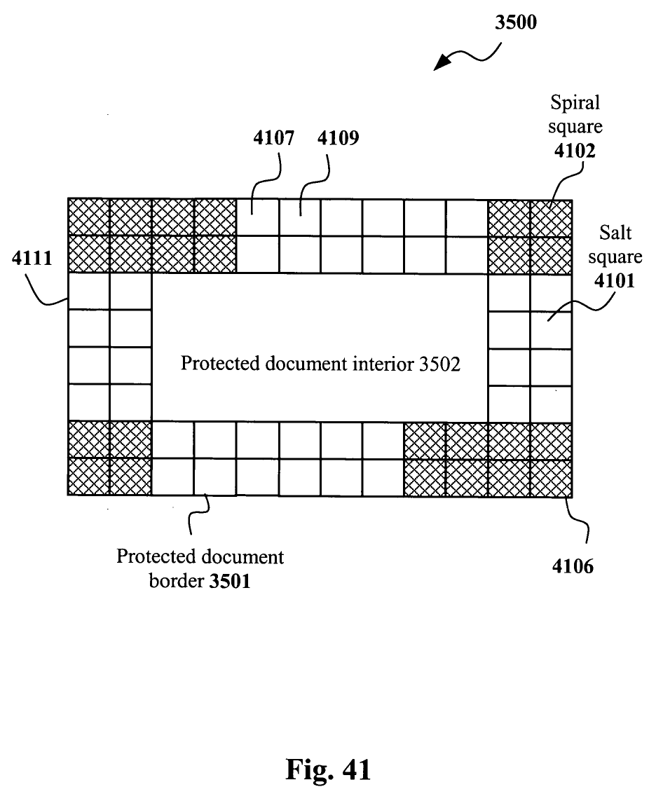

For the purposes of storing and reading the salt data, the border 3501 of the protected document is divided into squares (e.g., 4101, 4102), as shown in FIG. 41. The border 3501 has width equal to B, and the protected document 3500 has both height and width that are multiples of the border width B. Thus, the border 3501 of the protected document 3500 may be divided evenly into squares (e.g., 4101) with width and height equal to B/2. The square 4101 may be referred to as a ‘salt square’.

The corners (e.g., 4106) of the protected document 3500 contain spirals. As such, salt squares (e.g., 4102) that lie where a spiral has been placed may be removed from further consideration and are not considered as being salt squares. Each of the remaining salt squares, such as the square 4101, which have not been removed, may be used to store one bit of salt data.

For the purposes of storing and reading the salt data, two pseudo-random arrays, α₀ and α₁, may be used. These pseudo-random arrays, α₀ and α₁ represent noise patterns. Both of the arrays α₀ and α₁, at each 2-tuple of pixel coordinates (x, y), contain a value αᵢ(x, y) that is either zero (0) or one (1). Since the αᵢ are pseudo-random, the values αᵢ(x, y) will appear random, even though the values are predetermined given x and y. Any suitable pseudo-random number generation algorithm may be used to generate the arrays α₀ and α₁. For example, the arrays α₀ and α₁ may be generated using the RC4 algorithm, initialized with known seeds. The arrays α₀ and α₁ represent salt patterns, which may occur in the salt squares of the border 201, as will be described in detail below.

At step 3703 the processor 105 assigns values to the pixels in the coarse alignment border 3501 of the protected document 3500, in accordance with the salt data to be encoded. The number of bits of salt data that may be encoded is equal to the number of salt squares (e.g., 1401) that fit in the border 3501 of the protected document 3500, given the protected document dimensions. Thus, protected documents with different dimensions may be able to store different amounts of salt data.

The method 4200 of storing data in border pixels of the protected document 3500, as executed at step 3703, will now be described in detail with reference to FIG. 42. The method 4200 may be implemented as software resident in the hard disk drive 110 and being controlled in its execution by the processor 105.

The method 4200 begins at step 4202 where the processor 105 iterates through the salt squares (e.g., 4101) of the protected document 3500, in a predetermined order. For example, the processor 105 may iterate through the salt squares 4101 in scanline order. In this instance, on the first execution of step 4202, a leftmost salt square 4107 in the top row of salt squares is selected. This leftmost salt square 4107 becomes the currently selected salt square. On subsequent executions of 4202, subsequent salt squares (e.g., 4109 etc) in the topmost row will be selected, and then salt squares in subsequent rows will be selected, row by row. In some rows (e.g., row 4111) the salt squares may not all be adjacent.

At a following step 4203, the processor 105 sets the values of pixels in a currently selected salt square (e.g., 4101). At step 4203 the processor 105 assigns the values of the pixels in the currently selected salt square to corresponding values of αᵢ, as follows:
α(x, y, c)=αᵢ(x, y, c)
for all (x, y, c) in the selected salt square, where n is defined such that the currently selected salt square is the n-th salt square to be processed at step 4203, and i is the value of the n-th bit of the salt data.

At the next step 4204, if the processor 105 determines that there are more salt squares in the protected document 3500 to be processed then the method 4200 returns to step 4202. Otherwise, the method 4200 concludes.

13.2 Reading the Salt Data

The method 4300 of extracting salt data from the border 3501 of the protected document 3500, as executed at step 3804, will now be described with reference to FIG. 43. The method 4300 may be implemented as software resident on the hard disk drive 110 and being controlled in its execution by the processor 105.

In the method 4300, the processor 105 uses the coarse-alignment affine transform determined at step 4005 and the scanned image of the protected document 200 to extract the salt data from the border 3501 of the protected document 3500.

The method 4300 begins at step 4302, where the processor 105 iterates through the salt squares (e.g., 4101) of the protected document 3500. For example, the processor 105 may iterate through the salt squares in the same predetermined order used in step 4202 described above. The following steps 4303 to 4306 of the method 1200 determine which of the two salt patterns represented by the pseudo-random arrays α₀ or α₁ occur in a selected salt square 4101. This may be achieved by correlating both salt patterns with the selected salt square, and determining which of the salt patterns provides a larger result. Knowing which of the salt patterns correlate with the selected salt square enables the value of the data bit encoded in the selected salt square to be determined.

At step 4303, a coarsely-aligned image of the currently selected salt square is generated by the processor 105. The coarsely aligned image may be generated by interpolating the scanned image, in order to determine values for the coarsely aligned image at non-integer coordinates. The scanned image may be interpolated using bicubic interpolation. A greyscale value interpolated from the scanned image of the protected document 3500 at the coordinates (x, y) in the scanned image coordinate system may be denoted as s(x, y).

The coarsely-aligned image of the currently selected salt square may be denoted by Uₛ. The image Uₛ has both height and width equal to half the border width (i.e., B/2). As an example, if the currently selected salt square has a top-left pixel at coordinates (xₛ, yₛ, c), then pixels in Uₛ correspond to the pixels with x-coordinates between xₛ and xₛ+B/2−1, and y-coordinates between yₛ and yₛ+B/2−1. If the x- and y-coordinates of Uₛ range from 0 to B/2 −1, then the image Uₛ may be generated in accordance with Formula (60) as follows:

$${U}_{s} ( x , y ) = s ( A ( \begin{matrix}x + xs \\ y + ys\end{matrix} ) + a ) \qquad ( 60 )$$

That is, the pixel coordinates are transformed using the coarse alignment affine transform, resulting in coordinates in the scanned image of the protected document 3500. The scanned image may then be interpolated at these coordinates, and the greyscale value may be encoded into the coarsely-aligned image Uₛ.

Two images, U₀ and U₁, may also be generated at step 4303. The images U₀ and U₁ contain the expected salt patterns, as represented by the arrays α₀ and α₁. The images U₀ and U₁ may be generated as follows:
U₀(x, y)=α₀(x+xₛ, y+yₛ)
U₁(x, y)=α₁(x+xₛ, y+yₛ) (61)

The method 4300 continues at the next step 4304, where the processor 105 performs two circular correlations. The circular correlation of two images I₁ and I₂ with the same dimensions generates a third image Iₓ with the same dimensions, according to Formula (62) below:

$${I}_{x} ( x , y ) = {\sum }_{{x}^{′} , {y}^{′}} {I}_{1} ( {x}^{′} , {y}^{′} ) {I}_{2} ( {x}^{′} + x , {y}^{′} + y ) \qquad ( 62 )$$

The sum of Formula (62) ranges over all x′ and y′ where I₁ is defined, and, in the image I₂, the values of pixels outside the image I₂ may be obtained by considering I₂ to be periodic.

Two circular correlations are performed at step 4304 in accordance with the Formula (62). The first of these circular correlations is the correlation of Uₛ and U₀, resulting in a correlation image U_{X0}. The second of these correlations is the correlation of Uₛ and U₁, resulting in a correlation image U_{X1}.

At the next step 4305, the processor 105 determines maximum values in the correlation images U_{X0} and U_{X1}. Then at the next step 4306, the processor 105 stores a salt bit in a buffer containing salt data, using the maximum values determined at step 4305. If the maximum value in image U_{X0} is greater than the maximum value in image U_{X1}, then the salt bit stored in the buffer is a zero (0). Otherwise, the largest value in U_{X1} is greater than the largest value in U_{X0}, and the salt bit stored in the buffer is a one (1). The buffer containing the salt data may be configured within memory 106. At the next step 4307, if the processor 105 determines that there are more salt squares to be processed, then the method 4300 returns to step 4302. Otherwise, the method 4300 concludes.

14.0 Fine Alignment

The method 4500A of generating an alignment pattern in the alignment pixels (e.g., 3505) in the interior 3502 of the protected document 3500, as executed at step 3704, for documents that do not have a dominant amount of one color, will now be described in more detail with reference to FIG. 45A. The method 4500B of generating an alignment pattern in the alignment pixels (e.g., 3505) of the protected document 3500, as executed at step 3704, for documents that do have a dominant amount of one color, will also be described in more detail with reference to FIG. 45B. The method 4400 of determining a fine alignment warp map for the scanned image of the protected document 3500, as executed at step 3805, will also be described.

The fine alignment warp map is determined in the method 4400 using the alignment pattern generated in accordance with either of the methods 4500A or 4500B, depending on whether or not the document being processed has a dominant amount of one color.

The method 4500A may be implemented as software resident on the hard disk drive 110 and being controlled in its execution by the processor 105. The method 4500A comprises one step 4501, where the processor 105 encodes an alignment pattern into the pixels of the protected document 3500. The alignment pattern used may be represented as a pseudo-random (i.e., noise) array of bits. For example, the pseudo-random array of bits α₀ described above may be used at step 4501. In this instance, at step 4501, the processor 105 may set the value of each alignment pixel (x, y) (e.g., 3505) of the protected document 3500 to α₀(x, y). The alignment pattern may be distributed uniformly across the pixels in the interior 3502 of the protected document 3500. Alternatively, the alignment pattern may be distributed in one or more particular areas of the interior 3502 of the protected document 3500.

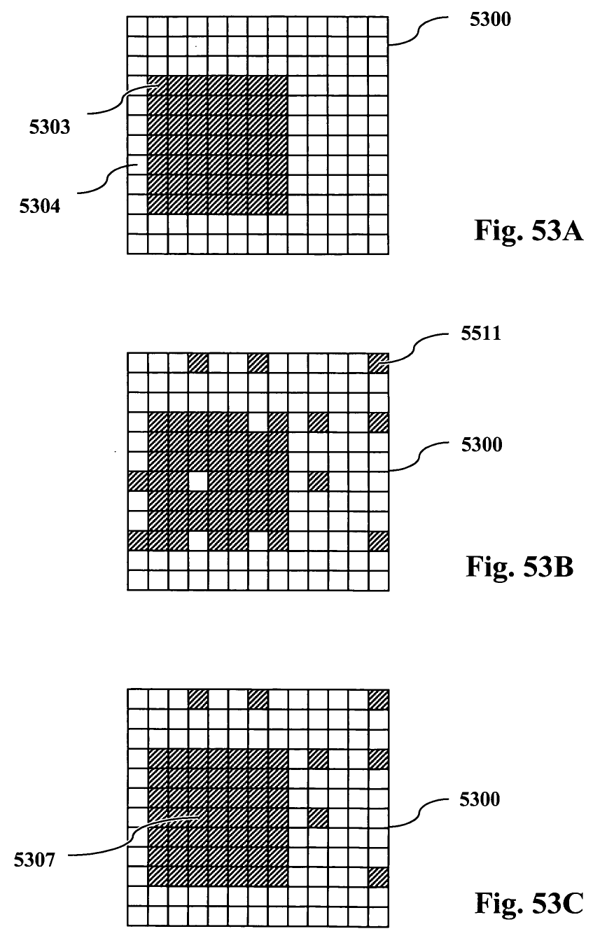

As an example, FIG. 53A show a protected document 5300 before alignment pixels have been inserted FIG. 53B shows the document 5300 with alignment pixels (e.g., 5305) inserted into the protected document 5300 using the method 4500A. As seen in FIG. 53B, the alignment pixels (e.g., 5305) have resulted in significant corruption of the protected document 5300.

As described above, the method 4500B of generating an alignment pattern in the alignment pixels of a protected document may be used for protected documents that do have a dominant amount of one color. A text document is an example of such a document. Text documents typically comprise 10% black pixels and 90% white pixels. To describe the method 4500B, a pixel in the protected document 5300 of FIG. 53A may be denoted as d(x,y), a less frequent color (e.g., 5803) in the protected document 5300 may be denoted as C₀ and a more frequent color (e.g., 5304) in the protected document 2800 may be denoted as C₁. The method 4500B may be implemented as software resident in the hard disk drive 110 and being controlled in its execution by the processor 105. The method 4500B, begins at the first step 4502, where the processor 105 selects an alignment pixel (x, y) (e.g., 5305) in the protected document 5300. At the next step 4503, if the corresponding protected document 5300 pixel d(x, y) is set to C₀, then the method 4500B proceeds to step 4504. Otherwise, the method 4500B proceeds to step 4505. At step 4504, the processor 105 sets the selected alignment pixel to C₀ and the method 4500B proceeds to step 4508.

At step 4505, if the protected document pixel d(x, y) is set to C₁ and one of the pixels adjacent to d(x, y) is set to C₀, then the method 4500B proceeds to step 4506. Otherwise, the method 4500B proceeds to step 4507. At step 4506, the processor 105 sets the alignment pixel (x, y) to C₁.

At step 4507, the alignment pixel is set it to α₀(x, y). At the next step 4508, if there are more pixels in the document 5300 to process, then the method 4500B returns to step 4502. Otherwise the method 4500B concludes.

As an example, FIG. 53C shows the document 5300 with alignment pixels (e.g., 5305) inserted using the method 4500B. As seen in FIG. 53C, image quality of the document 5300 is improved, as C₀-colored pixels (e.g., 5807) remain C₀ colored without corruption by C₁-colored alignment pixels. Also, the shape of C₀-colored regions is preserved as a C₁-colored border is present around such regions.

The method 4400 of determining a fine alignment warp map for the scanned image of the protected document 3500, as executed at step 3805, will now be described with reference to FIG. 44. The method 4400 may be implemented as software resident in the hard disk drive and being controlled in its execution by the processor 105.

The fine alignment warp map is generated in preparation for verification of the protected document 3500. The method 4500A of generating an alignment pattern in the alignment pixels of a document is used in the method 4400. The method 4500B is not used since the version of the protected document before alignment pixels have been inserted is not accessible.

The method 4400 uses the scanned image of the protected document 3500, and the coarse alignment affine transform specified by the matrix A and the vector a according to Formula (11) and determines the warp map for the scanned image of the protected document 3500. If the scanned image of the protected document 3500 has alignment pixels generated in accordance with the method 4500B, the scanned image will be aligned against an alignment pattern which is slightly different from a reference image used to create the protected document 3500. Fine alignment may still be able to be used to align the scanned image of the protected document 3500 despite the minor differences in the alignment patterns.

The method 4400 begins at step 4402 where the processor 105 generates a coarsely-aligned image for the scanned image of the protected document. The coarsely-aligned image is generated from the scanned image using the coarse alignment affine transform specified by the matrix A and the vector a. The dimensions of the coarsely-aligned image are the same as the dimensions of the protected document 3500.

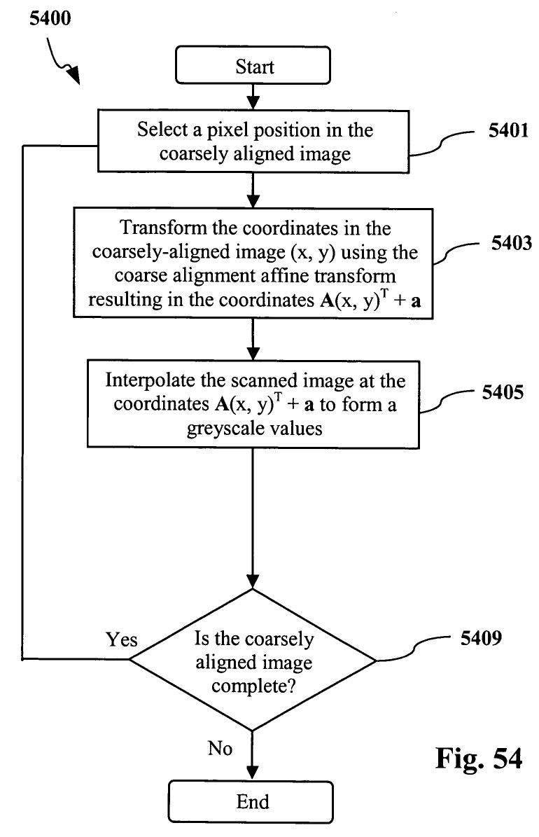

A method 5400 of generating a coarsely-aligned image for the scanned image of the protected document 3500, as executed at step 4402, will now be described with reference to FIG. 54. The method 5400 may be implemented as software resident on the hard disk drive 110 and being controlled in its execution by the processor 105.

The method 5400 begins at step 5401, where the processor 105 selects the coordinates for a first pixel position (i.e., a current pixel position) in the coarsely-aligned image. The coarsely-aligned image may be generated in memory 106, for example. At the next step 5403, the processor 105 transforms the selected coordinates in the coarsely-aligned image (x, y) using the coarse alignment affine transform, resulting in coordinates A(x, y)^{T}+a for the selected pixel in the scanned image of the protected document 3500. Then at the next step 5405, the processor 105 interpolates the scanned image at the coordinates A(x, y)^{T}+a, using bicubic interpolation, resulting in a greyscale value. The resulting pixel value is stored in the coarsely-aligned image configured within memory 106 at the current pixel position. Then at the next step 5409, if the coarsely aligned image is complete (i.e., all pixel values have been generated for the coarsely-aligned image), the method 5400 concludes. Otherwise, the method 5400 returns to step 5401 to select a next pixel position in the coarsely aligned image.

Alternatively, the scanned image may first be blurred with a low-pass filter prior to execution of the method 5400. Blurring the scanned image of the protected document 3500 using the low-pass filter may reduce the effects of aliasing introduced when a high-resolution scanned image is transformed to produce a lower-resolution coarsely-aligned image. Any suitable low-pass filter may be used to blur the scanned image. The selection of the low-pass filter may be based on the ratio between the resolution of the scanned image and the resolution of the protected document 3500.

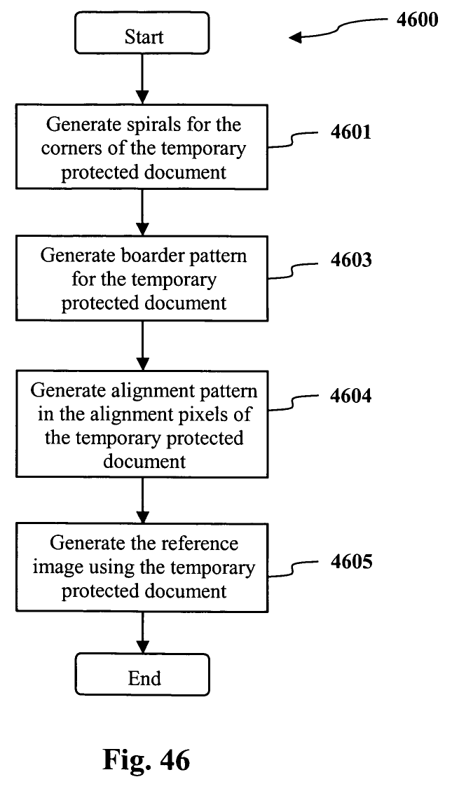

Following step 4402 of the method 4400, at the next step 4403, the processor 105 generates a reference image. A method 4600 for generating a reference image, as executed at step 4403, will now be described with reference to FIG. 46. The method 4600 may be implemented as software resident on the hard disk drive 110 and being controlled in its execution by the processor 105.

The method 4600 generates a temporary protected document with the same parameters (i.e., dimensions and salt value) as the protected document 3500. The temporary protected document may be configured within memory 106. The temporary protected document may be used to generate the reference image. The protected document dimensions and salt value used in the method 4600 have been determined previously in steps 3802 and 3804 of the method 3800.

The method 4600 begins at step 4601, where the processor 105 generates spirals for the corners of the temporary protected document, in a similar manner to the generation of the spirals for the protected document 3500 at step 3702 of the method 3700. At the next step 4603, the processor 105 generates a border pattern for the temporary protected document, storing data in the border pixels of the temporary protected document, in a similar manner to the generation of the border pattern for the protected document 3500 at step 3702 of the method 3700. Then at the next step 4604, the processor 105 generates an alignment pattern in the alignment pixels in an interior region of the temporary protected document, in a similar manner to the generation of the alignment pattern at step 3704 of the method 3700 for the protected document 3500. Accordingly, at step 4604, all of the pixels in the temporary protected document have been assigned values, except for the document pixels and the protection pixels.

The method 4600 continues at the next step 4605 where the processor 105 generates the reference image, within memory 106, using the temporary protected document. Initially the reference image is empty. When the pixels in the temporary document are “on”, a corresponding pixel in the reference image is set to a value of +1, and when the pixels are “off”, the corresponding pixel in the reference image is set to a value of −1. For the document pixels and the protection pixels which have not been assigned values previously, the corresponding pixel in the reference image is given a value of 0. The method 4600 concludes following step 4605.

At step 4403, where spirals are printed at a higher resolution than the protected document resolution where the spirals are to be embedded, rather than dividing these pixels into F×F pixels, the pixels may be left undefined. In this instance, the pixels in the reference image corresponding to undefined pixels in the temporary protected document may be assigned the value 0.

At the next step 4404 of the method 4400, the processor 105 uses the coarsely-aligned image and the reference image to generate a displacement map d_{c}. The displacement map d_{c} stores displacement vectors. Each displacement vector stored is associated with a location in the reference image, and measures the amount of shift between the reference image and the coarsely-aligned image at that location.

The displacement map d_{c} may be generated at step 4404 using the method 1700 of generating a displacement map d_{c} for the color channel c as described above. The generation of the displacement map d_{c} involves selection of a tile size 2 Q and a step size P. The tile size and step size may be varied. Larger values of Q give more measurement precision, at the expense of averaging the increased precision over a larger spatial area, and possibly more processing time. Smaller values of step size P give more spatial detail. However, again using smaller values of step size P may increase processing time. As an example, in one implementation Q=96, and P=16. This represents a tile of 192 pixels high by 192 pixels wide, stepped along the reference image and the coarsely-aligned image, in both horizontal and vertical directions, in 16 pixel increments.

Following the generation of the displacement map d_{c} at step 1304, the following steps of the method 4400 may use the displacement map d_{c} to generate a warp map w_{c}. The warp map w_{c} maps each pixel in the printed version of the protected document 3500 to a location in the coordinate space of the scanned image of the protected document 3500. Some parts of the warp map w_{c} may map pixels in the protected document 3500 to coordinates outside the scanned image, since the scanner 119 may not have scanned the entire printed version of the protected document 3500.

If (x, y) are the coordinates of a pixel in the reference image, then the displacement map d_{c}(x, y) represents the shift to a corresponding location in the coarsely-aligned image. Therefore, the corresponding coordinates in the coarsely-aligned image may be determined as (x, y)^{T}+d_{c}(x, y). Applying the coarse alignment affine transform to the reference image provides the coordinates in the scanned image. The warp map w_{c} maps each pixel (x, y) in the protected document 3500 to a location in the coordinate space of the scanned image of the protected document 3500 in accordance with Formula (63) as follows:
w_{c}(x, y)=A((x, y)^{T}+d_{c}(x, y)+a (63)

However, the displacement map d_{c}(x, y) is only defined at a few places, namely the locations of the centres of some correlation tiles (e.g., 1603 and 1604). In order to determine a value for Formula (63) at the locations of all pixels of the protected document 200, the displacement map d_{c} is interpolated.

The method 4400 continues at the next step 4405, where the processor 105 determines an affine transform defined by a matrix G and vector g. The affine transform determined at step 1305 may be referred to as a gross approximation affine transform. The gross approximation affine transform approximates the warp map w_{c} with an affine transform. The error function to be minimized in determining the affine transform is the Euclidean norm measure E that may be defined according to Formula (64) as follows:

$$E = {\sum }_{( x , y )} {‖ G ( \begin{matrix}x \\ y\end{matrix} ) + g - {w}_{c} ( x , y ) ‖}^{2} \qquad ( 64 )$$

Formula (64) may be solved using least squares minimisation methods to determine the affine transform in accordance with Formula (65) as follows:

$$( G \vert g ) = ( {\sum }_{( x , y )} {w}_{c} ( x , y ) {( \begin{matrix}x \\ y \\ 1\end{matrix} )}^{T} ) {( {\sum }_{( x , y )} ( \begin{matrix}x \\ y \\ 1\end{matrix} ) {( \begin{matrix}x \\ y \\ 1\end{matrix} )}^{T} )}^{- 1} \qquad ( 65 )$$

For both Formulae (64) and (65), the sums are taken over all coordinate pairs (x, y) where the displacement map d_{c}(x, y) is defined, and hence the warp map w_{c}(x, y) is defined, via Formula (63).

At the next step 4406 of the method 4400, the processor 105 removes the gross approximation affine transform from the warp map w_{c} to generate a modified warp map w_{c}′ in accordance with Formula (66) as follows:
w_{c}′(x, y)=w_{c}(x, y)−G(x, y)−g (66)
where the modified warp map w_{c}′ is defined at coordinates (x, y) at which d_{c}(x, y) is defined. Thus, the modified warp map w_{c}′ is defined at some points (x, y) that lie on the grid formed by the centres of the correlation tiles (e.g., 1603, 1604).

The method 4400 continues at the next step 4407, where the processor 105 interpolates the modified warp map w_{c}′, so that the modified warp map w_{c}′ is defined at all pixel coordinates (x, y) in the protected document 3500. The method 2000 of interpolating a mapping, as executed at step 1307, may be executed at step 4407.

At the next step 4408, the processor 105 then reapplies the previously removed gross approximation affine transform to the modified warp map w_{c}′ to generate the warp map w_{c} in accordance with Formula (67) as follows:
w_{c}(x, y)=w_{c}′(x, y)+G(x, y)^{T}+g (67)
The warp map is now defined at all pixels in the protected document 3500 and may be denoted w. The method 4400 concludes following step 4408.
15.0 Document Protection and Verification

Tamper protection may be applied to the protected document 3500. The tamper-protected document 3500 may be verified for authenticity.

Error-correction coding may be applied to the document 3504 of the protected document 3500 using an error correction code (ECC) so that tamper detection and correction of each pixel of the document 3504 is possible. In this instance, low density parity check (LDPC) coding may be used to apply error-correction coding to the document 3504. The publication “Low-density parity-check codes”, IRE Transactions on Information Theory, Vol. 8, January 1962, describes one error-correction coding method which may be applied to the document 3504. Alternatively, other error-correction coding methods may also be applied to the pre-processed data. For example, Reed-Solomon (RS) coding or Turbo codes.

Low density parity check (LDPC) coding is a block coding scheme, in which data representing the document 3504 is first divided into blocks of length ECCK bits, and each block is encoded to produce encoded blocks of length ECCN bits, where ECCN and ECCK are parameters of the particular LDPC code in use. The encoded blocks have (ECCN−ECCK) parity bits. If the length of any pre-processed data representing the document 3504 is not a multiple of ECCK bits, the pre-processed data may be padded with zeros to make the length a multiple of ECCK bits.

The width and area of the protection barcode 3503 may be determined based on the shape and the proportion of parity bits in the LDPC code, respectively, as will be described in detail below. The protection barcode 3503 may be appended to the top and bottom of the document 3504, and the width of the barcode 3503 is the same on both sides of the barcode 3503. The width of the barcode 3503 may be referred to as BarcodeWidth.

The width and height of the interior 3502 of the protected document 3500 is a multiple of the width of the coarse alignment border 3501.

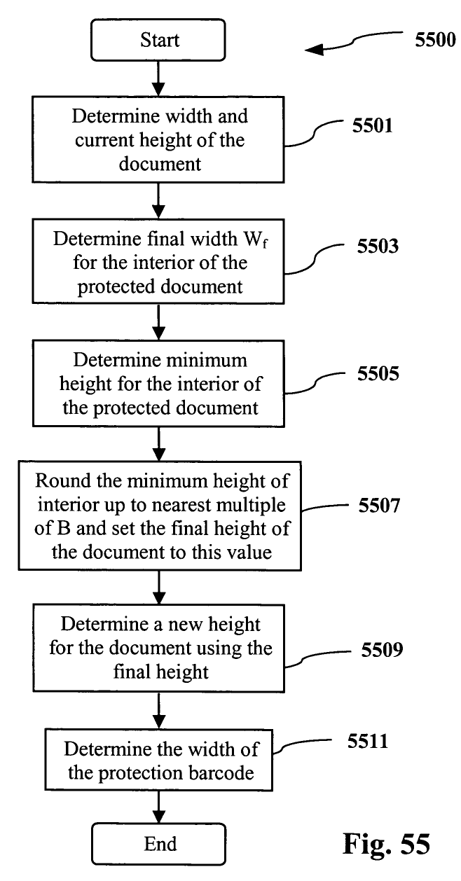

A method 5500 of determining the width of the protection barcode 3503, BarcodeWidth, for the protected document 3500 when protecting a document 3504, will now be described in detail below with reference to FIG. 55. As described above, the width of the coarse alignment border 3501 may be denoted as B. The method 5500 ensures that the interior 3502 of the protected document 3500 has the correct dimensions in order to fit the protection barcode 3503. The method 5500 determines the height of the interior 3502 to accommodate the protection barcode 3503 and the document 3504 and then rounds both the width and increased height of the interior 3502 up to a nearest multiple of the width of the border 3501, B.

The method 5500 may be implemented as software resident in the hard disk drive 110 and being controlled in its execution by the processor 105. The method 5500 begins as step 5501, where the processor 105 determines a width ‘W’ of the document 3504, and a current height ‘H’ of the document 3504. At the next step 5503, the processor 105 determines a final width W_{f} for the document 3504 by rounding the document width ‘W’ up to the nearest multiple of B. Then at the next step 5505, a minimum height, MinHeight, for the interior 3502 of the protected document 3500 is determined in accordance with Formula (68) as follows:

$$MinHeight = ⌈ \frac{H \times ECCN}{ECCK} ⌉ + ⌈ \frac{ECCN - ECCK}{{W}_{f}} ⌉ + 1 \qquad ( 68 )$$

The method 5500 continues at the next step 5507, where the processor 105 rounds up the minimum height, MinHeight, to the nearest multiple of B. A final height of the document H_{f} may be determined by setting H_{f} to the rounded value of MinHeight. At the next step 5509, since the total height of the interior 3502 has changed, the new height of the original document H_{new} is determined in accordance with Formula (69) as follows:

$${H}_{new} = ⌊ \frac{( {H}_{f} - ⌈ \frac{ECCN - ECCK}{{W}_{f}} ⌉ - 1 ) * ECCK}{ECCN} ⌋ \qquad ( 69 )$$

The new dimensions W_{f} and H_{new} may be used as the dimensions of the document 3504 when the document 3504 is encoded. In this instance, the document 3504 may be padded with a border of white pixels so that the document 3504 fits the new dimensions W_{f} and H_{new}.

The method 5500 concludes at the next step 5511, where the processor 105 determines the width, BarcodeWidth, of both the top 3503A and bottom 3503B regions of the protection barcode 3503, and the total area, BarcodeArea, of the protection barcode 3503, in accordance with Formulas (70) and (71), respectively.

$$BarcodeWidth = \frac{{H}_{f} - {H}_{NEW}}{2} \qquad ( 70 )$$

BarcodeArea=BarcodeWidth×W_{f}×2 (71)

The BarcodeArea may be greater than a minimum area needed for the barcode 3503. If the shape of the protection barcode 3503 is changed, then the method for determining the size of the protection barcode 3503 will also change.

If the value determined for BarcodeWidth is not an integer, then the top half of the protection barcode 3503 will have ┌BarcodeWidth┐ lines of pixels, and the bottom half of the protection barcode 3503 will have └BarcodeWidth┘ lines of pixels.

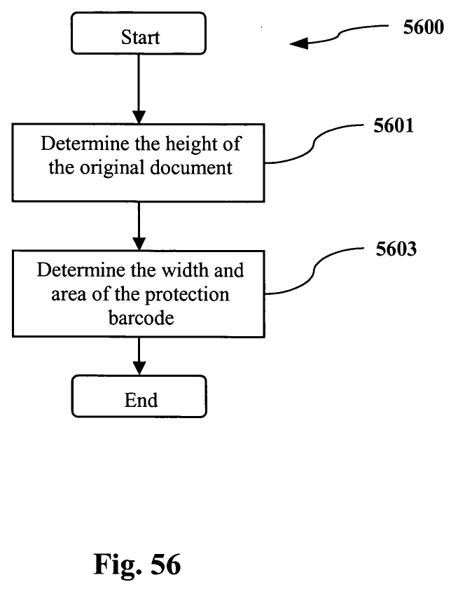

A method 5600 of determining the width of the protection barcode 3503, BarcodeWidth, for the protected document 3500 when verifying the protected document 3500, will now be described in detail below with reference to FIG. 56. The width and height of the interior 3502 of the protected document 3500 being verified may be denoted as Wᵣ and Hᵣ respectively.

The method 5600 begins at the first step 5601, where the processor 105 determines the height of the document 204, Hₒ, using the height Hᵣ of the interior 3502 of the protected document 3500 being verified. At the next step 5603, the processor 105 determines the width, BarcodeWidth, and the area, BarcodeArea, of the protection barcode 3503 in accordance with Formulas (73) and (74) as follows:

$$\begin{matrix}{H}_{o} = ⌊ \frac{( {H}_{r} - ⌈ \frac{ECCN - ECCK}{{W}_{r}} ⌉ - 1 ) * ECCK}{ECCN} ⌋ & ( 72 ) \\ BarcodeWidth = \frac{{H}_{r} - {H}_{o}}{2} & ( 73 ) \\ BarcodeArea = BarcodeWidth \times {W}_{r} \times 2 & ( 74 )\end{matrix}$$

Again, if the value determined for BarcodeWidth is not an integer, then the top half of the protection barcode 3503 will have ┌BarcodeWidth┐ lines of pixels, and the bottom half of the protection barcode 3503 will have └BarcodeWidth┘ lines of pixels.

Different LDPC codes may be chosen and used. As such, a direct trade-off may be made between the size of the protection barcode 3503 and ability to recover the document 3504. For example, an LDPC code with a large amount of redundancy may be used to protect a very valuable document 3504, at the cost of a larger protection barcode 3503.

15.1 Tamper Protecting a Document

Tamper protection is applied in two steps. As described above, step 3705 of the method 3700 accesses data in the form of a bi-level image representing the document 3504 to be protected, from memory 106 for example and encodes the data to form a 1D document array and a 1D protection array. The 1D document array represents a serialised version of the document 3504. The 1D protection array comprises protection bits.

As described above, at step 3706 the processor 105 arranges the 1D document array and the 1D protection array on a page, as the document 3504 and the protection barcode section 3503, respectively.

The method 4700 of encoding a document 3504 to be protected into 1D document array and a 1D protection array, as executed at step 3705, will now be described with reference to FIG. 47. The method 4700 begins at step 4702, where the processor 105 serialises the document 3504 to form a 1D image array. The processor 105 accesses the pixels of the bi-level image representing the document 3504 in raster order (i.e., from left to right, then from top to bottom) and adds the pixels of the document 3504 one by one to the 1D document array configured within memory 106. The 1D document array may also be padded with zeros so that the size of the array is a multiple of ECCK.

At the next step 4703, the processor 105 pseudo-randomly permutes the order of elements of the 1D document array. Step 4703 is executed since document alterations or tampering are generally localised. Once serialised, such alterations manifest as a burst error in the 1D document array. Most error correcting codes, including LDPC codes have difficulty correcting burst errors. However, such error correcting codes correct dispersed errors more easily. Allowing localised alterations to remain localised reduces the effectiveness of the described methods. Permuting the elements in the 1D document array at step 4703, converts localised tampers into dispersed tampers.

Many methods may be used to generate a pseudo-random permutation at step 4703 and use the permutation to scramble the ordering of elements in a 1D array. For example, a pseudo-random array of positive integers α₂(x) may be generated using the RC4 random number generation algorithm.

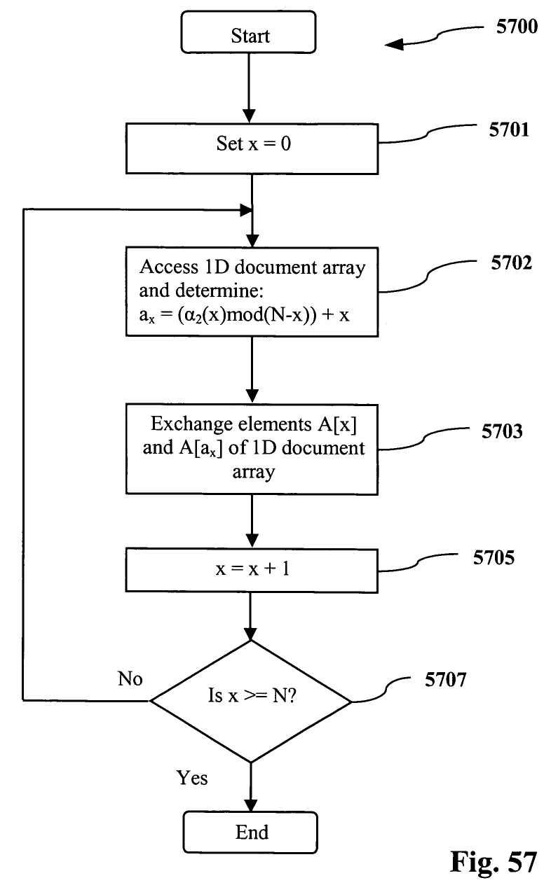

A method 5700 of generating a pseudo-random permutation, as executed at step 4703, will now be described with reference to FIG. 57. The method 5700 may be implemented as software resident on the hard disk drive 110 and being controlled in its execution by the processor 105. The length of the 1D document array may be denoted as N.

The method 5700 begins at step 5701, where the processor 105 sets a variable x configured in memory to zero (i.e., x=0), where x ranges from (0, N-1). Then at the next step 5702, the processor 105 accesses the 1D document array, denoted as A[x], and determines (α₂(0) mod (N)). The result of step 5702 may be denoted as α₀ (i.e., aₓ). At the next step 5703, the processor 105 exchanges elements at A[0] and A[a₀] of the 1D document array, A[x]. Then at the next step 5705, the processor 105 sets x equal to x plus one (1) (i.e., x=x+1). If x is greater than or equal to N at the next step 5707, then the method 5700 concludes. Otherwise, the method 5700 returns to step 5702. At the second execution of step 5702, the processor 105 determines (α₂ (1) mod (N-1))+1, since x=1. The result of the second execution of step 5702 may be denoted a₁. Then at the next execution of step 5703, the processor 105 exchanges the elements at A[1] and A[a₁ ]. The method 5700 proceeds in this manner until x is greater than or equal to N at step 5707 and the 1D document array is randomly permuted.

The method 4700 continues at the next step 4704, where the processor 105 divides the 1D document array into blocks of size ECCK. These blocks may be processed one at a time from left to right in the following steps 4705 to 4707, where a current block BK is accessed at each iteration of the steps 4705 to 4707.

At step 4705, the processor 105 accesses block BK and uses the LDPC encoder to generate an encoded block of size ECCN comprising the concatenation of the original block BK and generated parity bits. This encoded block may be denoted BK_{E}. Then at the next step 4706, the processor 105 extracts the (ECCN−ECCK) generated parity bits from block BK_{E}, and adds the extracted parity bits to the end of the 1D protection array.

The method 4700 continues at the next step 4707, where if there are more blocks of the 1D document array to process, then the method 4700 returns to step 4704. Otherwise, the method 4700 proceeds to step 4708. When all of the blocks of the 1D document array have been processed, the 1D protection array is padded with zeros so that the 1D protection array is the same size as the BarcodeArea described above.

At step 4708, the processor 105 accesses the 1D protection array and pseudo-randomly permutes the order of the elements of the 1D protection array in accordance with the method 5700, where the array accessed at step 5702 of the method 5700 is the 1D protection array rather than the 1D document array.

The method 4700 continues at the next step 4709, where the processor 105 accesses the permuted 1D document array from memory 110, for example, and applies the inverse pseudo-random permutation applied in step 4703. The method used to inverse pseudo-random permute the 1D document array at step 4709 depends on the method of permutation used in step 4703. The pseudo-random array of integers α₂ (x) described above may be used at step 4709.

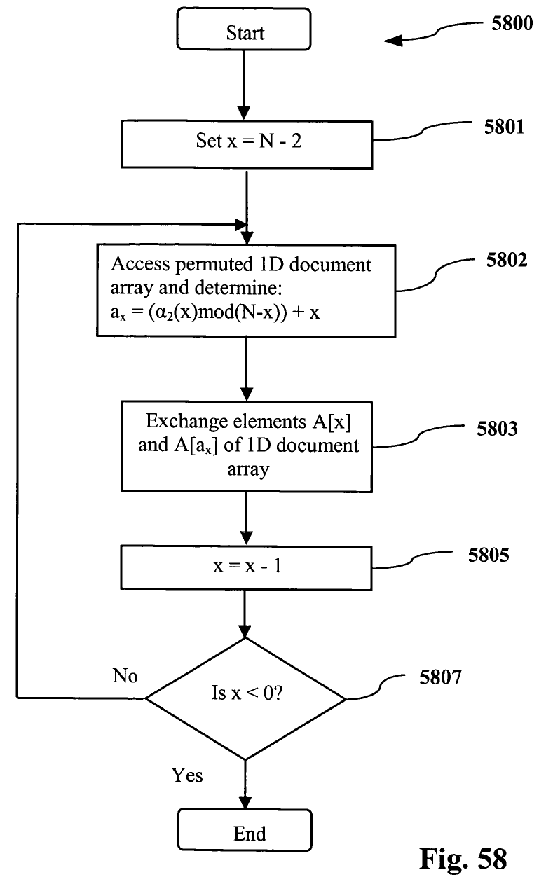

A method 5800 of generating an inverse pseudo-random permutation, as executed at step 4709, will now be described with reference to FIG. 58. The method 5800 may be implemented as software resident on the hard disk drive 110 and being controlled in its execution by the processor 105.

The method 5800 begins at step 5801, where the processor 105 sets a variable x configured in memory 106 to N-2 (i.e., x=N-2). Then at the next step 5802, the processor 105 accesses the 1D document array, denoted as A[x], and determines (α2 (N-2) mod 2)+N-2. The result of step 5802 may be denoted as a_{N-2}. That is, the processor 105 determines aₓ=α2(x)mod(N-2))+x at step 5802. At the next step 5803, the processor 105 exchanges elements at A[N-2] and A[a_{N-}2] of the permuted 1D document array, A[x]. Then at the next step 5805, the processor 105 sets x equal to x minus one (1) (i.e., x=x−1). If x is than zero (0) at step 5807, then the method 5700 concludes. Otherwise, the method 5800 returns to step 5802. At the second execution of step 5802, the processor 105 determines (α2(N-3)mod 3)+N-3. The result of the second execution of step 5802 may be denoted x_{N-}₃. Then at the next execution of step 5803, the processor 105 exchanges the elements at A[N-3] and A[X_{N-3}]. The method 5700 proceeds in this manner until x is less than zero (0) at step 5805, resulting in the permuted 1D document array being undone.

The method 4700 concludes following step 4709.

The method 4800 of arranging the 1D document array and the 1D protection array to form the protected document 3500, as executed at step 3706, will now be described with reference to FIG. 48. The method 4800 may be implemented as software resident in the hard disk drive 110 and being controlled in its execution by the processor 105. As described above, the method 4800 arranges the 1D document array and the 1D protection array as the document 3505 and the protection barcode 3503, respectively, to form the protected document 3500. The method 4800 may be implemented as software resident in the hard disk drive 110 and being controlled in its execution by the processor 105.

Steps 4802 to 4807 of the method 4800 iterate over the pixels in the protection barcode 3503 and the document section 3504 in raster order (i.e., from left to right, then from top to bottom). A current pixel may be denoted P (x, y) for steps 4803 to 4807, where (x, y) is the row and column coordinates of the current pixel.

At step 4803, if the processor 105 determines that the current pixel P(x,y) is an alignment pixel, then the method 4800 proceeds to step 4807. Otherwise, the method 4800 proceeds to step 4804. The determination may be made at step 4803 by determining if x and y for the current pixel P(x, y) are both divisible by three (3). If x and y for the current pixel P(x, y) are both divisible by three (3), then the pixel P(x, y) is an alignment pixel.

At step 4804, if the current pixel P(x, y) is in the protection barcode 3503, the method 4800 proceeds to step 4806. Otherwise, the method 4800 proceeds to step 4805. The determination at step 4804 depends on the shape and location of the barcode 3503. For the barcode 3503 of FIG. 35A, the protection barcode 3503 is appended to the top (i.e., barcode region 3503A) and bottom (i.e., barcode region 3503B) of the document 3504 as seen in FIG. 35A. In this instance, the current pixel P(x, y) is in the protection barcode 3503 if y is less than the value of BarcodeWidth, or y greater than or equal to (H_{f}−BarcodeWidth).

At step 4805, the processor 105 sets the current pixel P(x, y) to the next element in the 1D document array configured within memory 106, for example. The next element is the element after a last used element in the 1D document array, in left to right order.

At step 4806, the processor 105 sets the current pixel P(x, y) to the next element in the 1D protection array. The next element in the 1D protection array is the element after a last used element, in left to right order.

At the next step 4807, if the processor 105 determines that there are more pixels in the protection barcode 3503 and the document 3504 to be processed, then the method 4800 proceeds to step 4802. Otherwise, the method 4800 concludes. Following the conclusion of the method 4800, every pixel in the protection barcode 3503 and the document 3504 will be allocated a value.

15.3 Verifying a Document

Verification of a protected document 3500 is performed in steps 3806 and 3807 of the method 3800, as described above. At step 3806, the processor 105 extracts a 1D document array and a 1D protection array from the aligned scanned image of the protected document 3500. The protection barcode section 3503 and the document section 3504 are serialised into a 1D protection array and a 1D document array respectively, at step 3806, in accordance with the method 4900, which will be described in detail below with reference to FIG. 49.

At step 3807, the 1D document array and the 1D protection array may be used to detect alterations in the scanned image of the printed document 3500. The processor 105 produces two images at step 3807, a first image showing the location of the alterations or tampered pixels in the scanned image of the document 3504 and a second image where the alterations have been corrected or repaired. If the document 3504 has been greatly damaged or altered, repairing the document 3504 may fail, and the document 3504 may be marked invalid. If the document 3504 was successfully repaired, the image showing the alterations is created by comparing the scanned image of document 3504 with the repaired document.

The method 4900 of extracting the two one dimensional arrays from the scanned image of the protected document 3500, as executed at step 3806, may be implemented as software resident in the hard disk drive 110 and being controlled in its execution by the processor 105. Steps 4902 to 4907 iterate over all the pixels in the interior 3502 of the protected document 3500 in raster order (i.e., from left to right, then from top to bottom). A current pixel may be denoted as P (x, y) for steps 4903 to 4907, where (x, y) is the row and column coordinates of the current pixel P(x, y).

Steps 4902 to 4907 of the method 4900 iterate over the pixels in the protection barcode 3503 and the document section 3504 in raster order (i.e., from left to right, then from top to bottom). A current pixel may be denoted P (x, y) for steps 4903 to 4907, where (x, y) is the row and column coordinates of the current pixel.

At step 4903, if the processor 105 determines that the current pixel P(x,y) is an alignment pixel, then the method 4900 proceeds to step 4907. Otherwise, the method 4900 proceeds to step 4904. The determination may be made at step 4903 by determining if x and y for the current pixel P(x, y) are both divisible by three (3). If x and y for the current pixel P(x, y) are both divisible by three (3), then the pixel P(x, y) is an alignment pixel.

At step 4904, if the current pixel P(x, y) is in the protection barcode 3503, the method 4900 proceeds to step 4906. Otherwise, the method 4900 proceeds to step 4905. The determination at step 4904 depends on the shape and location of the barcode 3503. For the protection barcode 3503 of FIG. 35A the protection barcode 3503 is appended to the top (i.e., barcode region 3503A) and bottom (i.e., barcode region 3503B) of the document 3504 as seen in FIG. 35A. In this instance, the current pixel P(x, y) is in the protection barcode 3503 if y is less than the value of BarcodeWidth, or y greater than or equal to (H_{f}−BarcodeWidth).

At step 4905, the processor 105 adds the value of the current pixel P(x, y) to the end of the 1D document array configured within memory 106, for example.

At the next step 4906, the processor 105 adds the value of the current pixel P(x, y) to the end of the 1D protection array.

At the next step 4907, if the processor 105 determines that there are more pixels in the protection barcode 3503 and the document section 3504 to be processed, then the method 4900 proceeds to step 4902. Otherwise, the method 4900 concludes. Following the conclusion of the method 4900, every pixel in the protection barcode 3503 and the document 3504 has been copied to either the 1D document array or the 1D protection array. The 1D document array may also be padded with zeros to increase the size of the 1D document array to the nearest multiple of ECCK.

As described above, step 3807 repairs the document 3504 and, if the repair was successful, the processor 105 creates an image showing the pixels that have been altered or tampered. Step 3807 generates two new 1D arrays. The first array is the 1D repaired document array, and stores a serialised 2D-image representing the repaired document 3504. The second array generated at step 3807 may be referred to as a 1D tamper array, and stores a serialised 2D-image representing the detected tampered areas of the document 3504.

The method 5000 indicating the location of the alterations to the scanned image of the protected document and generating an image correcting the alterations, as executed at step 3807, will be described in detail below with reference to FIG. 50.

The method 5000 begins at step 5002, where the processor 105 accesses the 1D document array and pseudo-randomly permutes the order of the elements of the 1D document array, in accordance with the method 5700 described above.

At the next step 5003, the processor 105 applies the inverse pseudo-random permutation to the 1D protection array, in accordance with the method 5800 described above.

At the next step 5004, the processor 105 divides the 1D document array into blocks of size ECCK, and the 1D protection array into blocks of size (ECCN−ECCK). Blocks in the 1D document array are processed one at a time from left to right in the following steps 5005 to 5008, of the method 5000. For each block from the 1D document array, the processor 105 pairs the block with a corresponding block in the 1D protection array to form a new block of size ECCN. This block may be referred to as BK. The block BK is the reconstructed LDPC code encoded block, with the parity bits reassembled next to the document bits.

At step 5005, the processor 105 processes the block BK and using LDPC attempts to repair any alterations made to the block BK. The output of step 5005 is a block with the parity bits removed, leaving repaired document bits. The output of step 5005 may be denoted as BK_{D}.

At the next step 5006, if the processor 105 determines that severe damage was present in the block BK and the block BK cannot be repaired, the method 5000 proceeds to step 5011. Otherwise, any damage or fraudulent alteration to block BK has been successfully repaired into block BK_{D} and the method 5000 proceeds to step 5007. At step 5011, the processor 105 reports that the block BK and therefore the document 3504 cannot be repaired and the method 5000 concludes.

At step 5007, the processor 105 accesses the block BK_{D} and adds the block BK_{D} to the end of the 1D repaired document array. In order to detect which pixels have been altered in the block BK, the processor 105 compares block BK_{D} to the document bits of block BK. The bits of the block BK_{D} and the document bits of block BK may be XORed together. The result of such an XOR is added to the end of the 1D tamper array.

At the next step 5008, if there are any more blocks of the 1D document array to process, the method 5000 returns to step 5004. Otherwise, the method 5000 proceeds to step 5009. At step 5009, the 1D repaired document array contains a permuted version of the original document 3504, and the 1D tamper array contains a permuted serialised 2D-image where altered pixels appear in one colour, and correct pixels appear in the other colour.

At step 5009, the processor 105 applies the inverse pseudo-random permutation to the 1D repaired document array and the 1D tamper array, in accordance with the method 5800 described above.

The method 5000 concludes at the next step 5010, where the processor 105 converts each of the 1D repaired document array and the 1D tamper array to 2D images. Each 1D array is iterated through from left to right, and the pixels are written into a 2D image in raster order. If a pixel (x, y) about to be written in the 2D image is an alignment pixel, then the pixel is skipped over and the next pixel in raster order is written to instead. Following step 5010, an image of the repaired document and an image that indicates which pixels of the printed version of the printed document 3500 have been altered are configured within memory 106.

The aforementioned preferred method(s) comprise a particular control flow. There are many other variants of the preferred method(s) which use different control flows without departing the spirit or scope of the invention. Furthermore one or more of the steps of the preferred method(s) may be performed in parallel rather sequentially.

The foregoing describes only some embodiments of the present invention, and modifications and/or changes can be made thereto without departing from the scope and spirit of the invention, the embodiments being illustrative and not restrictive. For example, the interpolation of the scanned image using bi-cubic interpolation at steps 4303 and 4402 may be alternatively performed using any suitable interpolation. For example, bi-linear interpolation may be used at steps 4303 and 4402.

Further, the interpolation of the mapping in accordance with the method 2000 using bi-cubic interpolation may alternatively be executed using any suitable interpolation method. For example, bi-linear interpolation may be used to interpolate the mapping in the method 2000.

Further, the resistance of a protected document 3500 from deliberate alteration or tampering is dependent on keeping both the permutation in step 4703 and the LDPC code secret. If an attacker knows both the permutation in step 4703 and the LDPC code, the attacker may modify the protected document 3500 at will and alter the protection barcode 3503 to create a new, valid protected document 3500. Public/private key encryption may be used to overcome such a problem. The protection bits in the protection barcode 3503 may be encrypted with the private key of a sender, and may be decrypted during verification by the public key of the sender. This makes modifying the protection bits very difficult without the private key of the sender. Furthermore, public/private key encryption allows a receiver to verify that the protected document originated from a claimed sender.

As described above, the barcode 3503 is laid out above and below the document 3504. The shape and location of the barcode 3503 is not fixed, and may be altered to any other suitable shape and location.

Further, the peak detection step 1705 uses Fourier interpolation and a bi-parabolic fit to estimate the location of a peak to sub-pixel accuracy. However, any suitable peak determination method may be used in the described methods. For example, a chirp-z transform may be used to interpolate the correlation image at a large number of points, and the point with the largest value may be taken as the peak location.

The claims defining the invention are as follows:

1. A method of generating a barcode representing one or more portions of data, said method comprising the steps of:
generating a block-based correlatable alignment pattern of data;
arranging the generated correlatable alignment pattern according to a predetermined arrangement; and
interdispersing the one or more portions of data with the arranged correlatable alignment pattern to generate the barcode.

2. A method according to claim 1, wherein the correlatable alignment pattern is generated based on a correlation image Iₓ according the following formula:
$${I}_{x} ( x , y ) = {\sum }_{{x}^{′} , {y}^{′}} {I}_{1} ( {x}^{′} , {y}^{′} ) {I}_{2} ( {x}^{′} + x , {y}^{′} + y )$$
where I₁ and I₂ represent images from which said correlation image is generated.

3. A method according to claim 1, wherein the correlatable alignment pattern is a noise pattern.

4. A method according to claim 1, wherein the correlatable alignment pattern comprises one or more portions of pseudo-random data.

5. A method according to claim 4, further comprising the step of distributing the random data according to the correlatable alignment pattern substantially uniformly throughout the barcode.

6. A method according to claim 5, wherein the random data is distributed within an interior region of said barcode.

7. A method according to claim 5, wherein the random data is distributed in a border region of said barcode.

8. A method according to claim 7, wherein the one or more portions of data are interdispersed with the random data within said interior region.

9. A method according to claim 1, further comprising the step of generating one or more further data patterns based on a mathematical function having a predetermined property.

10. A method according to claim 9, further comprising the step of arranging the further generated data patterns in a border region of said barcode.

11. A method according to claim 10, further comprising the step of interdispersing one or more further portions of data with the further generated data patterns within the border region of the barcode.

12. A method according to claim 9, wherein the further generated data patterns are spirals.

13. A method according to claim 12, wherein the spirals are arranged in corners of the barcode.

14. A method according to claim 12, wherein six of the spirals are generated.

15. A method according to claim 12, wherein at least one of the spirals has a different phase to others of the spirals.

16. A method according to claim 12, wherein the spirals are printed at a higher resolution than the one or more portions of data.

17. A method according to claim 1, further comprising the step of compressing the one or more portions of data.

18. A method according to claim 1, further comprising the step of encrypting the one or more portions of data.

19. A method according to claim 1, further comprising the step of error correcting the one or more portions of data.

20. A method according to claim 1, wherein each of the one or more portions of data is of a predetermined size.

21. A method according to claim 1, wherein random data is embedded together with the generated correlatable alignment pattern in one or more color channels.

22. A method according to claim 1, wherein the correlatable alignment pattern is generated in one or more color channels.

23. A method according to claim 1, wherein the one or more portions of data are generated in one or more color channels.

24. A method according to claim 1, wherein the barcode is generated for a plurality of color channels.

25. A method according to claim 24, wherein the barcode comprises one or more independent barcodes, each independent barcode being of a particular one of said color channels.

26. A method of generating a barcode representing one or more portions of data, said method comprising the steps of:
generating one or more data patterns based on a mathematical function having a predetermined property;
arranging the generated data patterns in a border region of said barcode;
generating a block-based correlatable pattern of data;
arranging the correlatable pattern of data in an interior region of said barcode according to a predetermined arrangement; and
interdispersing the one or more portions of data with the arranged data patterns in the interior and exterior of said barcode to generate the barcode.

27. A method of generating a barcode representing one or more portions of data, said method comprising the steps of:
generating one or more spiral data patterns;
arranging the spiral data patterns in a border region of said barcode;
generating a noise pattern using random data;
arranging the random data in an interior region of said barcode according to a predetermined arrangement; and
interdispersing the one or more portions of data with the arranged spirals and the random data in the interior and exterior of said barcode in order to generate the barcode.

28. An apparatus for generating a barcode representing one or more portions of data, said apparatus comprising:
pattern generation means for generating a block-based correlatable alignment pattern of data;
data pattern arranging means for arranging the generated correlatable alignment pattern according to a predetermined arrangement; and
interdispersing means for interdispersing the one or more portions of data with the arranged correlatable alignment pattern to generate the barcode.

29. A computer program for generating a barcode representing one or more portions of data, said program comprising:
code for generating a block-based correlatable alignment pattern of data;
code for arranging the generated correlatable alignment pattern according to a predetermined arrangement; and
code for interdispersing the one or more portions of data with the arranged correlatable alignment pattern to generate the barcode.

30. A method of generating a protected document, said method comprising the steps of:
generating a block-based correlatable alignment pattern of data;
encoding data representing a document to be protected using an error correction code to generate parity bits for the document; and
arranging the generated correlatable alignment pattern, the encoded document and the generated parity bits according to a predetermined arrangement to generate the protected document.

31. A method of generating a protected document, said method comprising the steps of:
generating one or more data patterns based on a mathematical function having a predetermined property;
arranging the generated data patterns in a border region of said protected document;
generating a block-based correlatable pattern of data;
arranging the correlatable pattern of data in an interior region of said protected document according to a predetermined arrangement; and
encoding data representing a document to be protected using an error correction code to generate parity bits for the document; and
arranging the encoded document and the generated parity bits in said interior region according to said predetermined arrangement to generate said protected document.

32. A method of generating a protected document, said method comprising the steps of:
generating one or more spiral data patterns;
arranging the spiral data patterns in a border region of said protected document;
generating a noise pattern using random data;
arranging the random data in an interior region of said protected document according to a predetermined arrangement; and
encoding data representing a document to be protected using an error correction code to generate parity bits for the document; and
arranging the encoded document and the generated parity bits in said interior region according to said predetermined arrangement to generate said protected document.

33. An apparatus for generating a protected document, said apparatus comprising:
generating means for generating a block-based correlatable alignment pattern of data;
data encoding means for encoding data representing a document to be protected using an error correction code to generate parity bits for the document; and
arranging means for arranging the generated correlatable alignment pattern, the encoded document and the generated parity bits according to a predetermined arrangement to generate the protected document.

34. A computer program for generating a protected document, said program comprising:
code for generating a block-based correlatable alignment pattern of data;
code for encoding data representing a document to be protected using an error correction code to generate parity bits for the document; and
code for arranging the generated correlatable alignment pattern, the encoded document and the generated parity bits according to a predetermined arrangement to generate the protected document.
